(19) United States
(12) Patent Application Publication
(10) Pub. No.: US 2026/0059409 A1
(43) Pub. Date: Feb. 26, 2026

(54) METHOD AND APPARATUS FOR USER PLANE FUNCTION SELECTION

(71) Applicant: Telefonaktiebolaget LM Ericsson (publ), Stockholm (SE)

(72) Inventors: Yingjiao HE, Shanghai (CN); Yong YANG, Kallered (SE); Juan XU, Shanghai (CN); Wen ZHANG, Shanghai (CN); Zhansheng WEI, Shanghai (CN)

(21) Appl. No.: 19/102,017

(22) PCT Filed: Aug. 7, 2023
(86) PCT No.: PCT/CN2023/111598

§ 371 Date: Feb. 7, 2025

(30) Foreign Application Priority Data
Aug. 8, 2022 (WO) PCT/CN2022/110896

(51) Int. Cl. H04W 36/12; H04W 36/00

(52) U.S. Cl. CPC H04W 36/12; H04W 36/0022

(57) ABSTRACT

Embodiments of the present disclosure provide a method and an apparatus for a local protocol data unit session anchor (PSA) selection. A method (300) performed by a first network node comprises: receiving (S302) from a second network node, a first list of data network access identifier, DNAI; and selecting (S304) a user plane function, UPF, based at least on the first list of DNAI. According to embodiments of the present disclosure, by receiving a first list of DNAI, a first network node may select UPF in time when needed. Therefore, the problem that the DNAI might not be available when the network node needs to select a UPF at some time point will be avoided.

### TECHNICAL FIELD

The present disclosure relates generally to the technology of communication network, and in particular, to a method and an apparatus for a user plane function (UPF) selection.

### BACKGROUND

This section introduces aspects that may facilitate better understanding of the present disclosure. Accordingly, the statements of this section are to be read in this light and are not to be understood as admissions about what is in the prior art or what is not in the prior art.

In communication network, many technologies are applied to improve the performance.

For example, a mobile edge computing (MEC) technique may be used to provide a low latency between a terminal device (such as a user equipment (UE)) and a server. To utilize MEC technique, a UPF, such as an Intermediate UPF (I-UPF), a visited UPF, (V-UPF), or a protocol data unit session anchor (PSA), should be selected from a plurality of UPFs which are connected to the server and are capable of relatively high-speed communication with the server. Generally, the selected UPF should be close to the terminal device for achieving an efficient service delivery through the reduced end-to-end latency and load on the transport network.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

For selecting the UPF for one PDU session in Edge Computing, a network node should have information about candidate UPFs. For example, in current communication standards (such as in a 3^{rd} generation partnership project technical specification, 3GPP TS23.502, V17.5.0 (2022 June)), such information may be included in a list, such as a data network access identifier (DNAI) list of interest. DNAI is a mandatory input for the network node selecting UPF in Edge Computing. However, one problem is that the DNAI might not be available when the network node needs to select a UPF at some time point.

Certain aspects of the present disclosure and their embodiments may provide solutions to these or other challenges. There are, proposed herein, various embodiments which address one or more of the issues disclosed herein.

A first aspect of the present disclosure provides a method performed by a first network node. The method comprises: receiving from a second network node, a first list of data network access identifier (DNAI); selecting a user plane function (UPF), based at least on the first list of DNAI.

In embodiments of the present disclosure, the UPF comprises at least one of: an Intermediate UPF, I-UPF, a visited UPF, V-UPF, or a local protocol data unit session anchor, PSA, for a protocol data unit, PDU, session.

In embodiments of the present disclosure, the method may further comprise: storing the first list of DNAI.

In embodiments of the present disclosure, the method may further comprise: receiving an updated first list of DNAI, from the second network node; and storing the updated first list of DNAI.

In embodiments of the present disclosure, selecting the UPF may comprise: obtaining a second list of DNAI, based at least on the first list of DNAI and/or a configuration: selecting one or more UPF, based at least on the second list of DNAI.

In embodiments of the present disclosure, the second list of DNAI is a list of DNAIs that are both included in the first list of DNAI and supported by the first network node.

In embodiments of the present disclosure, the method may further comprise: prior to select any local UPF, selecting an Uplink Classifier or Branching Point to be inserted into user plane data path.

In embodiments of the present disclosure, the first list of DNAI may be a full DNAI list.

In embodiments of the present disclosure, the full DNAI list is a DNAI list of interest for a protocol data unit, PDU, session, excluding one or more DNAIs supported by the second network node, or not excluding one or more DNAIs supported by the second network node.

In embodiments of the present disclosure, the first network node may comprise: a first intermediate session management function (I-SMF), or a first V-SMF.

In embodiments of the present disclosure, the second network node may comprise: a session management function (SMF).

In embodiments of the present disclosure, the second network node may comprise: a second intermediate session management function (I-SMF), or a second V-SMF, or an anchor SMF.

In embodiments of the present disclosure, the first list of DNAI may be received via at least one of: Nsmf_PDUSession_Context Response message, Nsmf_PDUSession_Update Request message, Nsmf_PDUSession_Update Response message, or Nsmf_PDUSession_Create Response message.

In embodiments of the present disclosure, the first I-SMF is a newly inserted I-SMF or a target I-SMF at an inter I-SMF mobility procedure; or the first I-SMF may be an inserted I-SMF, or a target I-SMF when changing I-SMF.

In embodiments of the present disclosure, the first network node may receive the first list of DNAI, during at least one of flowing procedures: protocol data unit session establishment, registration, service request, inter next generation-radio access network node N2 based handover, Xn based handover, handover from evolved packet core/evolved packet data gateway to 5th generation system, and/or handover from non-3rd generation partnership project access to 5th generation system.

A second aspect of the present disclosure provides a method performed by a second network node. The method comprises: transmitting to a first network node, a first list of data network access identifier (DNAI). The first list of DNAI may be used for the first network node to select a user plane function (UPF), based at least on the first list of DNAI.

In embodiments of the present disclosure, the UPF comprises at least one of: an Intermediate UPF, I-UPF, a visited UPF, V-UPF, or a local protocol data unit session anchor, PSA, for a protocol data unit, PDU, session.

In embodiments of the present disclosure, the method may further comprise: receiving an updated first list of DNAI, from a PCF; and transmitting the updated first list of DNAI, to the first network node.

In embodiments of the present disclosure, the first list of DNAI may be used for the first network node to obtain a second list of DNAI based at least on the first list of DNAI and/or a configuration, and select one or more UPF based at least on the second list of DNAI.

In embodiments of the present disclosure, the second list of DNAI may be a list of DNAIs that are both included in the first list of DNAI and supported by the first network node.

In embodiments of the present disclosure, the first network node selects an Uplink Classifier or Branching Point to be inserted into user plane data path, prior to select any local PSA.

In embodiments of the present disclosure, the first list of DNAI may be a full DNAI list.

In embodiments of the present disclosure, the full DNAI list is a DNAI list of interest for a protocol data unit, PDU, session, excluding one or more DNAIs supported by the second network node, or not excluding one or more DNAIs supported by the second network node.

In embodiments of the present disclosure, the first network node may comprise: a first intermediate session management function (I-SMF), or a first V-SMF.

In embodiments of the present disclosure, the second network node may comprise: a session management function (SMF).

In embodiments of the present disclosure, the second network node may comprise: a second intermediate session management function (I-SMF), or a second V-SMF, or an anchor SMF.

In embodiments of the present disclosure, the first list of DNAI may be transmitted via at least one of: Nsmf_PDUSession_Context Response message, Nsmf_PDUSession_Update Request message, Nsmf_PDUSession_Update Response message, or Nsmf_PDUSession_Create Response message.

In embodiments of the present disclosure, the first I-SMF is a newly inserted I-SMF or a target I-SMF at an inter I-SMF mobility procedure; or the first I-SMF may be an inserted I-SMF, or a target I-SMF when changing I-SMF.

In embodiments of the present disclosure, the first network node may receive the first list of DNAI, during at least one of flowing procedures: protocol data unit session establishment, registration, service request, inter next generation-radio access network node N2 based handover, Xn based handover, handover from evolved packet core/evolved packet data gateway to 5th generation system, and/or handover from non-3rd generation partnership project access to 5th generation system.

A third aspect of the present disclosure provides a method performed by a system including a first network node and a second network node. The method comprises: transmitting, by the second network node to the first network node, a first list of data network access identifier (DNAI): receiving, by the first network node from the second network node, the first list of DNAI; and selecting, by the first network node, a user plane function (UPF) for a PDU session, based at least on the first list of DNAI.

In embodiments of the present disclosure, the UPF comprises at least one of: an Intermediate UPF, I-UPF, a visited UPF, V-UPF, or a local protocol data unit session anchor, PSA, for a protocol data unit, PDU, session.

In embodiments of the present disclosure, the method may further comprise: storing, by the first network node, the first list of DNAI.

In embodiments of the present disclosure, the method may further comprise: receiving, by the second network node from the PCF, an updated first list of DNAI; transmitting, by the second network node to the first network node, the updated first list of DNAI: receiving, by the first network node from the second network node, the updated first list of DNAI; and storing, by the first network node, the updated first list of DNAI.

In embodiments of the present disclosure, selecting the UPF by the first network node for the PDU session comprises: obtaining, by the first network node, a second list of DNAI, based at least on the first list of DNAI, and/or a configuration; and selecting, by the first network node, one or more UPF for the PDU session, based at least on the second list of DNAI.

In embodiments of the present disclosure, the second list of DNAI may be a list of DNAIs that are both included in the first list of DNAI and supported by the first network node.

In embodiments of the present disclosure, the method further comprises: prior to select any local UPF, selecting an Uplink Classifier or Branching Point to be inserted into user plane data path for the PDU session.

In embodiments of the present disclosure, the first list of DNAI may be a full DNAI list.

In embodiments of the present disclosure, the full DNAI list is a DNAI list of interest for a protocol data unit, PDU, session, excluding one or more DNAIs supported by the second network node, or not excluding one or more DNAIs supported by the second network node.

In embodiments of the present disclosure, the first network node may comprise: a first intermediate session management function (I-SMF), or a first V-SMF.

In embodiments of the present disclosure, the second network node may comprise: a session management function (SMF).

In embodiments of the present disclosure, the second network node may comprise: a second intermediate session management function (I-SMF), or a second V-SMF, or an anchor SMF.

In embodiments of the present disclosure, the first list of DNAI may be received via at least one of: Nsmf_PDUSession_Context Response message, Nsmf_PDUSession_Update Request message, Nsmf_PDUSession_Update Response message, or Nsmf_PDUSession_Create Response message.

In embodiments of the present disclosure, the first I-SMF is a newly inserted I-SMF or a target I-SMF at an inter I-SMF mobility procedure, or the first I-SMF may be an inserted I-SMF, or a target I-SMF when changing I-SMF.

In embodiments of the present disclosure, the first network node may receive the first list of DNAI, during at least one of flowing procedures: protocol data unit session establishment, registration, service request, inter next generation-radio access network node N2 based handover, Xn based handover, handover from evolved packet core/evolved packet data gateway to 5th generation system, and/or handover from non-3rd generation partnership project access to 5th generation system.

A fourth aspect of the present disclosure provides an apparatus for a first network node. The apparatus for the first network node comprises: a processor; and a memory. The memory contains instructions executable by the processor. The apparatus for the first network node is operative for: receiving from a second network node, a first list of data network access identifier (DNAI); and selecting a user plane function (UPF), based at least on the first list of DNAI.

In embodiments of the present disclosure, the apparatus may be further operative to perform the method according to any of above embodiments.

A fifth aspect of the present disclosure provides an apparatus for a second network node. The apparatus for the second network node comprises: a processor; and a memory. The memory contains instructions executable by the processor. The apparatus for the second network node is operative for: transmitting to a first network node, a first list of data network access identifier (DNAI). The first list of DNAI may be used for the first network node to select a user plane function (UPF), based at least on the first list of DNAI.

In embodiments of the present disclosure, the apparatus may be further operative to perform the method according to any of above embodiments.

A sixth aspect of the present disclosure provides a system comprising: an apparatus for a first network node, and an apparatus for a second network node. The apparatus for the first network node comprises: a processor; and a memory. The memory contains instructions executable by the processor. The apparatus for the first network node is operative for: receiving from a second network node, a first list of data network access identifier (DNAI); and selecting a UPF, based at least on the first list of DNAI. The apparatus for the second network node comprises: a processor; and a memory. The memory contains instructions executable by the processor. The apparatus for the second network node is operative for: transmitting to a first network node, a first list of data network access identifier (DNAI). The first list of DNAI may be used for the first network node to select a user plane function (UPF), based at least on the first list of DNAI.

In embodiments of the present disclosure, the system may be further operative to perform the method according to any of above embodiments.

A seventh aspect of the present disclosure provides computer-readable storage medium storing instructions, which when executed by at least one processor, cause the at least one processor to perform the method according to any of above embodiments.

Another aspect of the present disclosure provides a host configured to operate in a communication system to provide an over-the-top (OTT) service. The host comprises: processing circuitry configured to provide user data; and a network interface configured to initiate transmission of the user data to a network node in a cellular network for transmission to a user equipment (UE). The network node has a communication interface and processing circuitry. The processing circuitry of the network node is configured to perform any of the method performed by the first network node and/or the second network node to transmit the user data from the host to the UE.

In embodiments of the present disclosure, the processing circuitry of the host is configured to execute a host application that provides the user data; and the UE comprises processing circuitry configured to execute a client application associated with the host application to receive the transmission of user data from the host.

Another aspect of the present disclosure provides a method implemented in a host configured to operate in a communication system that further includes a network node and a user equipment (UE). The method comprises: providing user data for the UE; and initiating a transmission carrying the user data to the UE via a cellular network comprising the network node. The network node performs any of the method performed by the first network node and/or the second network node to transmit the user data from the host to the UE.

In embodiments of the present disclosure, the method further comprises, at the network node, transmitting the user data provided by the host for the UE.

In embodiments of the present disclosure, the user data is provided at the host by executing a host application that interacts with a client application executing on the UE, the client application being associated with the host application.

Another aspect of the present disclosure provides a communication system configured to provide an over-the-top service. The communication system comprises: a host comprising: processing circuitry configured to provide user data for a user equipment (UE), the user data being associated with the over-the-top service; and a network interface configured to initiate transmission of the user data toward a cellular network node for transmission to the UE. The network node has a communication interface and processing circuitry. The processing circuitry of the network node is configured to perform any of the method performed by the first network node and/or the second network node to transmit the user data from the host to the UE.

In embodiments of the present disclosure, the communication system of the previous embodiment, further comprise: the network node; and/or the user equipment.

In embodiments of the present disclosure, the processing circuitry of the host is configured to execute a host application, thereby providing the user data; and the host application is configured to interact with a client application executing on the UE, the client application being associated with the host application.

Another aspect of the present disclosure provides a host configured to operate in a communication system to provide an over-the-top (OTT) service. The host comprises: processing circuitry configured to initiate reception of user data; and a network interface configured to receive the user data from a network node in a cellular network, the network node having a communication interface and processing circuitry. The processing circuitry of the network node is configured to perform any of the method performed by the first network node and/or the second network node to receive the user data from the UE for the host.

In embodiments of the present disclosure, the processing circuitry of the host is configured to execute a host application, thereby providing the user data; and the host application is configured to interact with a client application executing on the UE, the client application being associated with the host application.

In embodiments of the present disclosure, the initiating reception of the user data comprises requesting the user data.

Another aspect of the present disclosure provides a method implemented by a host configured to operate in a communication system that further includes a network node and a user equipment (UE). The method comprising: at the host, initiating reception of user data from the UE, the user data originating from a transmission which the network node has received from the UE. The network node performs any of the method performed by the first network node and/or the second network node to receive the user data from the UE for the host.

In embodiments of the present disclosure, the method of the previous embodiment, further comprising at the network node, transmitting the received user data to the host.

Another aspect of the present disclosure provides a host configured to operate in a communication system to provide an over-the-top (OTT) service. The host comprises: processing circuitry configured to provide user data; and a network interface configured to initiate transmission of the user data to a cellular network for transmission to a user equipment (UE). The UE comprises a communication interface and processing circuitry, the communication interface and processing circuitry of the UE being configured to perform any of the method to receive the user data from the host.

In embodiments of the present disclosure, the cellular network further includes a network node configured to communicate with the UE to transmit the user data to the UE from the host.

In embodiments of the present disclosure, the processing circuitry of the host is configured to execute a host application, thereby providing the user data; and the host application is configured to interact with a client application executing on the UE, the client application being associated with the host application.

Another aspect of the present disclosure provides a method implemented by a host operating in a communication system that further includes a network node and a user equipment (UE). The method comprising: providing user data for the UE; and initiating a transmission carrying the user data to the UE via a cellular network comprising the network node. The UE performs any of the method performed by the first network node and/or the second network node to receive the user data from the host.

In embodiments of the present disclosure, the method of the previous embodiment, further comprises: at the host, executing a host application associated with a client application executing on the UE to receive the user data from the UE.

In embodiments of the present disclosure, the method of the previous embodiment further comprises: at the host, transmitting input data to the client application executing on the UE, the input data being provided by executing the host application. The user data is provided by the client application in response to the input data from the host application.

Another aspect of the present disclosure provides a host configured to operate in a communication system to provide an over-the-top (OTT) service. The host comprises: processing circuitry configured to utilize user data; and a network interface configured to reception of transmission of the user data to a cellular network for transmission to a user equipment (UE). The UE comprises a communication interface and processing circuitry, the communication interface and processing circuitry of the UE being configured to perform any of the method to transmit the user data to the host.

In embodiments of the present disclosure, the cellular network further includes a network node configured to communicate with the UE to transmit the user data from the UE to the host.

In embodiments of the present disclosure, the processing circuitry of the host is configured to execute a host application, thereby providing the user data; and the host application is configured to interact with a client application executing on the UE, the client application being associated with the host application.

Another aspect of the present disclosure provides a method implemented by a host configured to operate in a communication system that further includes a network node and a user equipment (UE). The method comprises: at the host, receiving user data transmitted to the host via the network node by the UE. The UE performs any of the method performed by the first network node and/or the second network node transmit the user data to the host.

In embodiments of the present disclosure, the method of the previous embodiment, further comprises: at the host, executing a host application associated with a client application executing on the UE to receive the user data from the UE.

In embodiments of the present disclosure, the method of the previous embodiments, further comprises: at the host, transmitting input data to the client application executing on the UE, the input data being provided by executing the host application. The user data is provided by the client application in response to the input data from the host application.

Embodiments herein afford many advantages. According to embodiments of the present disclosure, improved methods and improved apparatuses for local protocol data unit session anchor (PSA) selection may be provided.

Particularly, by receiving a first list of DNAI and selecting UPF, such as I-UPF, or V-UPF, or PSA, based at least on the first list of DNAI, a first network node may select a UPF in time to save some signalling transactions between the first network node and the second network node, therefore the signalling latency is reduced. Therefore, the problem that the DNAI might not be available when the network node needs to select a UPF at some time point will be avoided.

### BRIEF DESCRIPTION OF DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1A is a signalling diagram for simultaneous change of Branching Point or UL CL and additional PSA controlled by different I-SMFs.

FIG. 1B is a signalling diagram for UE Triggered Service Request procedure with I-SMF insertion/change/removal.

FIG. 1C is a signalling diagram for Inter NG-RAN node N2 based handover, preparation phase, with I-SMF insertion/change/removal.

FIG. 1D is a signalling diagram for PDU session creation.

FIG. 2 is a diagram showing a problem for Simultaneous change of Branching Point or UL CL and additional PSA controlled by different I-SMFs.

FIG. 3A is an exemplary flow chart for a method performed by a first network node, according to exemplary embodiments of the present disclosure.

FIG. 3B is an exemplary flow chart showing addition steps of method shown in FIG. 3A, according to exemplary embodiments of the present disclosure.

FIG. 3C is an exemplary flow chart showing further addition steps of method shown in FIG. 3A, according to exemplary embodiments of the present disclosure.

FIG. 3D is an exemplary flow chart showing substeps of method shown in FIG. 3A, according to exemplary embodiments of the present disclosure.

FIG. 4A is an exemplary flow chart for a method performed by a second network node, according to exemplary embodiments of the present disclosure.

FIG. 4B is an exemplary flow chart showing addition steps of method shown in FIG. 4A, according to exemplary embodiments of the present disclosure.

FIG. 5A is an exemplary flow chart for a method performed by a system including the first network node and the second network node, according to exemplary embodiments of the present disclosure.

FIG. 5B is an exemplary flow chart showing addition steps of method shown in FIG. 5A, according to exemplary embodiments of the present disclosure.

FIG. 5C is an exemplary flow chart showing further addition steps of method shown in FIG. 5A, according to exemplary embodiments of the present disclosure.

FIG. 6A is a diagram showing a solution for simultaneous change of ULCL/BP and additional PSA controlled by inserted I-SMF, according to embodiments of the present disclosure.

FIG. 6B is a diagram showing a solution for simultaneous change of ULCL/BP and additional PSA controlled by changed I-SMF, according to embodiments of the present disclosure.

FIG. 6C is a diagram showing a PDU Session Establishment Procedure, during which a first list of DNAI (fullDaniList) is sent to a first network node (an inserted I-SMF).

FIG. 6D is a diagram showing a procedure, during which a first list of DNAI (fullDaniList) is sent to a first network node (an inserted I-SMF).

FIG. 6E is a diagram showing a procedure, during which a I-SMF is informed with latest fullDnaiLit from PCF.

FIG. 7A is a block diagram showing an exemplary apparatus for a first network node, which is suitable for performing the method according to embodiments of the disclosure.

FIG. 7B is a block diagram showing an exemplary apparatus for a second network node, which is suitable for performing the method according to embodiments of the disclosure.

FIG. 7C is a block diagram showing an exemplary system including the first network node, and the second network node.

FIG. 8 is a block diagram showing an apparatus/computer readable storage medium, according to embodiments of the present disclosure.

FIG. 9A is a block diagram showing modules for a first network node, which are suitable for performing the method according to embodiments of the disclosure.

FIG. 9B is a block diagram showing modules for a second network node, which are suitable for performing the method according to embodiments of the disclosure.

FIG. 10 shows an example of a communication system 1000 in accordance with some embodiments.

FIG. 11 shows a UE 1100 in accordance with some embodiments.

FIG. 12 shows a network node 1200 in accordance with some embodiments.

FIG. 13 is a block diagram of a host 1300, which may be an embodiment of the host 1016 of FIG. 10, in accordance with various aspects described herein.

FIG. 14 is a block diagram illustrating a virtualization environment 1400 in which functions implemented by some embodiments may be virtualized.

FIG. 15 shows a communication diagram of a host 1502 communicating via a network node 1504 with a UE 1506 over a partially wireless connection in accordance with some embodiments.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the term “network” or “communication network” refers to a network following any suitable communication standards (such for an internet network, or any wireless network). For example, wireless communication standards may comprise new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. In the following description, the terms “network” and “system” can be used interchangeably. Furthermore, the communications between two devices in the network may be performed according to any suitable communication protocols, including, but not limited to, the wireless communication protocols as defined by a standard organization such as 3rd generation partnership project (3GPP) or the wired communication protocols.

The term “network node” used herein refers to a network device or network entity or network function or any other devices (physical or virtual) in a communication network. For example, the network node in the network may include a base station (BS), an access point (AP), a multi-cell/multicast coordination entity (MCE), a server node/function (such as a service capability server/application server, SCS/AS, group communication service application server, GCS AS, application function, AF), an exposure node/function (such as a service capability exposure function, SCEF, network exposure function, NEF), a unified data management, UDM, a home subscriber server, HSS, a session management function, SMF, an access and mobility management function, AMF, a mobility management entity, MME, a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Further, the term “network node”, “network function”, “network entity” herein may also refer to any suitable node, function, entity which can be implemented (physically or virtually) in a communication network. For example, the 5G system (5GS) may comprise a plurality of NFs such as AMF (Access and mobility Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), etc. In other embodiments, the network function may comprise different types of NFs (such as PCRF (Policy and Charging Rules Function), etc.) for example depending on the specific network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VOIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP, such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and (or) B” should be understood to mean “only A, only B, or both A and B.” The phrase “A and/or B” should be understood to mean “only A, only B, or both A and B.”

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

As examples for UPF selection, the following scenarios are illustrated.

In TS23.502 (V17.5.0), which is incorporated herein by reference in its entirety, some exemplary scenarios are defined as follows.

### 4.23.9 Branching Point or UL CL Controlled by I-SMF

### 4.23.9.0 Overview

The procedures in this clause describe the Addition, Removal and Change of PDU Session Anchor (PSA2), Branching Point or UL CL controlled by I-SMF. They all rely on following principles:
1. When a (new) I-SMF is inserted (e.g. as described in clause 4.23.7 or clause 4.23.11), the I-SMF provides the DNAI list it supports to the SMF. This list is assumed to remain constant during the N16a association between the I-SMF and the SMF for a PDU Session.
2. Based on the DNAI list information received from I-SMF, the SMF may then at any time provide or update the list of DNAI(s) of interest for this PDU Session to I-SMF. This may take place e.g. when the I-SMF provides the DNAI list it supports or when new or updated or removed PCC rule(s) is/are received by the SMF as defined in clause 4.23.6. This list of DNAI(s) of interest for this PDU Session indicates to the I-SMF the list of DNAI(s) candidate for local traffic steering within the PDU Session.
. . .

### 4.23.9.5 Simultaneous Change of Branching Points or UL CLs Controlled by Different I-SMFs

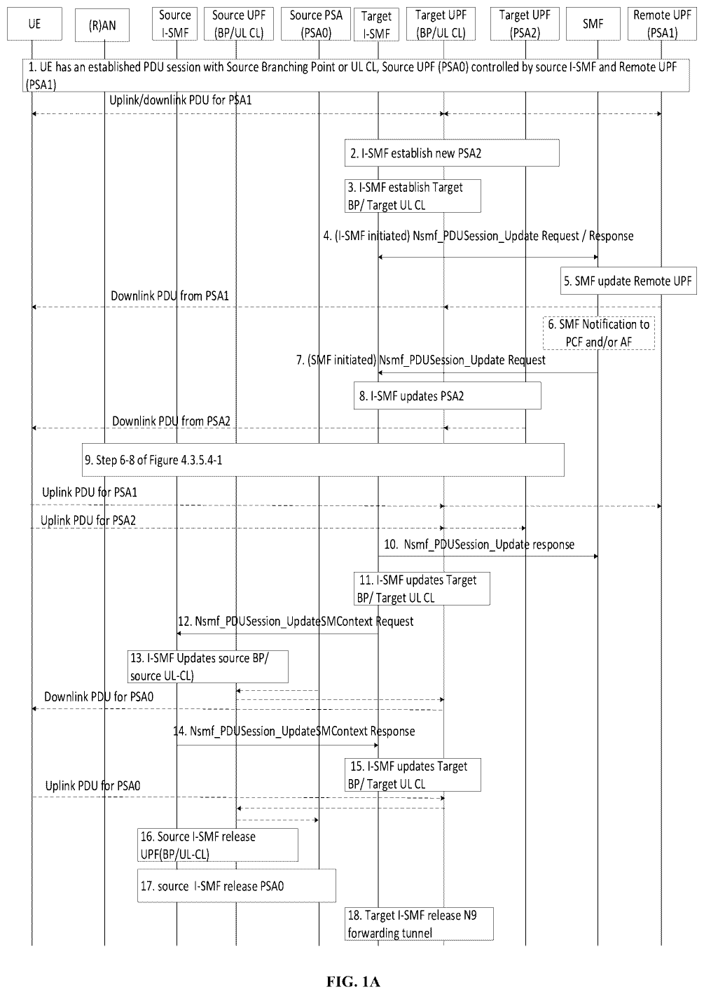

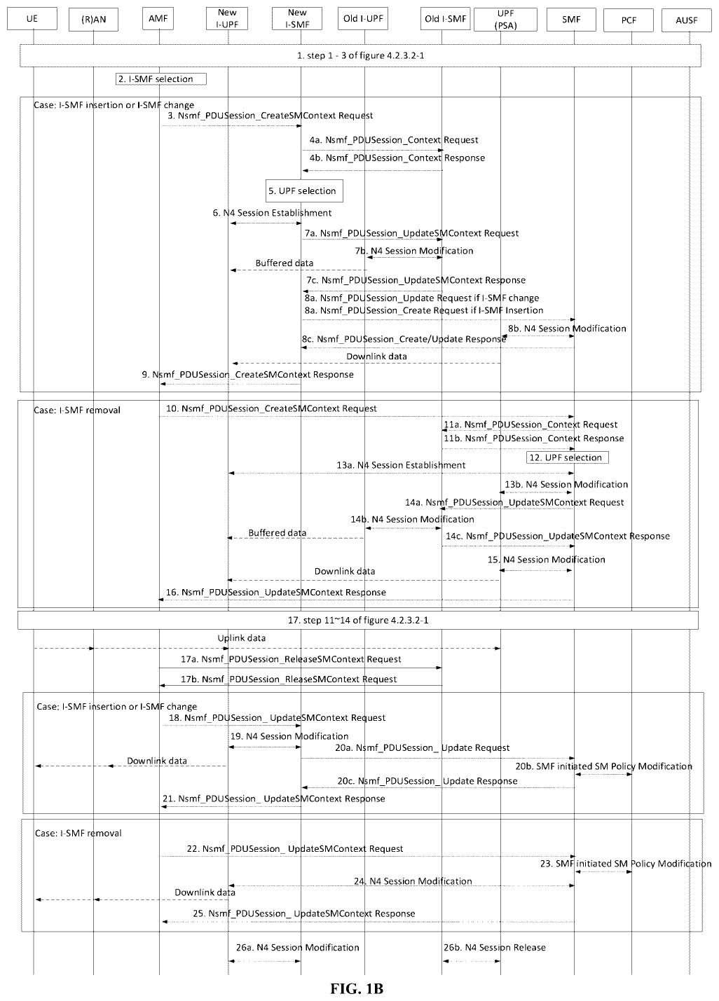

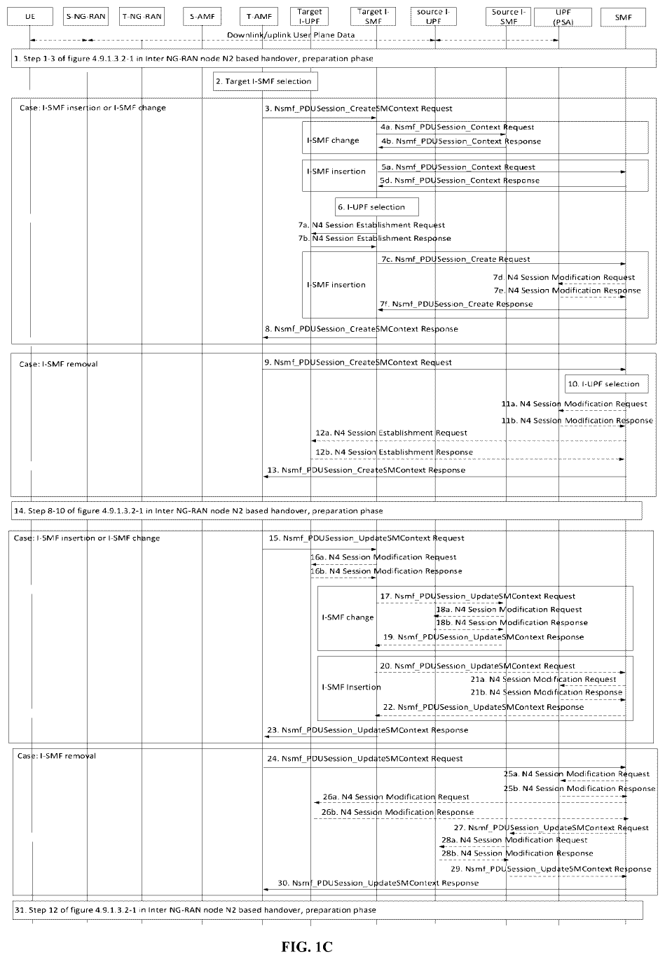

This clause describes simultaneous change of UL-CL/BP function and additional PSA, e.g. addition of a new UL CL/BP and PDU Session Anchor (i.e. PSA2) and release of the existing UL CL/BP and PDU Session Anchor (i.e. PSA0), with target UPF(s) and source UPF(s) are all controlled by different I-SMF(s).
This procedure may be triggered after N2 handover or Xn based handover procedure.
   . . . (See FIG. 1A)

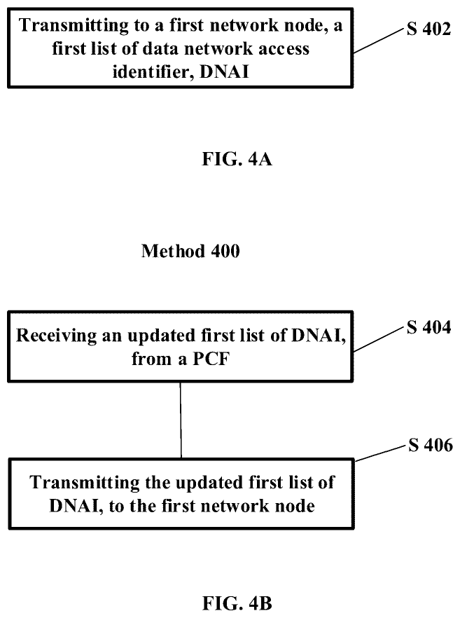

### FIG. 4.23.9.5-1: Simultaneous Change of Branching Point or UL CL and Additional PSA Controlled by Different I-SMFs

1. UE has established PDU Session with Source Branching Point or UL CL, and Source UPF (PSA0) controlled by source I-SMF and Remote PSA. The UE has mobility with I-SMF change, e.g. handed over from a source RAN to a target RAN. After mobility, the path between Target I-UPF and Remote PSA (PSA1) has been established.
2. This step is the same as steps 2 in clause 4.23.9.3.
3. Same as in step 3 of FIG. 4.23.9.4-1.
4. Same as in step 4 of FIG. 4.23.9.4-1.
5. Same as in step 5 of FIG. 4.23.9.4-1.
. . .
   (see Clause 4.23.9.3 step 2:
2. At some point the I-SMF decides to establish a new PDU Session Anchor and release the existing PDU Session Anchor e.g. due to UE mobility. The I-SMF selects a UPF and using N4 establishes the new PDU Session Anchor 2 of the PDU Session.)
   (see FIG. 4.23.9.4-1 in TS23.502 (V17.5.0), steps 3-5:
3. The I-SMF selects a UPF and using N4 establishes the target UL CL or BP of the PDU Session.
4. The I-SMF invokes Nsmf_PDUSession_Update Request (Indication of Change of traffic offload, (new allocated IPv6 prefix @PSA2, DNAI(s) supported by PSA2), (Removal of IPv6 prefix @PSA0, DNAI(s) supported by PSA0), DL Tunnel Info of the new UL CL/Branching Point) to SMF.
   The DL Tunnel Info of target UL CL/Branching Point is provided to SMF.
5. The SMF updates the remote PSA (PSA1) via N4 with the DL Tunnel Info of the Target UL CL/BP for the downlink traffic.)
   4.23.4.3 UE Triggered Service Request with I-SMF Insertion/Change/Removal
. . .
   . . . (See FIG. 1B)
      FIG. 4.23.4.3-1: UE Triggered Service Request Procedure with I-SMF Insertion/Change/Removal
. . .
   Case: I-SMF insertion or I-SMF change, steps 3-9 are skipped for I-SMF removal case.
3. If the AMF has selected a new I-SMF, the AMF sends a Nsmf_PDUSession_CreateSMContext Request (PDU Session ID. SM Context ID. UE location info. Access Type, RAT Type. Operation Type) to the new I-SMF. The SM Context ID points to the old I-SMF in the case of I-SMF change or to SMF in the case of I-SMF insertion.
4a. The new I-SMF retrieves SM Context from the old I-SMF (in the case of I-SMF change) or SMF (in the case of I-SMF insertion) by invoking Nsmf_PDUSession_Context Request (SM context type, SM Context ID). The new I-SMF uses SM Context ID received from AMF for this service operation. SM Context ID is used by the recipient of Nsmf_PDUSession_Context Request in order to determine the targeted PDU Session. SM context type indicates that the requested information is all SM context, i.e. PDN Connection Context and 5G SM context.
4b. The old I-SMF in the case of I-SMF change or SMF in the case of I-SMF insertion responds with the SM context of the indicated PDU Session.
5. The new I-SMF selects a new I-UPF: Based on the received SM context, e.g. S-NSSAI, and UE location information, the new I-SMF selects a new I-UPF as described in clause 6.3.3 of TS 23.501 [2].
6. The new I-SMF initiates a N4 Session Establishment to the new I-UPF. The new I-UPF provide tunnel endpoints to the new I-SMF.
7a. If the tunnel endpoints for the buffered DL data were allocated, the new I-SMF invokes Nsmf_PDUSession_UpdateSMContext Request (tunnel endpoints for buffered DL data) to the old I-SMF in the case of I-SMF change in order to establish the forwarding tunnel. The new I-SMF uses the SM Context ID received from AMF for this service operation.
7b. The old I-SMF, in the case of I-SMF change initiates a N4 session modification to the old I-UPF to send the tunnel endpoints for buffered DL data to the old I-UPF. After this step, the old I-UPF starts to send buffered DL data to the new I-UPF.
7c. The old I-SMF, in the case of I-SMF change responds the new I-SMF with Nsmf_PDUSession_UpdateSMContext response.
8a. In the case of i-SMF change, the new I-SMF invokes Nsmf_PDUSession_Update Request (SM Context ID, new I-UPF DL tunnel information, SM Context ID at I-SMF, Access Type, RAT Type, DNAI list supported by the new I-SME. Operation Type) towards the SMF. The new I-SMF uses the SM Context ID at SMF received from old I-SMF for this service operation.
   In the case of I-SMF insertion, the new I-SMF invokes Nsmf_PDUSession_Create Request (new I-UPF DL tunnel information, new I-UPF tunnel endpoint for buffered DL data, SM Context ID at I-SMF. Access Type, RAT type, DNAI list supported by the new I-SME, Operation Type) towards the SMF.
8b. The SMF initiates N4 Session Modification toward the PDU Session Anchor UPF. During this step:
   The SMF provides the new I-UPF DL tunnel information.
      If different CN Tunnel Info need be used by PSA UPF, i.e. the CN Tunnel Info at the PSA for N3 and N9 are different, a CN Tunnel Info for the PDU Session Anchor UPF is allocated.
      For I-SMF insertion, if a new I-UPF tunnel endpoint for buffered DL data is received, the SMF triggers the transfer of buffered DL data to the new I-UPF tunnel endpoint for buffered DL data.
   If the DL tunnel information has changed, the SMF indicates the UPF (PSA) to send one or more “end marker” packets for each N9 tunnel to the old I-UPF immediately after switching the path to new I-UPF. From now on the PDU Session Anchor UPF begins to send the DL data to the new I-UPF as indicated in the new I-UPF DL tunnel information. The UPF (PSA) sends one or more “end marker” packets for each N9 tunnel to the old I-UPF immediately after switching the path to new I-UPF. If indicated by the new I-SMF in step 6, the new I-UPF reports to SMF when “end marker” has been received. The new SMF initiates N4 Session Modification procedure to indicate the new I-UPF to send the DL packet(s) received from the UPF (PSA).
8c. The SMF responds to the new I-SMF with Nsmf_PDUSession_Update Response (the DNAI(s) of interest for this PDU Session in the case of I-SMF change) or Nsmf_PDUSession_Create Response (the DNAI(s) of interest for this PDU Session. Tunnel Info at UPF (PSA) for UL data in the case of I-SMF insertion if it is allocated in step 8b).
9. The new I-SMF sends a Nsmf_PDUSession_CreateSMContext Response (N2 SM information (PDU Session ID, QFI(s), QoS profile(s), CN N3 Tunnel Info, S-NSSAI, User Plane Security Enforcement, UE Integrity Protection Maximum Data Rate), N1 SM Container, Cause)) to the AMF. The CN N3 Tunnel Info is the UL Tunnel Info of the new I-UPF.
. . .
   4.23.7.3 Inter NG-RAN Node N2 Based Handover with I-SMF Insertion/Change/Removal
. . .
   . . . (See FIG. 1C)
      FIG. 4.23.7.3.2-1: Inter NG-RAN Node N2 Based Handover, Preparation Phase, with I-SMF Insertion/Change/Removal
. . .
   4a. (I-SMF change case) Target I-SMF to Source I-SMF: Target I-SMF retrieves SM Context from the source I-SMF by invoking Nsmf_PDUSession_Context Request (SM context type, SM Context ID). The Target I-SMF uses SM Context ID received from T-AMF for this service operation. SM context type indicates that the requested information is all SM context, i.e. PDN Connection Context and 5G SM context. The SM Context ID is used by the recipient of Nsmf_PDUSession_Context Request in order to determine the targeted PDU Session.
   4b. Source I-SMF to Target i-SMF: Nsmf_PDUSession_Context Response. The source I-SMF responds with the requested SM context.
Case: I-SMF insertion, step 5 are skipped for I-SMF change case.
   5a. Target I-SMF to SMF: Target I-SMF retrieves SM Context from the SMF by invoking Nsmf_PDUSession_Context Request (SM context type. SM Context ID).
   . . .

In TS29.502 (V17.5.0), which is incorporated herein by reference in its entirety, some exemplary scenarios are defined as follows.

### 5.2.2.7 Create Service Operation

### 5.2.2.7.1 General

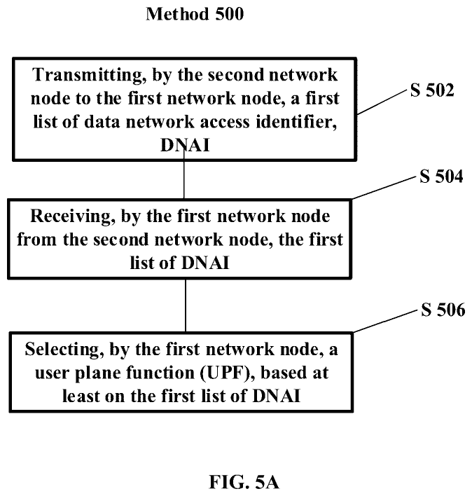

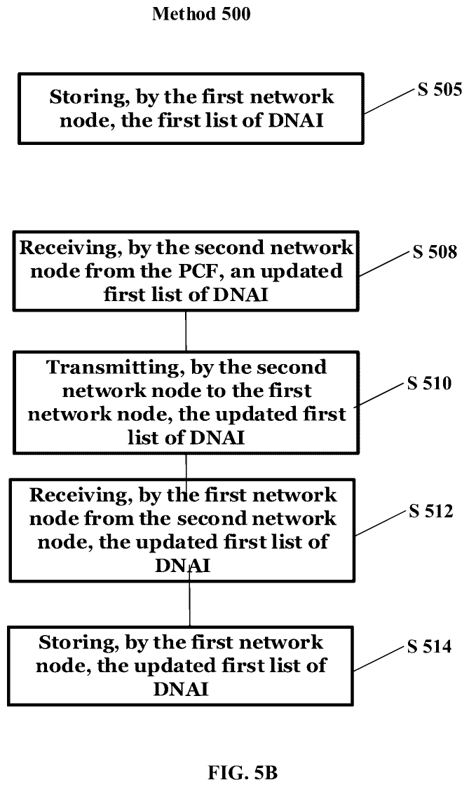

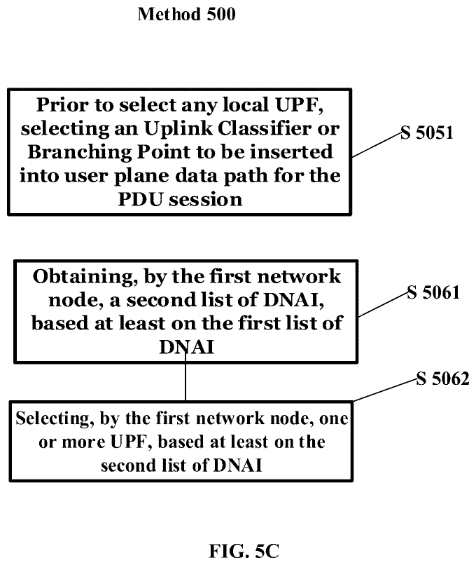

The Create service operation shall be used to create an individual PDU session in the H-SMF for HR roaming scenarios, or in the SMF for PDU sessions involving an I-SMF.
It is used in the following procedures:
   UE requested PDU Session Establishment with or without an I-SMF insertion (see clauses 4.3.2.2.2 and 4.23.5.1 of 3GPP TS 23.502 [3]);
   when an I-SMF is inserted during the Registration, Service Request, Inter NG-RAN node N2 based handover, Xn based handover, Handover from EPC/ePDG to 5GS and Handover from non-3GPP to 3GPP access procedures (see clauses 4.23.3, 4.23.4, 4.23.7.3, 4.23.11.2 and 4.23.16 of 3GPP TS 23.502 [3]);
   EPS to 5GS Idle mode mobility or handover using N26 interface (see clauses 4.11, 4.23.12.3, 4.23.12.5 and 4.23.12.7 of 3GPP TS 23.502 [3]);
   EPS to 5GS mobility without N26 interface (see clause 4.11.2.3 of 3GPP TS 23.502 [3]);
   Handover of a PDU session between 3GPP access and non-3GPP access, when the target AMF does not know the SMF resource identifier of the SM context used by the source AMF, e.g. when the target AMF is not in the PLMN of the N3IWF (see clause 4.9.2.3.2 of 3GPP TS 23.502 [3]);
   Handover from EPS to 5GC-N3IWF (see clause 4.11.3.1 of 3GPP TS 23.502 [3]);
   Handover from EPC/ePDG to 5GS (see clause 4.11.4.1 of 3GPP TS 23.502 [3]).
The NF Service Consumer (e.g. V-SMF or I-SMF) shall create a PDU session in the SMF (i.e. H-SMF for a HR PDU session, or SMF for a PDU session involving an I-SMF) by using the HTTP POST method as shown in FIG. 5.2.2.7.1-1.
   . . . (See FIG. 1D)

### FIG. 5.2.2.7.1-1: PDU Session Creation

. . .

TABLE 6.1.6.2.9-1
Definition of type PduSessionCreateData

| Attribute | | | | | |
|---|---|---|---|---|---|
| name | Data type | P | Cardinality | Description | Applicability |
| . . . | . . . | . . . | . . . | . . . | . . . |
| dnaiList | array(Dnai) | C | 1 . . . N | This IE shall be present over N16a if an I-SMF is | DTSSA |
| | | | | inserted into a PDU session during the following | |
| | | | | procedures: PDU session establishment, Registration, | |
| | | | | Service Request, Xn based handover, Inter NG-RAN | |
| | | | | node N2 based handover (see clause 4.23 of 3GPP | |
| | | | | TS 23.502 [3]). When present, it shall include the | |
| | | | | list of DNAIs supported by the I-SMF. | |
| . . . | . . . | . . . | . . . | . . . | . . . |

TABLE 6.1.6.2.10-1
Definition of type PduSessionCreatedData

| Attribute | | | | | |
|---|---|---|---|---|---|
| name | Data type | P | Cardinality | Description | Applicability |
| . . . | . . . | . . . | . . . | . . . | . . . |
| dnaiList | array(Dnai) | C | 1 . . . N | This IE shall be present over N16a, if available and an | DTSSA |
| | | | | I-SMF has been inserted into a PDU session, during the | |
| | | | | following procedures: PDU session establishment, | |
| | | | | Registration, Service Request, Xn based handover, Inter | |
| | | | | NG-RAN node N2 based handover (see clause 4.23 of | |
| | | | | 3GPP TS 23.502 [3]). | |
| | | | | When present, it shall include the list of DNAIs of | |
| | | | | interest for the PDU session for local traffic steering | |
| | | | | at the I-SMF. | |
| . . . | . . . | . . . | . . . | . . . | . . . |

TABLE 6.1.6.2.39-1
6.1.6.2.39 Type: SmContext
Definition of type SmContext

| | | | Cardi- | |
|---|---|---|---|---|
| Attribute name | Data type | P | nality | Description |
| pduSessionId | PduSessionId | M | 1 | This IE shall contain the PDU Session ID. |
| dnn | Dnn | M | 1 | This IE shall contain the UE requested DNN of |
| | | | | the PDU session. |
| | | | | The DNN shall be the full DNN (i.e. with both |
| | | | | the Network Identifier and Operator |
| | | | | Identifier) for a HR PDU session, and it |
| | | | | should be the full DNN in LBO and non-roaming |
| | | | | scenarios. If the Operator Identifier is absent, |
| | | | | the serving core network operator shall be |
| | | | | assumed. |
| selectedDnn | Dnn | C | 0 . . . 1 | This IE shall be present, if another DNN other |
| | | | | than the UE requested DNN is selected for this |
| | | | | PDU session. When present, it shall contain |
| | | | | the selected DNN. The DNN shall be the full DNN |
| | | | | (i.e. with both the Network Identifier and |
| | | | | Operator Identifier) for a HR PDU session, and |
| | | | | it should be the full DNN in LBO and non- |
| | | | | roaming scenarios. If the Operator Identifier is |
| | | | | absent, the serving core network operator |
| | | | | shall be assumed. |
| sNssai | Snssai | M | 1 | This IE shall contain the S-NSSAI for the serving PLMN. |
| hplmnSnssai | Snssai | C | 0 . . . 1 | This IE shall be present for a HR PDU session. When |
| | | | | present, it shall contain the S-NSSAI for the HPLMN. |
| pduSessionType | PduSessionType | M | 1 | This IE shall indicate the PDU session type. |
| gpsi | Gpsi | C | 0 . . . 1 | This IE shall be present if it is available. When present, |
| | | | | it shall contain the user's GPSI. |
| hSmfUri | Uri | C | 0 . . . 1 | This IE shall be present in HR roaming scenarios. When |
| | | | | present, it shall contain the API URI of the |
| | | | | Nsmf_PDUSession service of the H-SMF. The API URI shall |
| | | | | be formatted as specified in clause 6.1.1. |
| smfUri | Uri | C | 0 . . . 1 | This IE shall be present for a PDU session with an I-SMF. |
| | | | | When present, it shall contain the API URI of the |
| | | | | Nsmf_PDUSession service of the SMF. The API URI shall be |
| | | | | formatted as specified in clause 6.1.1. |
| pduSessionRef | Uri | C | 0 . . . 1 | This IE shall be present for a HR PDU session or a PDU |
| | | | | session with an I-SMF. |
| | | | | When present, this IE shall include the absolute URI of the |
| | | | | PDU Session in H-SMF or SMF, including apiRoot (see |
| | | | | clause 6.1.3.6.2) |
| interPlmnApiRoot | Uri | C | 0 . . . 1 | This IE shall be present, if available. |
| | | | | When present, it shall contain the apiRoot of the PDU session |
| | | | | context to be used in inter-PLMN signalling request targeting |
| | | | | the PDU session context. |
| | | | | (NOTE 2) |
| intraPlmnApiRoot | Uri | C | 0 . . . 1 | This IE shall be present, if available. |
| | | | | When present, it shall contain the apiRoot of the PDU session |
| | | | | context to be used in intra-PLMN signalling request targeting |
| | | | | the PDU session context. |
| | | | | (NOTE 2) |
| pcfId | NfInstanceId | O | 0 . . . 1 | When present, this IE shall contain the identifier of: |
| | | | | the H-PCF selected by the AMF (for UE Policy), for a |
| | | | | HR PDU session; or |
| | | | | the V-PCF selected by the AMF (for Access and |
| | | | | Mobility Policy), for a PDU session in LBO roaming |
| | | | | scenarios; or |
| | | | | the PCF selected by the AMF (for Access and Mobility |
| | | | | Policy and/or UE Policy), for a PDU session in non- |
| | | | | roaming scenarios. |
| pcfGroupId | NfGroupId | O | 0 . . . 1 | This IE may be present in non-roaming and HR roaming |
| | | | | scenarios. |
| | | | | When present, this IE shall contain the identity of the |
| | | | | (home) PCF group serving the UE for Access and Mobility |
| | | | | Policy and/or UE Policy. |
| pcfSetId | NfSetId | O | 0 . . . 1 | This IE may be present if the pcfId IE is present. |
| | | | | When present, it shall contain the NF Set ID of the PCF |
| | | | | indicated by the pcfId IE. |
| selMode | DnnSelectionMode | C | 0 . . . 1 | This IE shall be present if it is available. When present, |
| | | | | it shall be set to: |
| | | | | “VERIFIED”, if the requested DNN provided by UE or |
| | | | | the selected DNN provided by the network corresponds |
| | | | | to an explicitly subscribed DNN; or |
| | | | | “UE_DNN_NOT_VERIFIED”, if the requested DNN |
| | | | | provided by UE corresponds to the usage of a wildcard |
| | | | | subscription; or |
| | | | | “NW_DNN_NOT_VERIFIED”, if the selected DNN |
| | | | | provided by network corresponds to the usage of a |
| | | | | wildcard subscription. |
| | | | | If both the requested DNN (i.e. dnn IE) and selected |
| | | | | DNN (i.e. selected Dun IE) are present, the selMode shall |
| | | | | be related to the selected DNN. |
| udmGroupId | NfGroupId | O | 0 . . . 1 | When present, it shall indicate the identity of the UDM group |
| | | | | serving the UE. |
| routingIndicator | string | O | 0 . . . 1 | When present, it shall indicate the Routing Indicator of the |
| | | | | UE. |
| hNwPubKeyId | integer | O | 0 . . . 1 | When present, it shall indicate the Home Network Public Key |
| | | | | Identifier of the UE. (NOTE 1) |
| sessionAmbr | Ambr | M | I | This IE shall contain the Session AMBR granted to the PDU |
| | | | | session. |
| qosFlowsList | array(QosFlowSetupItem) | M | 1 . . . N | This IE shall contain the set of QoS flow(s) established for the |
| | | | | PDU session. It shall contain at least the Qos flow associated |
| | | | | to the default Qos rule. |
| | | | | The qosRules attribute of each QosFlowSetupItem shall be set |
| | | | | to an empty string. |
| hSmfInstanceId | NfInstanceId | C | 0 . . . 1 | This IE shall be present for a HR PDU session. |
| | | | | When present, it shall contain the identifier of the home SMF. |
| smfInstanceId | NfInstanceId | C | 0 . . . 1 | This IE shall be present for a PDU session with an I-SMF. |
| | | | | When present, it shall contain the identifier of the SMF. |
| pduSessionSmfSetId | NfSetId | C | 0 . . . 1 | This IE shall be present, if available. |
| | | | | When present, this IE shall contain the NF Set ID of the home |
| | | | | SMF as identified by hSmfInstanceId, or the SMF as identified |
| | | | | by the smfInstanceId. |
| pduSessionSmfServiceSetId | NfServiceSetId | C | 0 . . . 1 | This IE shall be present, if available. |
| | | | | When present, this IE shall contain the NF Service Set ID of |
| | | | | the PDUSession service instance (for this PDU session) in the |
| | | | | home SMF or the SMF. |
| pduSessionSmfBinding | SbiBindingLevel | C | 0 . . . 1 | This IE shall be present, if available. |
| | | | | When present, this IE shall contain the SBI binding level of the |
| | | | | PDU session resource in the home SMF or the SMF. |
| enablePauseCharging | boolean | C | 0 . . . 1 | This IE shall be present for a HR PDU session, if available. |
| | | | | When present, it shall indicate whether the use of Pause of |
| | | | | Charging is enabled for the PDU session (see clause 4.4.4 of |
| | | | | 3GPP TS 23.502 [3]). |
| | | | | When present, it shall be set as follows: |
| | | | | true: enable Pause of Charging; |
| | | | | false (default): disable Pause of Charging. |
| ueIpv4Address | Ipv4Addr | C | 0 . . . 1 | This IE shall be present if a UE IPv4 address to the |
| | | | | PDU session. |
| ueIpv6Prefix | Ipv6Prefix | C | 0 . . . 1 | This IE shall be present if a UE IPv6 prefix to the |
| | | | | PDU session. |
| epsPdnCnxInfo | EpsPdnCnxInfo | C | 0 . . . 1 | This IE shall be present if the PDU session may be |
| | | | | moved to EPS during its lifetime. |
| epsBearerInfo | array(EpsBearerInfo) | C | 1 . . . N | This IE shall be present if the PDU session may be |
| | | | | moved to EPS during its lifetime. |
| maxIntegrityProtectedDataRate | MaxIntegrityProtectedDataRate | C | 0 . . . 1 | This IE shall be present if the upSecurity IE is present and |
| | | | | indicates that integrity protection is preferred or required. |
| | | | | When present, it shall indicate the maximum integrity |
| | | | | protected data rate for uplink. |
| | | | | If the maxIntegrityProtectedDataRateDl IE is absent, this IE |
| | | | | applies to both uplink and downlink. |
| maxIntegrityProtectedDataRateDl | MaxIntegrityProtectedDataRate | C | 0 . . . 1 | This IE may be present if the upSecurity IE is present and |
| | | | | indicates that integrity protection is preferred or required. |
| | | | | When present, it shall indicate the maximum integrity |
| | | | | protected data rate for downlink. |
| alwaysOnGranted | boolean | C | 0 . . . 1 | This IE shall be present if available. When present, it shall |
| | | | | indicate whether this is an always On PDU session and it shall |
| | | | | be set as follows: |
| | | | | true: always-on PDU session granted. |
| | | | | false (default): always-on PDU session not granted. |
| upSecurity | UpSecurity | O | 0 . . . 1 | When present, this IE shall indicate the security policy for |
| | | | | integrity protection and encryption for the user plane of the |
| | | | | PDU session. |
| hSmfServiceInstanceId | string | O | 0 . . . 1 | This IE may be present for a HR PDU session. |
| | | | | When present, this IE shall contain the serviceInstanceId of |
| | | | | the H-SMF service instance serving the PDU session. |
| | | | | This IE may be used by the V-SMF to identify PDU sessions |
| | | | | affected by a failure or restart of the H-SMF service |
| | | | | (see clause 6.2 of 3GPP TS 23.527 [24]). |
| smfServiceInstanceId | string | O | 0 . . . 1 | This IE may be present for a PDU session with an I-SMF. |
| | | | | When present, this IE shall contain the serviceInstanceId of |
| | | | | the SMF service instance serving the PDU session. |
| | | | | This IE may be used by the I-SMF to identify PDU sessions |
| | | | | affected by a failure or restart of the SMF service (see |
| | | | | clause 6.2 of 3GPP TS 23.527 [24]). |
| recoveryTime | DateTime | O | 0 . . . 1 | This IE may be present if available. |
| | | | | When present, this IE shall indicate the timestamp when the H- |
| | | | | SMF or SMF service instance serving the PDU session was |
| | | | | (re)started (see clause 6.3 of 3GPP TS 23.527 [24]). |
| forwardingInd | boolean | C | 0 . . . 1 | This IE shall be present, when downlink data packets are |
| | | | | buffered at I-UPF. The SMF or I-SMF shall use this IE to |
| | | | | inform the NF service consumer that a forwarding tunnel is |
| | | | | needed for receiving the buffered downlink data packets, as |
| | | | | specified in clause 4.23.4 of 3GPP TS 23.502 [3]. |
| | | | | When present, this IE shall be set as follows: |
| | | | | true: a forwarding tunnel is needed for sending buffered |
| | | | | downlink data packets; |
| | | | | false (default): forwarding tunnel is not needed |
| psaTunnelInfo | TunnelInfo | C | 0 . . . 1 | This IE shall be present if available. |
| | | | | When present, this IE shall contain the N9 tunnel information |
| | | | | of PDU Session Anchor UPF controlled by SMF or H-SMF. |
| chargingId | string | C | 0 . . . 1 | This IE shall be present for a HR PDU session, in scenarios |
| | | | | with a V-SMF insertion/change/removal. |
| | | | | When present, it shall contain the Charging ID of the PDU |
| | | | | session (see 3GPP TS 32.255 [25]). |
| chargingInfo | ChargingInformation | C | 0 . . . 1 | This IE shall be present for a HR PDU session, if available |
| | | | | and if the NF Service Consumer requesting the SM Context |
| | | | | pertains to the same PLMN (i.e. if the Retrieve SM Context |
| | | | | Request does not contain the servingNetwork attribute set to a |
| | | | | different PLMN ID). |
| | | | | When present, it shall contain the addresses of the V-CHF |
| | | | | used for the PDU session. |
| roamingChargingProfile | RoamingChargingProfile | C | 0 . . . 1 | This IE shall be present for a HR PDU session, if available |
| | | | | and if the NF Service Consumer requesting the SM Context |
| | | | | pertains to the same PLMN (i.e. if the Retrieve SM Context |
| | | | | Request does not contain the servingNetwork attribute set to a |
| | | | | different PLMN ID). |
| | | | | When present, it shall contain the Roaming Charging Profile |
| | | | | selected by the HPLMN (see clauses 5.1.9.1, 5.2.1.7 and |
| | | | | 5.2.2.12.2 of 3GPP TS 32.255 [25]). |
| nefExtBufSupportInd | boolean | C | 0 . . . 1 | This IE shall be present with value “true”, if the anchor NEF |
| | | | | has indicated support of Extended Buffering for mobile |
| | | | | terminated data during SMF-NEF connection establishment. |
| | | | | When present, this IE shall be set as following: |
| | | | | true: Extended Buffering supported by NEF |
| | | | | false (default): Extended Buffering not supported by NEF |
| ipv6Index | IpIndex | C | 0 . . . 1 | This IE shall be present during I-SMF change scenarios, if |
| | | | | IPv6 Index has previously been received by old I-SMF. |
| dnAaaAddress | IpAddress | O | 0 . . . 1 | When present, this IE shall contain the address of DN-AAA |
| | | | | server for UE IP Address allocation previously received by old |
| | | | | I-SMF. |
| redundantPduSessionInfo | RedundantPduSessionInformation | C | 0 . . . 1 | This IE shall be present for a PDU session with an I-SMF, if |
| | | | | this information has been received previously from the UE, the |
| | | | | anchor SMF or the old I-SMF. |
| ranTunnelInfo | QosFlowTunnel | C | 0 . . . 1 | This IE shall be present if the ranUnchangedInd IE is set to |
| | | | | “true” in the SM context retrieve request. |
| | | | | When present, this IE shall contain the N2 tunnel information |
| | | | | of NG-RAN with associated QoS flows (see “DL QoS Flow per |
| | | | | TNL Information” in clause 9.3.4.2 of 3GPP 38.413 [9]). |
| addRanTunnelInfo | array(QosFlowTunnel) | C | 1 . . . N | This IE shall be present if the ran UnchangedInd IE is set to |
| | | | | “true” in the SM context retrieve request. |
| | | | | When present, this IE shall contain the additional N2 tunnel |
| | | | | information of NG-RAN together with associated QoS flows |
| | | | | for split PDU session (see “Additional DL QoS Flow per TNL |
| | | | | Information” in clause 9.3.4.2 of 3GPP 38.413 [9]). |
| redRanTunnelInfo | QosFlowTunnel | C | 0 . . . 1 | This IE shall be present if the ranUnchangedInd IE is set to |
| | | | | “true” in the SM context retrieve request. |
| | | | | When present, this IE shall contain the additional N2 tunnel |
| | | | | information of NG-RAN together with associated QoS flows |
| | | | | for Redundant QoS Flow(s) (see “Redundant DL QoS Flow per |
| | | | | TNL Information” in clause 9.3.4.2 of 3GPP 38.413 [9]). |
| addRedRanTunnelInfo | array(QosFlowTunnel) | C | 1 . . . N | This IE shall be present if the ranUnchangedInd IE is set to |
| | | | | “true” in the SM context retrieve request. |
| | | | | When present, this IE shall contain the additional N2 tunnel |
| | | | | information of NG-RAN together with associated QoS flows |
| | | | | for Redundant QoS Flow(s) with split PDU session (see |
| | | | | “Additional Redundant DL QoS Flow per TNL Information” in |
| | | | | clause 9.3.4.2 of 3GPP 38.413 [9]). |
| nspuSupportInd | boolean | C | 0 . . . 1 | This IE shall be present and set to “true” if the |
| | | | | enablePauseCharging in the SmContext data type is set to |
| | | | | “true” and if the (H-)SMF and PSA UPF support Notify Start |
| | | | | Pause of Charging via user plane feature as specified in |
| | | | | clause 5.30 of 3GPP TS 29.244 [29]. |
| | | | | When present, it shall be set as follows: |
| | | | | true: Notify Start Pause of Charging via user plane |
| | | | | feature is supported. |
| smfBindingInfo | string | C | 0 . . . 1 | This IE shall be present, if available. |
| | | | | When present, this IE shall contain the Binding indications of |
| | | | | the PDU session resource in the home SMF or the SMF and |
| | | | | shall be set to the value of the 3gpp-Sbi-Binding header |
| | | | | defined in clause 5.2.3.2.6 of 3GPP TS 29.500 [4], without the |
| | | | | header name. |
| satelliteBackhaulCat | SatelliteBackhaulCategory | O | 0 . . . 1 | When present, this IE shall indicate the satellite backhaul |
| | | | | category information last signalled towards the anchor |
| | | | | SMF, if any. |
| sscMode | string | C | 0 . . . 1 | This IE shall be present, if available. |
| | | | | When present, this IE shall indicate the SSC mode applicable |
| | | | | to the PDU session. |
| | | | | When present, it shall be encoded as one character in |
| | | | | hexadecimal representation, taking a value of “0” to “7”, |
| | | | | representing the 3 bits of the SSC mode value of the SSC mode |
| | | | | IE specified in clause 9.11.4.16 of 3GPP TS 24.501 [7]. |
| | | | | Pattern: “\hat{ }[0-7]$” |
| | | | | Example: SSC mode 3 shall be encoded as “3”. |

(NOTE 1):
If present, this attribute shall be used together with routingIndicator. This attribute is only used by
the HPLMN in roaming scenarios.
(NOTE 2):
See NOTE 7 of Table 6.1.6.2.10-1.

In these exemplary scenarios, some problems exist.

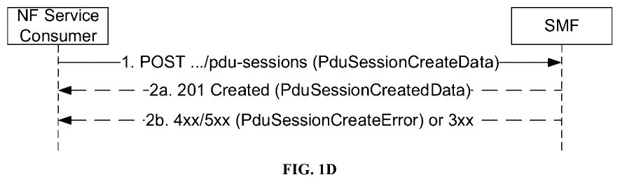

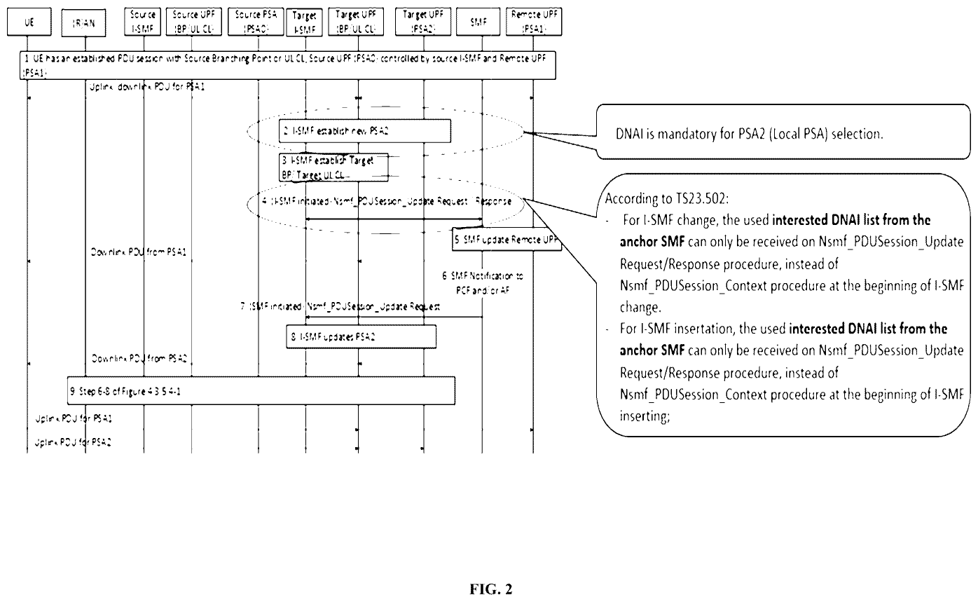

FIG. 2 is a diagram showing a problem for Simultaneous change of Branching Point or UL CL and additional PSA controlled by different I-SMFs.

In the scenario of simultaneous change of I-SMF, or V-SMF, or PSA, such as Branching Point or UL CL and additional PSA, controlled by different I-SMFs, there are two ways of signaling processing.

In an applied scenario 1, change of ULCL/BP and Local PSA is performed after mobility procedure (Xn or N2 mobility). There is no issue for this way of signaling processing.

In an applied scenario 2, change of ULCL/BP and Local PSA is embedded in mobility procedure. The picture in chapter 4.23.9.5 of TS23.502 (V17.5.0) indicates this scenario.

As described in TS23.502:
In the case of I-SMF change, the new I-SMF invokes Nsmf_PDUSession_Update Request (SM Context ID, new I-UPF DL tunnel information, SM Context ID at I-SMF, Access Type, RAT Type, DNAI list supported by the new I-SMF. Operation Type) towards the SMF. The new I-SMF uses the SM Context ID at SMF received from old I-SMF for this service operation.
In the case of I-SMF insertion, the new I-SMF invokes Nsmf_PDUSession_Create Request (new I-UPF DL tunnel information, new I-UPF tunnel endpoint for buffered DL data, SM Context ID at I-SMF, Access Type, RAT type, DNAI list supported by the new I-SMF, Operation Type) towards the SMF.
. . .
The SMF responds to the new I-SMF with Nsmf_PDUSession_Update Response (the DNAI(s) of interest for this PDU Session in the case of I-SMF change) or Nsmf_PDUSession_Create Response (the DNAI(s) of interest for this PDU Session, Tunnel Info at UPF (PSA) for UL data in the case of I-SMF insertion if it is allocated in step 8b).
. . .

Refer to the following TS23.502 description, SMF provides ““the list of DNAI(s) of interest” based on the DNAI list information received from I-SMF.

### 4.23.5.1 PDU Session Establishment Procedure

. . . The I-SMF provides the DNAI list it supports to SMF and the SMF provides the DNAI(s) of interest for this PDU Session to I-SMF based on the DNAI list information received from I-SMF as defined in FIG.

### 4.23.9.1-1 Step 1.

### 4.23.9 Branching Point or UL CL Controlled by I-SMF

. . .
   2. Based on the DNAI list information received from I-SMF, the SMF may then at any time provide or update the list of DNAI(s) of interest for this PDU Session to I-SMF. This may take place e.g. when the I-SMF provides the DNAI list it supports or when new or updated or removed PCC rule(s) is/are received by the SMF as defined in clause 4.23.6. This list of DNAI(s) of interest for this PDU Session indicates to the I-SMF the list of DNAI(s) candidate for local traffic steering within the PDU Session.

According to the above standard description, the DNAI(s) of interest for this PDU Session in the case of I-SMF change/insert is the final common list for the DNAI(s) of interest for this PDU Session and DNAI list supported by the new I-SMF, generated by excluding the DNAI list not supported by the I-SMF.

For the applied scenario 2 of TS23.502, 4.23.9.5, there are the following two problems:

For problem 1, during the mobility procedure, I-SMF is changed, and simultaneously, UL CL and local PSA are changed. When I-SMF is changed, local PSA need be selected immediately, DNAI is the mandatory input for I-SMF selecting Local PSA. The problem is that the DNAI is not available at that time point, the DNAI(s) of interest for this PDU Session need wait for the late procedure Nsmf_PDUSession_Update Request/Response with the anchor SMF. Or, I-SMF may only select I-UPF and wait for the late procedure Nsmf_PDUSession_Update Request/Response to get dnailist of interest to select new ULCL/PSA0, then the previously I-UPF may need be removed if a combined ULCL/PSA0 is selected.

For problem 2, during the mobility procedure, I-SMF is inserted, and simultaneously, ULCL and local PSA are changed. When I-SMF is inserted, local PSA need be selected immediately, DNAI is the mandatory input for I-SMF selecting Local PSA. The problem is that the DNAI is not available at that time point, the DNAI(s) of interest for this PDU Session need wait for the late procedure Nsmf_PDUSession_Create Request/Response with the anchor SMF. Or, I-SMF may only select I-UPF and wait for the late procedure Nsmf_PDUSession_Update Request/Response to get dnailist of interest to select new ULCL/PSA0, then the previously I-UPF may need be removed if a combined ULCL/PSA0 is selected.

In general, without DANI list information, simultaneous change of branching point or UL CL and additional PSA controlled by different I-SMFs in applied scenario 2 as in TS23.502, 4.23.9.5 can't work, or the ULCL/PSA can't be selected as early as possible.

For problem 3, it is not optimized and flexible to let anchor SMF to generate a dnai of interest. For example, if I-SMF change the local supported dnai list, it needs always to inform anchor SMF to generate dnailist of interest. The embodiments of the present disclosure can let the I-SMF generates it.

To solve the above problems, embodiments of the present disclosure propose the following solutions.

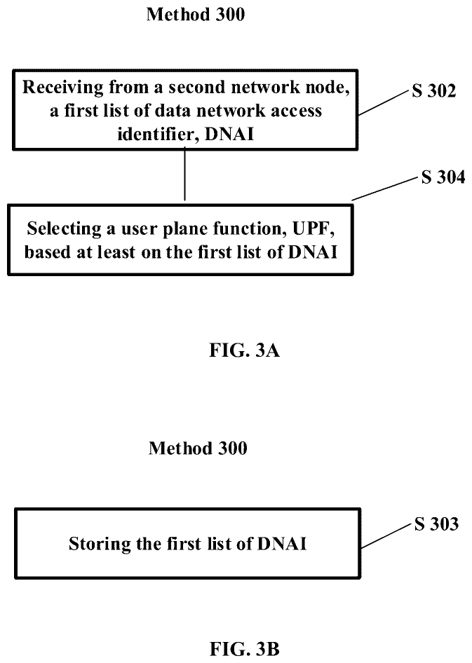

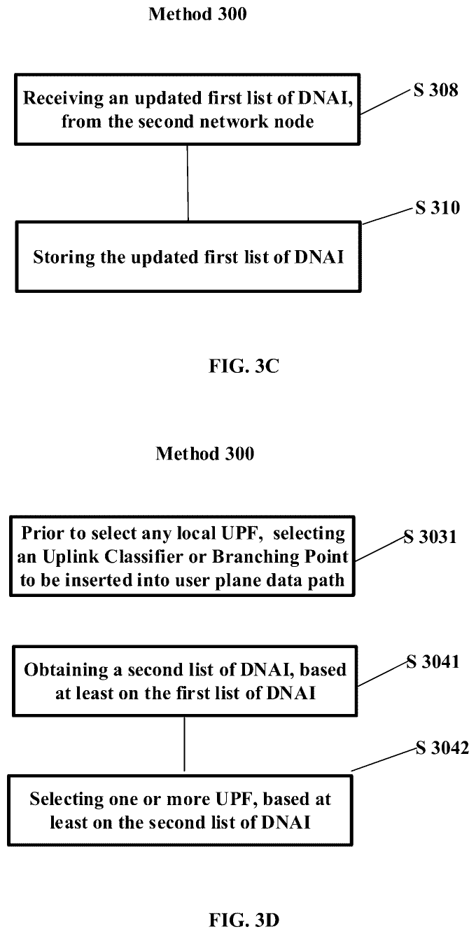

FIG. 3A is an exemplary flow chart for a method performed by a first network node, according to exemplary embodiments of the present disclosure.

As shown in FIG. 3A, the method 300 comprises: a step S302, receiving from a second network node, a first list of data network access identifier (DNAI); and a step S304, selecting a user plane function (UPF), based at least on the first list of DNAI.

In embodiments of the present disclosure, the UPF comprises at least one of: an Intermediate UPF, I-UPF, a visited UPF, V-UPF, or a local protocol data unit session anchor, PSA, for a protocol data unit, PDU, session.

According to embodiments of the present disclosure, improved methods and improved apparatuses for UPF, such as I-UPF, V-UPF, or protocol data unit session anchor (PSA), selection may be provided.

Particularly, by receiving a first list of DNAI, a first network node may select UPF based at least one the first list of DNAI in time when needed. Therefore, the problem that the DNAI might not be available when the network node needs to select a UPF at some time point will be avoided.

FIG. 3B is an exemplary flow chart showing addition steps of method shown in FIG. 3A, according to exemplary embodiments of the present disclosure.

As shown in FIG. 3B, in embodiments of the present disclosure, the method 300 may further comprise: a step 303, storing the first list of DNAI.

FIG. 3C is an exemplary flow chart showing further addition steps of method shown in FIG. 3A, according to exemplary embodiments of the present disclosure.

As shown in FIG. 3C, in embodiments of the present disclosure, the method 300 may further comprise: a step S308, receiving an updated first list of DNAI, from the second network node; and a step S310, storing the updated first list of DNAI.

FIG. 3D is an exemplary flow chart showing substeps of method shown in FIG. 3A, according to exemplary embodiments of the present disclosure.

As shown in FIG. 3D, selecting the UPF comprises: a substep S3041, obtaining a second list of DNAI, based at least on the first list of DNAI, and/or a configuration; and a substep S3042, selecting one or more UPF (e.g., which may be new local PSA) for a PDU session (particularly in Edge Computing), based at least on the second list of DNAI.

In embodiments of the present disclosure, the method may further comprise: prior to select any local UPF (e.g., which may be new local PSA specifically), a step S3031, selecting an Uplink Classifier or Branching Point to be inserted into user plane data path, such as for the PDU session.

In embodiments of the present disclosure, the first list of DNAI may be a full DNAI list. The second list of DNAI may be a list of DNAIs that are both included in the first list of DNAI and supported by the first network node.

In embodiments of the present disclosure, the full DNAI list is a DNAI list of interest for a protocol data unit, PDU, session, excluding one or more DNAIs supported by the second network node, or not excluding one or more DNAIs supported by the second network node.

In embodiments of the present disclosure, the first network node may comprise: a first intermediate session management function (I-SMF), or a first V-SMF.

In embodiments of the present disclosure, the second network node may comprise: a second intermediate session management function (I-SMF), or a second V-SMF, or a session management function (SMF).

In embodiments of the present disclosure, the first list of DNAI may be received via a message of Nsmf_PDUSession_Context Response, and/or Nsmf_PDUSession_Update Request and/or Response, and/or Nsmf_PDUSession_Create Response.

In embodiments of the present disclosure, the first I-SMF may be a newly inserted I-SMF or a target I-SMF at an inter I-SMF mobility procedure. Or, the first I-SMF may be an inserted I-SMF, or a target I-SMF when changing I-SMF.

In embodiments of the present disclosure, the second network node may comprise: an anchor SMF.

In embodiments of the present disclosure, the first list of DNAI may be received via at least one of Nsmf_PDUSession_Context Response message, Nsmf_PDUSession_Update Request message, Nsmf_PDUSession_Update Request Response message, or Nsmf_PDUSession_Create Response message.

In embodiments of the present disclosure, the first network node may receive the first list of DNAI, during at least one of flowing procedures: protocol data unit session establishment, registration, service request, inter next generation-radio access network node N2 based handover, Xn based handover, handover from evolved packet core/evolved packet data gateway to 5th generation system, and/or handover from non-3rd generation partnership project access to 3rd generation partnership project access (particularly 5th generation system).

According to embodiments of the present disclosure, the first network node (such as an inserted/changed I-SMF, or V-SMF) generates the second list of DNAI (such as “common supported Dnai list for I-SMF and SMF”) based on a local configuration (such as locally configured supported dnaiList of I-SMF) and the received first list of DNAI (such as a new fullDnaiList). That means I-SMF generates “dnailist of interest” by itself.

Particularly, for some scenarios (such as the simultaneous change of ULCL/BP and additional PSA controlled by different I-SMFs applied during the mobility procedure (TS23.502 4.23.9.5)), the changed I-SMF is able to select Local PSA.

Further, for other scenarios (such as the simultaneous change of UL CL/BP and additional PSA controlled by different I-SMFs applied during the mobility procedure (TS23.502 4.23.9.5)), the inserted I-SMF is able to select Local PSA.

FIG. 4A is an exemplary flow chart for a method performed by a second network node, according to exemplary embodiments of the present disclosure.

As shown in FIG. 4A, the method 400 comprises: a step S402, transmitting to a first network node, a first list of data network access identifier (DNAI). The first list of DNAI may be used for the first network node to select a user plane function (UPF) for a PDU session, based at least on the first list of DNAI.

In embodiments of the present disclosure, the local UPF comprises at least one of: an Intermediate UPF, I-UPF, a visited UPF, V-UPF, or a local protocol data unit session anchor, PSA, for a protocol data unit, PDU, session.

FIG. 4B is an exemplary flow chart showing addition steps of method shown in FIG. 4A, according to exemplary embodiments of the present disclosure.

As shown in FIG. 4B, in embodiments of the present disclosure, the method 400 may further comprise: a step S404, receiving an updated first list of DNAI, from a PCF; and a step S406, transmitting the updated first list of DNAI, to the first network node.

In embodiments of the present disclosure, the first list of DNAI is used for the first network node to obtain a second list of DNAI based at least on the first list of DNAI, and/or a configuration, and select one or more UPF (e.g., which may be new I-UPF, V-UPF, or local PSA) for the PDU session based at least on the second list of DNAI.

In embodiments of the present disclosure, the first network node selects an Uplink Classifier or Branching Point to be inserted into user plane data path for the PDU session, prior to select any local UPF (e.g., which may be new local PSA).

In embodiments of the present disclosure, the first list of DNAI may be a full DNAI list. The second list of DNAI may be a list of DNAIs that are both included in the first list of DNAI and supported by the first network node.

In embodiments of the present disclosure, the full DNAI list is a DNAI list of interest for a protocol data unit, PDU, session, excluding one or more DNAIs supported by the second network node, or not excluding one or more DNAIs supported by the second network node.

In embodiments of the present disclosure, the first network node may comprise: a first intermediate session management function (I-SMF), or a first V-SMF.

In embodiments of the present disclosure, the second network node may comprise: a second intermediate session management function (I-SMF), or a second V-SMF, or a session management function (SMF).

In embodiments of the present disclosure, the first list of DNAI may be transmitted via at least one of Nsmf_PDUSession_Context Response message, Nsmf_PDUSession_Update Request message, Response message, or Nsmf_PDUSession_Create Response message.

In embodiments of the present disclosure, the first I-SMF may be a newly inserted I-SMF or a target I-SMF at an inter I-SMF mobility procedure.

In embodiments of the present disclosure, the second network node may comprise: an anchor SMF.

In embodiments of the present disclosure, the first list of DNAI may be received via a message of Nsmf_PDUSession_Context Response, and/or Nsmf_PDUSession_Update Request and/or Response, and/or Nsmf_PDUSession_Create Response.

In embodiments of the present disclosure, the first I-SMF may be an inserted I-SMF, or a target I-SMF when changing I-SMF. The first network node may receive the first list of DNAI, during at least one of flowing procedures: protocol data unit session establishment, registration, service request, inter next generation-radio access network node N2 based handover, Xn based handover, handover from evolved packet core/evolved packet data gateway to 5th generation system, and/or handover from non-3rd generation partnership project access to 3rd generation partnership project access (5th generation system).

FIG. 5A is an exemplary flow chart for a method performed by a system including the first network node and the second network node, according to exemplary embodiments of the present disclosure.

As shown in FIG. 5A, the method 500 performed by the system comprises: a step S502, transmitting, by the second network node to the first network node, a first list of data network access identifier (DNAI); a step S504, receiving, by the first network node from the second network node, the first list of DNAI; and a step S506, selecting, by the first network node, a user plane function (UPF), based at least on the first list of DNAI.

In embodiments of the present disclosure, the local UPF comprises at least one of: an Intermediate UPF, I-UPF, a visited UPF, V-UPF, or a local protocol data unit session anchor, PSA, for a protocol data unit, PDU, session.

FIG. 5B is an exemplary flow chart showing addition steps of method shown in FIG. 5A, according to exemplary embodiments of the present disclosure.

In embodiments of the present disclosure, the method 500 may further comprise: a step S505, storing, by the first network node, the first list of DNAI.

In embodiments of the present disclosure, the method 500 may further comprise: a step S508, receiving, by the second network node from the PCF, an updated first list of DNAI; a step S510, transmitting, by the second network node to the first network node, the updated first list of DNAI; a step S512, receiving, by the first network node from the second network node, the updated first list of DNAI; and a step S514, storing, by the first network node, the updated first list of DNAI.

FIG. 5C is an exemplary flow chart showing substeps of method shown in FIG. 5A, according to exemplary embodiments of the present disclosure.

In embodiments of the present disclosure, selecting the UPF by the first network node for the terminal device comprises: a substep S5061, obtaining, by the first network node, a second list of DNAI, based at least on the first list of DNAI and/or a configuration; and a substep S5062, selecting, by the first network node, one or more UPF (e.g., which may be new I-UPF, or V-UPF, or local PSA) for the PDU session, based at least on the second list of DNAI.

In embodiments of the present disclosure, the method may further comprise: prior to select any local PSA (e.g., which may be new local PSA), a step S5051, selecting an Uplink Classifier or Branching Point to be inserted into user plane data path for the PDU session.

In embodiments of the present disclosure, the first list of DNAI may be a full DNAI list. The second list of DNAI may be a list of DNAIs that are both included in the first list of DNAI and supported by the first network node.

In embodiments of the present disclosure, the full DNAI list is a DNAI list of interest for a protocol data unit, PDU, session, excluding one or more DNAIs supported by the second network node, or not excluding one or more DNAIs supported by the second network node.

In embodiments of the present disclosure, the first network node may comprise: a first intermediate session management function (I-SMF), or a first V-SMF.

In embodiments of the present disclosure, the second network node may comprise: a second intermediate session management function (I-SMF), or a second V-SMF, or a session management function (SMF).

In embodiments of the present disclosure, the first list of DNAI may be received via at least one of: Nsmf_PDUSession_Context Response message, Nsmf_PDUSession_Update Request message, Nsmf_PDUSession_Update Response message, or Nsmf_PDUSession_Create Response message.

In embodiments of the present disclosure, the first I-SMF may be a newly inserted I-SMF or a target I-SMF at an inter I-SMF mobility procedure.

In embodiments of the present disclosure, the second network node may comprise: an anchor SMF.

In embodiments of the present disclosure, the first list of DNAI may be received via a message of Nsmf_PDUSession_Context Response, and/or Nsmf_PDUSession_Update Request and/or Response, and/or Nsmf_PDUSession_Create Response.

In embodiments of the present disclosure, the first I-SMF may be an inserted I-SMF, or a target I-SMF when changing I-SMF. The first network node may receive the first list of DNAI, during at least one of flowing procedures: protocol data unit session establishment, registration, service request, inter next generation-radio access network node N2 based handover, Xn based handover, handover from evolved packet core/evolved packet data gateway to 5th generation system, and/or handover from non-3rd generation partnership project access to 3rd generation partnership project access.

According to embodiments of the present disclosure, the anchor SMF stores a list of DNAIs of interest, which are used to instruct User Plane Function to route relevant application data towards a desired Data Network Access point (as identified by DNAI). This list of DNAIs is provisioned by the PCF as part of PCC rule authorization for the PDU session. The PCF determines the list of DNAIs for the PDU session by retrieving the AF traffic influence request information as part of the Application data from a UDR (Unified Data Repository), and/or being provisioned by the NEF when the NEF is establishing or updating an Application Session Context (via consuming Npcf_PolicyAuthoriztion service) upon receiving the traffic influence subscription request from an Application function. A new parameter “fullDnaiList” containing a list of DNAIs which is the list of DNAI of interest for the PDU session, excluding one or more DNAIs supported by the second network node, or not excluding one or more DNAIs supported by the second network node. That is, “All DnaiList from PCF provisioning without restricted to I-SMF supported Dnai list.” The I-SMF can get the this new “fullDnaiList” in the following cases:

As a case 1, when a new I-SMF is inserted during the UE (user equipment) mobility, the inserted I-SMF sends a message Nsmf_PDUSession_Context Request to retrieve the smContext from the anchor SMF. The anchor SMF provides the inserted I-SMF a new attribute fullDnaiList in Nsmf_PDUSession_Context Response (SmContextRetrievedData\smContext\fullDnaiList). The inserted I-SMF stores the received fullDnaiList. The new fullDnaiList may be put directly under SmContextRetrievedData.

As a case 2, during the mobility of I-SMF change, the target I-SMF sends Nsmf_PDUSession_Context Request to retrieve the smContext from the source I-SMF. The source I-SMF provides the target I-SMF a new attribute fullDnaiList in Nsmf_PDUSession_Context Response (SmContextRetrievedData\smContext\fullDnaiList), the target I-SMF stores the received fullDnaiList. The new fullDnaiList may be put directly under SmContextRetrievedData.

As a case 3, during PDU Session Establishment procedure, the Anchor SMF sends Nsmf_PDUSession_Create Response (PduSessionCreatedData\dnaiList, fullDnaiList).

As a case 4, the PCF informs the updated fullDnaiList to the SMF. The anchor SMF sends Nsmf_PDUSession_Update Request (VsmfUpdateData\dnaiList, fullDnaiList fullDnaiList) to the I-SMF.

As a case 5, 5 the SMF will send Nsmf_PDUSession_Update Response (HsmfUpdatedData (dnaiList, fullDnaiList) to the I-SMF.

If the inserted/changed I-SMF need select ULCL/BP and local PSA0 immediately, the inserted/changed I-SMF generates the “common supported Dnai list for I-SMF and SMF” based on locally configured supported dnaiList of I-SMF and new fullDnaiList. That means I-SMF generates “dnailist of interest” by itself, instead of receiving from later Nsmf_PDU Session_Update Response of anchor SMF, which is too late for the inserted I-SMF selecting local PSA0.

With this new fullDnaiList information, for simultaneous change of ULCL/BP and additional PSA controlled by different I-SMFs applied during the mobility procedure (TS23.502 4.23.9.5), Local PSA can be selected in time, i.e., correctly and as early as possible.

Embodiments of the present disclosure may provide the following advantages.

The inserted/changed I-SMF generates the “common supported Dnai list for I-SMF and SMF” based on locally configured supported dnaiList of I-SMF and the received new fullDnaiList. That means I-SMF generates “dnailist of interest” by itself.

For the simultaneous change of ULCL/BP and additional PSA controlled by different I-SMFs applied during the mobility procedure (TS23.502 4.23.9.5), the changed I-SMF is able to select UPF, such as I-UPF. V-UPF, or Local PSA in time, i.e., correctly and as early as possible.

For the simultaneous change of ULCL/BP and additional PSA controlled by different I-SMFs applied during the mobility procedure (TS23.502 4.23.9.5), the inserted I-SMF is able to select UPF, such as I-UPF, V-UPF, or Local PSA in time, i.e., correctly and as early as possible.

Further detailed exemplary application scenarios of the embodiments of the present disclosure may be illustrated below.

An exemplary application scenario may be associated to a solution for simultaneous change of ULCL/BP and additional PSA controlled by inserted I-SMF.

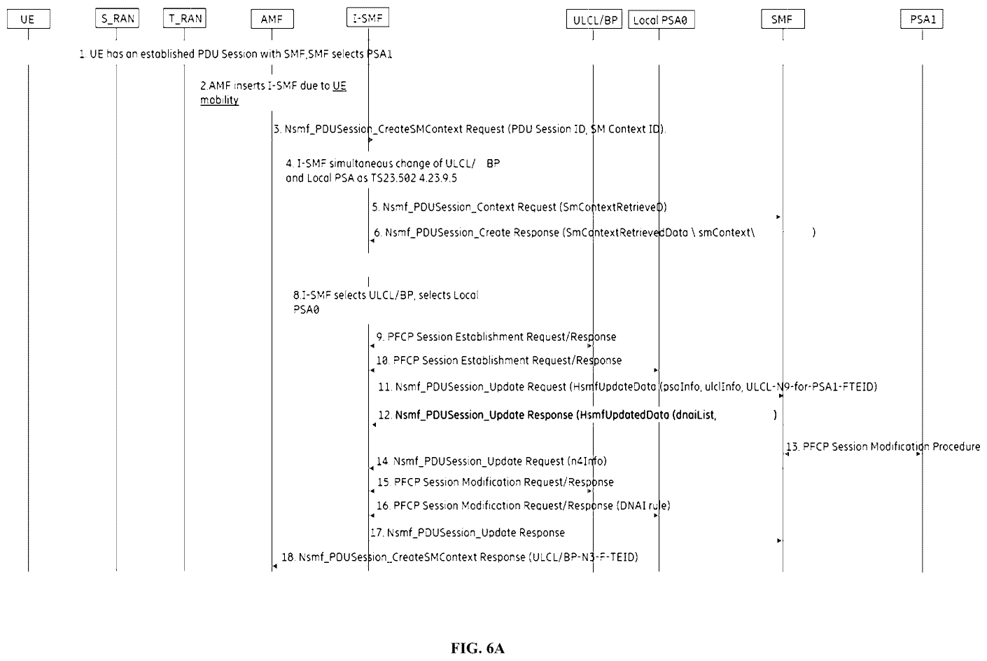

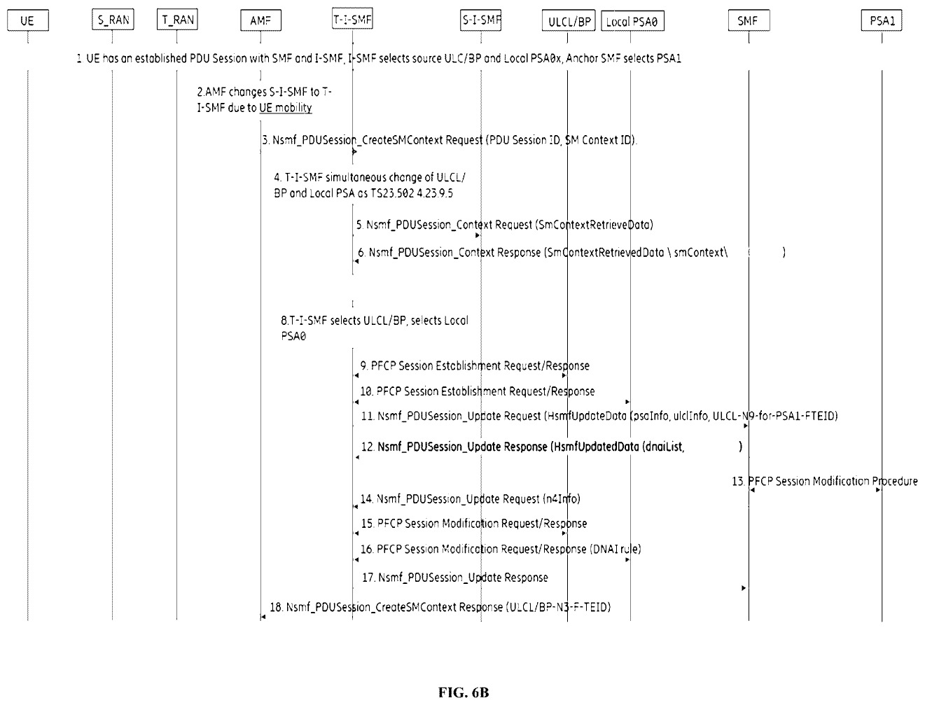

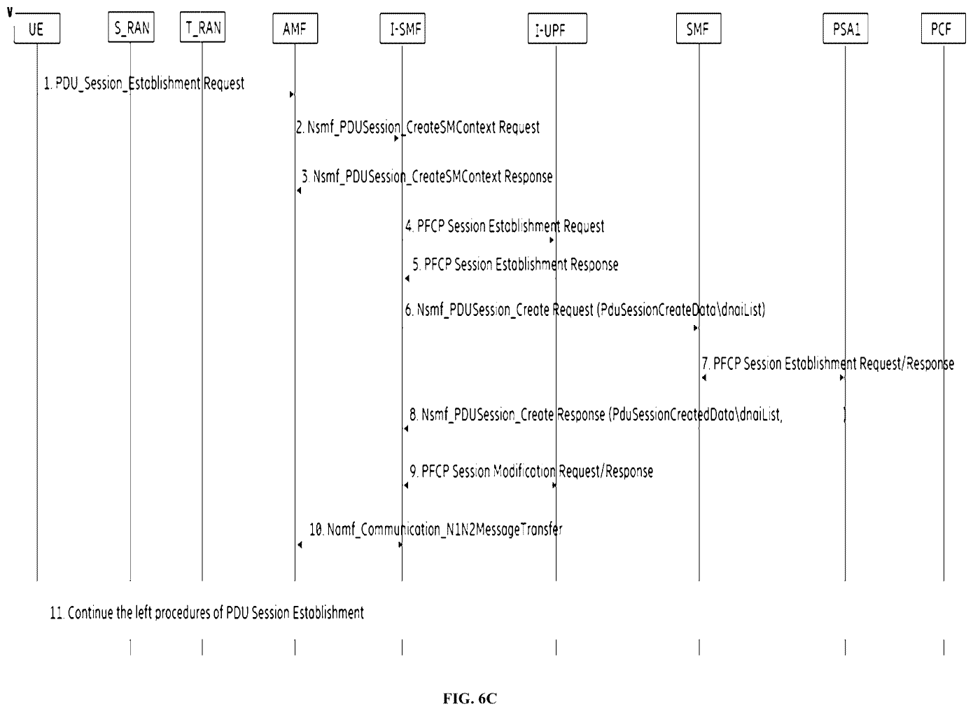

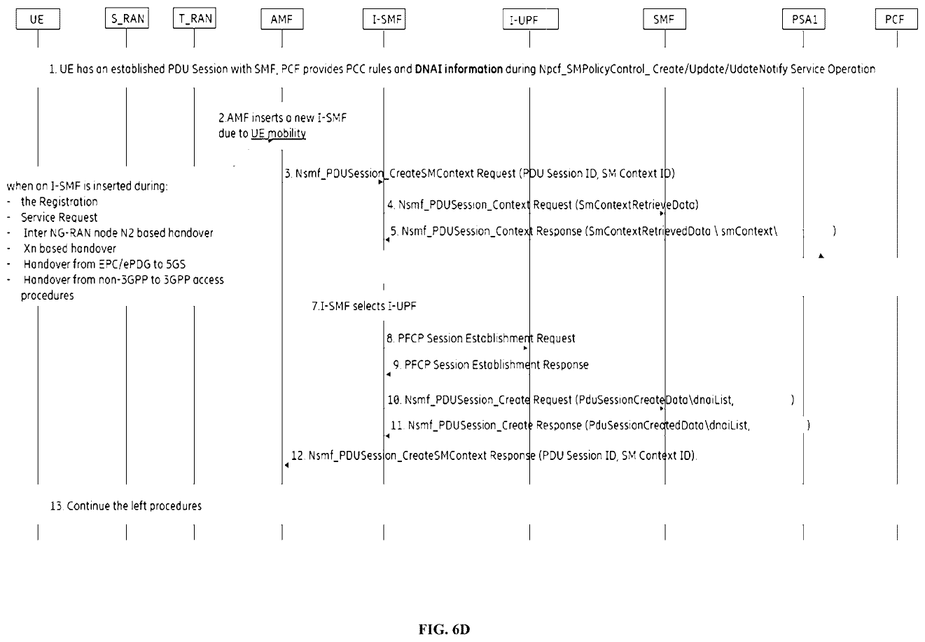

FIG. 6A is a diagram showing a solution for simultaneous change of ULCL/BP and additional PSA controlled by inserted I-SMF, according to embodiments of the present disclosure.

The improved procedure of this solution includes following steps:
1. The UE has an established PDU Session with SMF, and SMF selects PSA1.
2. The AMF inserted I-SMF due to UE mobility.
3. The AMF sends Nsmf_PDUSession_CreateSMContext Request (PDU Session ID, SM Context ID) to the inserted I-SMF.
4. The inserted I-SMF has simultaneous change of ULCL/BP and Local PSA as in TS23.502 4.23.9.5.
5. The inserted I-SMF sends Nsmf_PDUSession_Context Request (SmContextRetrieveData) to the anchor SMF.
6. The anchor SMF sends Nsmf_PDUSession_Create Response (SmContextRetrievedData\smContext\fullDnaiList), fullDnaiList means: all DnaiList from PCF provisioning without being restricted to supported Dnai list. For example, fullDnaiList may include DNAIs, b,c,d,e.
7. The I-SMF stores fullDnaiList.
8. The inserted I-SMF selects ULCL/BP, selects Local PSA0 based on the received fullDnaiList. That is: the inserted I-SMF generates the “common supported Dnai list for I-SMF and SMF” based on locally configured supported dnaiList of I-SMF (e.g., a, b, c) and the received new fullDnaiList. That means the inserted I-SMF generates “dnailist of interest” (b,c) by itself.
9. The inserted I-SMF performs PFCP Session Establishment Request/Response with the ULCL/BP.
10. The inserted I-SMF performs PFCP Session Establishment Request/Response with the Local PSA0.
11. The inserted I-SMF sends Nsmf_PDUSession_Create Request (psaInfo, ulclInfo, ULCL-N9-for-PSA1-FTEID) to the anchor SMF.
12. The anchor SMF sends Nsmf_PDUSession_Update Response (HsmfUpdatedData (dnaiList, fullDnaiList) to the I-SMF.
13. The anchor SMF performs PFCP (Packet Forwarding Control Protocol) Session Modification Procedure with the anchor UPF.
14. The anchor SMF sends Nsmf_PDUSession_Update Request (n4Info) to the I-SMF.
15. The inserted I-SMF performs PFCP Session Modification Request/Response with the ULCL/BP.
16. The inserted I-SMF performs PFCP Session Modification Request/Response with the Local PSA0.
17. The inserted I-SMF sends Nsmf_PDUSession_Update Response to the anchor SMF.
18. The inserted I-SMF sends Nsmf_PDUSession_CreateSMContext Response (ULCL/BP-N3-F-TEID) to the AMF.

An exemplary application scenario may be associated to a solution for simultaneous change of ULCL/BP and additional PSA controlled by changed I-SMF.

FIG. 6B is a diagram showing a solution for simultaneous change of ULCL/BP and additional PSA controlled by changed I-SMF, according to embodiments of the present disclosure.

The improved procedure of this solution includes following steps:
1. The UE has an established PDU Session with SMF and I-SMF, I-SMF selects source ULCL/BP and Local PSA0x, Anchor SMF selects PSA1.
2. AMF changes S-I-SMF to T-I-SMF due to UE mobility.
3. The AMF sends Nsmf_PDUSession_CreateSMContext Request (PDU Session ID, SM Context ID) to the T-I-SMF.
4. The T-I-SMF has simultaneous change of ULCL/BP and Local PSA as in TS23.502 4.23.9.5.
5. The T-I-SMF sends Nsmf_PDUSession_Context Request (SmContextRetrieveData) to the S-I-SMF.
6. The S-I-SMF sends Nsmf_PDUSession_Create Response (SmContextRetrievedData\smContext\fullDnaiList), fullDnaiList means: All DnaiList from PCF provisioning without restricted to I-SMF supported Dnai list.
7. The T-I-SMF stores fullDnaiList.
8. The T-I-SMF selects ULCL/BP, selects Local PSA0 based on the received fullDnaiList. The changed I-SMF selects ULCL/BP, selects Local PSA0 based on the received fullDnaiList. That is: the changed I-SMF generates the “common supported Dnai list for I-SMF and SMF” based on locally configured supported dnaiList of I-SMF and the received new fullDnaiList, that means the changed I-SMF generates “dnailist of interest” by itself.
9. The T-I-SMF performs PFCP Session Establishment Request/Response with the ULCL/BP.
10. The T-I-SMF performs PFCP Session Establishment Request/Response with the Local PSA0.
11. The inserted I-SMF sends Nsmf_PDUSession_Update Request (psaInfo, ulclInfo, ULCL-N9-for-PSA1-FTEID) to the anchor SMF.
12. The anchor SMF sends Nsmf_PDUSession_Update Response (HsmfUpdatedData (dnaiList, fullDnaiList) to the I-SMF.
13. The anchor SMF performs PFCP Session Modification Procedure with the anchor UPF.
14. The anchor SMF sends Nsmf_PDUSession_Update Request (n4Info) to the T-I-SMF.
15. The T-I-SMF performs PFCP Session Modification Request/Response with the ULCL/BP.
16. The T-I-SMF performs PFCP Session Modification Request/Response with the Local PSA0.
17. The T-I-SMF sends Nsmf_PDUSession_Update Response to the anchor SMF.
18. The T-I-SMF sends Nsmf_PDUSession_CreateSMContext Response (ULCL/BP-N3-F-TEID) to the AMF.

FIG. 6C is a diagram showing a PDU Session Establishment Procedure, during which a first list of DNAI (fullDaniList) is sent to a first network node (an inserted I-SMF).

The improved procedure of this solution includes following steps:
1. UE sends PDU_Session_Establishment Request to the AMF;
2. The AMF sends Nsmf_PDUSession_CreateSMContext Request to the I-SMF;
3. The I-SMF sends Nsmf_PDUSession_CreateSMContext Request to the AMF;
4. The I-SMF sends PFCP Session Establishment Request to the I-UPF;
5. The I-UPF sends PFCP Session Establishment Response to the I-SMF;
6. The I-SMF sends Nsmf_PDUSession_Create Request (PduSessionCreateData\dnaiList (supported by I-SMF) to the anchor SMF;
7. The anchor SMF sends PFCP Session Establishment Request to the PSA1, the PSAL sends PFCP Session Establishment Response to the anchor SMF;
8. The anchor SMF sends Nsmf_PDUSession_Create Response (PduSessionCreatedData\dnaiList, fullDnaiList) to the I-SMF;
9. The I-SMF performs PFCP Session Modification Request/Response with I-UPF;
10. The I-SMF sends Namf_Communication_NIN2MessageTransfer to the AMF;
11. Continue the left procedures of PDU Session Establishment.

FIG. 6D is a diagram showing a procedure, during which a first list of DNAI (fullDaniList) is sent to a first network node (an inserted I-SMF).

When a new I-SMF is inserted during the Registration, Service Request, Inter NG-RAN node N2 based handover, Xn based handover, Handover from EPC/ePDG to 5GS and Handover from non-3GPP to 3GPP access procedures (see clauses 4.23.3, 4.23.4, 4.23.7.3, 4.23.11.2 and 4.23.16 of 3GPP TS 23.502), the anchor SMF can send a new attribute fullDnaiList to the inserted I-SMF during the smContext retrieve procedure. The inserted I-SMF stores this fullDnaiList. The I-SMF can use this stored fullDnaiList to select local PSA when needed, or forward to new I-SMF if I-SMF changed due to UE mobility.

The improved procedure of this solution includes following steps:
1. UE has an established PDU Session with SMF, the PCF provides PCC rules and DNAI information during Npcf_SMPolicyControl_Create/Update/UpdateNotify Service Operation.
2. The AMF inserts a I-SMF due to UE mobility.
3. The AMF sends Nsmf_PDUSession_CreateSMContext Request (PDU Session ID, SM Context ID) to the inserted I-SMF.
4. The inserted I-SMF sends Nsmf_PDUSession_Context Request (SmContextRetrieveData) to the anchor SMF.
5. The anchor SMF sends Nsmf_PDUSession_Context Response (SmContextRetrievedData\smContext\fullDnaiList), fullDnaiList means: All DnaiList from PCF provisioning without restricted to I-SMF supported Dnai list.
6. The inserted I-SMF stores fullDnaiList.
7. The inserted I-SMF selects I-UPF (Intermediate-user plane function).
8. The inserted I-SMF sends PFCP Session Establishment Request to the I-UPF.
9. The I-UPF sends PFCP Session Establishment Response to the inserted I-SMF.
10. The inserted I-SMF sends Nsmf_PDUSession_Create Request with supported dnaiList to the anchor SMF.
11. The anchor SMF sends Nsmf_PDUSession_Create Request with preferred dnaiList (that is restricted to the common supported dnaiList of I-SMF and anchor SMF, fullDnaiList) to the inserted I-SMF.
   Note: The anchor SMF can extend the existing dnaiList to fullDnaiList, or send a new fullDnaiList to the I-SMF.
12. The inserted I-SMF sends Nsmf_PDUSession_CreateSMContext Response (PDU Session ID, SM Context ID) to the AMF.

FIG. 6E is a diagram showing a procedure, during which a I-SMF is informed with latest fullDnaiLit from PCF.

During PDU session lifetime, the AF can send a new Dnai list to the PCF, the PCF can update it to the anchor SMF, the anchor SMF can update it to the I-SMF, then I-SMF will store it locally.

The improved procedure of this solution includes following steps:
1. UE has an established PDU Session with SMF, the PCF provides PCC (policy and charging control) rules and DNAI information during Npcf_SMPolicyControl_Create/Update/UpdateNotify Service Operation
2. The AF informs the PCF new policy and a new Dnai List. The PCF informs the anchor SMF by the following procedures:
   Npcf_SMPolicyControl_UpdateNotify_Reuqest (dnalList)/Response
   Npcf_SMPolicyControl_Update Reuqest/Response (dnalList)/Response
   Note: smPolicyDecsion\pccRule\trafficControlData\RouteToLocation list\dnaiDist
3. The anchor SMF sends Nsmf_PDUSession_Update Request (fullDnaiList) to the I-SMF.
4. The I-SMF stores the received fullDnaiList.
5-17. The new policy is enforced to the NG-RAN, UE and PSA1.

Further, this new attribute “fullDnaiList” may be defined as follows, as an improvement to definition of “6.1.6.2.39 Type: SmContext” in TS29.502 (V17.5.0).

TABLE 6.1.6.2.39-1
Definition of type SmContext

| Attribute | | | Cardi- | | |
|---|---|---|---|---|---|
| name | Data type | P | nality | Description | |
| pduSessionId | PduSessionId | M | 1 | This IE shall contain the PDU Session ID. | |
| dnn | Dnn | M | 1 | This IE shall contain the UE requested DNN of the | |
| | | | | PDU session. | |
| | | | | The DNN shall be the full DNN (i.e. with both the | |
| | | | | Network Identifier and Operator Identifier) for a HR | |
| | | | | PDU session, and it should be the full DNN in LBO | |
| | | | | and non-roaming scenarios. If the Operator | |
| | | | | Identifier is absent, the serving core network | |
| | | | | operator shall be assumed. | |
| selectedDnn | Dnn | C | 0 . . . 1 | This IE shall be present, if another DNN other than | |
| | | | | the UE requested DNN is selected for this PDU | |
| | | | | session. | |
| | | | | When present, it shall contain the selected DNN. | |
| | | | | The DNN shall be the full DNN (i.e. with both the | |
| | | | | Network Identifier and Operator Identifier) for a | |
| | | | | HR PDU session, and it should be the full DNN in | |
| | | | | LBO and non-roaming scenarios. If the Operator | |
| | | | | Identifier is absent, the serving core network | |
| | | | | operator shall be assumed. | |
| sNssai | Snssai | M | 1 | This IE shall contain the S-NSSAI for the serving | |
| | | | | PLMN. | |
| hplmnSnssai | Snssai | C | 0 . . . 1 | This IE shall be present for a HR PDU session. | |
| | | | | When present, it shall contain the S-NSSAI for the | |
| | | | | HPLMN. | |
| pduSessionType | PduSessionType | M | 1 | This IE shall indicate the PDU session type. | |
| gpsi | Gpsi | C | 0 . . . 1 | This IE shall be present if it is available. When | |
| | | | | present, it shall contain the user's GPSI. | |
| hSmfUri | Uri | C | 0 . . . 1 | This IE shall be present in HR roaming scenarios. | |
| | | | | When present, it shall contain the API URI of the | |
| | | | | Nsmf_PDUSession service of the H-SMF. The API | |
| | | | | URI shall be formatted as specified in clause 6.1.1. | |
| smfUri | Uri | C | 0 . . . 1 | This IE shall be present for a PDU session with an I- | |
| | | | | SMF. When present, it shall contain the API URI of | |
| | | | | the Nsmf_PDUSession service of the SMF. The | |
| | | | | API URI shall be formatted as specified in clause | |
| | | | | 6.1.1. | |
| pduSessionRef | Uri | C | 0 . . . 1 | This IE shall be present for a HR PDU session or a | |
| | | | | PDU session with an I-SMF. | |
| | | | | When present, this IE shall include the absolute URI | |
| | | | | of the PDU Session in H-SMF or SMF, including | |
| | | | | apiRoot (see clause 6.1.3.6.2) | |
| interPlmnApiRoot | Uri | C | 0 . . . 1 | This IE shall be present, if available. | |
| | | | | When present, it shall contain the apiRoot of the | |
| | | | | PDU session context to be used in inter-PLMN | |
| | | | | signalling request targeting the PDU session | |
| | | | | context. (NOTE 2) | |
| intraPlmnApiRoot | Uri | C | 0 . . . 1 | This IE shall be present, if available. | |
| | | | | When present, it shall contain the apiRoot of the | |
| | | | | PDU session context to be used in intra-PLMN | |
| | | | | signalling request targeting the PDU session | |
| | | | | context. (NOTE 2) | |
| pcfId | NfInstanceId | O | 0 . . . 1 | When present, this IE shall contain the identifier of: | |
| | | | | the H-PCF selected by the AMF (for UE | |
| | | | | Policy), for a HR PDU session; or | |
| | | | | the V-PCF selected by the AMF (for Access | |
| | | | | and Mobility Policy), for a PDU session in | |
| | | | | LBO roaming scenarios; or | |
| | | | | the PCF selected by the AMF (for Access and | |
| | | | | Mobility Policy and/or UE Policy), for a PDU | |
| | | | | session in non-roaming scenarios. | |
| pcfGroupId | NfGroupId | O | 0 . . . 1 | This IE may be present in non-roaming and HR | |
| | | | | roaming scenarios. | |
| | | | | When present, this IE shall contain the identity of | |
| | | | | the (home) PCF group serving the UE for Access | |
| | | | | and Mobility Policy and/or UE Policy. | |
| pcfSetId | NfSetId | O | 0 . . . 1 | This IE may be present if the pcfId IE is present. | |
| | | | | When present, it shall contain the NF Set ID of | |
| | | | | the PCF indicated by the pcfId IE. | |
| selMode | DnnSelectionMode | C | 0 . . . 1 | This IE shall be present if it is available. When | |
| | | | | present, it shall be set to: | |
| | | | | “VERIFIED”, if the requested DNN provided | |
| | | | | by UE or the selected DNN provided by the | |
| | | | | network corresponds to an explicitly | |
| | | | | subscribed DNN; or | |
| | | | | “UE_DNN_NOT_VERIFIED”, if the requested | |
| | | | | DNN provided by UE corresponds to the usage | |
| | | | | of a wildcard subscription; or | |
| | | | | “NW_DNN_NOT_VERIFIED”, if the selected | |
| | | | | DNN provided by network corresponds to the | |
| | | | | usage of a wildcard subscription. | |
| | | | | If both the requested DNN (i.e. dnn IE) and selected | |
| | | | | DNN (i.e. selected Dnn IE) are present, the selMode | |
| | | | | shall be related to the selected DNN. | |
| udmGroupId | NfGroupId | O | 0 . . . 1 | When present, it shall indicate the identity of the | |
| | | | | UDM group serving the UE. | |
| routingIndicator | string | O | 0 . . . 1 | When present, it shall indicate the Routing Indicator | |
| | | | | of the UE. | |
| hNwPubKeyId | integer | O | 0 . . . 1 | When present, it shall indicate the Home Network | |
| | | | | Public Key Identifier of the UE. (NOTE 1) | |
| sessionAmbr | Ambr | M | 1 | This IE shall contain the Session AMBR granted to | |
| | | | | the PDU session. | |
| qosFlowsList | array(QosFlowSetupItem) | M | 1 . . . N | This IE shall contain the set of QoS flow(s) | |
| | | | | established for the PDU session. It shall contain at | |
| | | | | least the Qos flow associated to the default Qos rule. | |
| | | | | The qosRules attribute of each QosFlowSetupItem | |
| | | | | shall be set to an empty string. | |
| hSmfInstanceId | NfInstanceId | C | 0 . . . 1 | This IE shall be present for a HR PDU session. | |
| | | | | When present, it shall contain the identifier of the | |
| | | | | home SMF. | |
| smfInstanceId | NfInstanceId | C | 0 . . . 1 | This IE shall be present for a PDU session with an | |
| | | | | I-SMF. | |
| | | | | When present, it shall contain the identifier of the | |
| | | | | SMF. | |
| pduSessionSmfSetId | NfSetId | C | 0 . . . 1 | This IE shall be present, if available. | |
| | | | | When present, this IE shall contain the NF Set ID of | |
| | | | | the home SMF as identified by hSmfInstanceId, or | |
| | | | | the SMF as identified by the smfInstanceId. | |
| pduSessionSmfServiceSetId | NfServiceSetId | C | 0 . . . 1 | This IE shall be present, if available. | |
| | | | | When present, this IE shall contain the NF Service | |
| | | | | Set ID of the PDUSession service instance (for | |
| | | | | this PDU session) in the home SMF or the SMF. | |
| pduSessionSmfBinding | SbiBindingLevel | C | 0 . . . 1 | This IE shall be present, if available. | |
| | | | | When present, this IE shall contain the SBI binding | |
| | | | | level of the PDU session resource in the home SMF | |
| | | | | or the SMF. | |
| enablePauseCharging | boolean | C | 0 . . . 1 | This IE shall be present for a HR PDU session, if | |
| | | | | available. | |
| | | | | When present, it shall indicate whether the use of | |
| | | | | Pause of Charging is enabled for the PDU session | |
| | | | | (see clause 4.4.4 of 3GPP TS 23.502 [3]). | |
| | | | | When present, it shall be set as follows: | |
| | | | | true: enable Pause of Charging; | |
| | | | | false (default): disable Pause of Charging. | |
| ueIpv4Address | Ipv4Addr | C | 0 . . . 1 | This IE shall be present if a UE IPv4 address to the | |
| | | | | PDU session. | |
| ueIpv6Prefix | Ipv6Prefix | C | 0 . . . 1 | This IE shall be present if a UE IPv6 prefix to the | |
| | | | | PDU session. | |
| epsPdnCnxInfo | EpsPdnCnxInfo | C | 0 . . . 1 | This IE shall be present if the PDU session may be | |
| | | | | moved to EPS during its lifetime. | |
| epsBearerInfo | array(EpsBearerInfo) | C | 1 . . . N | This IE shall be present if the PDU session may be | |
| | | | | moved to EPS during its lifetime. | |
| maxIntegrityProtectedDataRate | MaxIntegrityProtectedDataRate | C | 0 . . . 1 | This IE shall be present if the upSecurity IE is | |
| | | | | present and indicates that integrity protection is | |
| | | | | preferred or required. | |
| | | | | When present, it shall indicate the maximum | |
| | | | | integrity protected data rate for uplink. | |
| | | | | If the maxIntegrityProtectedDataRateDl IE is absent, | |
| | | | | this IE applies to both uplink and downlink. | |
| maxIntegrityProtectedDataRateDl | MaxIntegrityProtectedDataRate | C | 0 . . . 1 | This IE may be present if the upSecurity IE is | |
| | | | | present and indicates that integrity protection is | |
| | | | | preferred or required. | |
| | | | | When present, it shall indicate the maximum | |
| | | | | integrity protected data rate for downlink. | |
| alwaysOnGranted | boolean | C | 0 . . . 1 | This IE shall be present if available. When present, | |
| | | | | it shall indicate whether this is an always On PDU | |
| | | | | session and it shall be set as follows: | |
| | | | | true: always-on PDU session granted. | |
| | | | | false (default): always-on PDU session not granted. | |
| upSecurity | UpSecurity | O | 0 . . . 1 | When present, this IE shall indicate the security | |
| | | | | policy for integrity protection and encryption for the | |
| | | | | user plane of the PDU session. | |
| hSmfServiceInstanceId | string | O | 0 . . . 1 | This IE may be present for a HR PDU session. | |
| | | | | When present, this IE shall contain the | |
| | | | | serviceInstanceId of the H-SMF service instance | |
| | | | | serving the PDU session. | |
| | | | | This IE may be used by the V-SMF to identify PDU | |
| | | | | sessions affected by a failure or restart of the H- | |
| | | | | SMF service (see clause 6.2 of 3GPP TS 23.527 | |
| | | | | [24]). | |
| smfServiceInstanceId | string | O | 0 . . . 1 | This IE may be present for a PDU session with an I- | |
| | | | | SMF. | |
| | | | | When present, this IE shall contain the | |
| | | | | serviceInstanceId of the SMF service instance | |
| | | | | serving the PDU session. | |
| | | | | This IE may be used by the I-SMF to identify PDU | |
| | | | | sessions affected by a failure or restart of the SMF | |
| | | | | service (see clause 6.2 of 3GPP TS 23.527 [24]). | |
| recoveryTime | DateTime | O | 0 . . . 1 | This IE may be present if available. | |
| | | | | When present, this IE shall indicate the timestamp | |
| | | | | when the H-SMF or SMF service instance serving | |
| | | | | the PDU session was (re)started (see clause 6.3 | |
| | | | | of 3GPP TS 23.527 [24]). | |
| forwardingInd | boolean | C | 0 . . . 1 | This IE shall be present, when downlink data | |
| | | | | packets are buffered at I-UPF. The SMF or I-SMF | |
| | | | | shall use this IE to inform the NF service | |
| | | | | consumer that a forwarding tunnel is needed for | |
| | | | | receiving the buffered downlink data packets, | |
| | | | | as specified in clause 4.23.4 of 3GPP TS | |
| | | | | 23.502 [3]. | |
| | | | | When present, this IE shall be set as follows: | |
| | | | | true: a forwarding tunnel is needed for sending | |
| | | | | buffered downlink data packets; | |
| | | | | false (default): forwarding tunnel is not needed | |
| psaTunnelInfo | TunnelInfo | C | 0 . . . 1 | This IE shall be present if available. | |
| | | | | When present, this IE shall contain the N9 tunnel | |
| | | | | information of PDU Session Anchor UPF controlled | |
| | | | | by SMF or H-SMF. | |
| chargingId | string | C | 0 . . . 1 | This IE shall be present for a HR PDU session, in | |
| | | | | scenarios with a V-SMF insertion/change/removal. | |
| | | | | When present, it shall contain the Charging ID of | |
| | | | | the PDU session (see 3GPP TS 32.255 [25]). | |
| chargingInfo | ChargingInformation | C | 0 . . . 1 | This IE shall be present for a HR PDU session, if | |
| | | | | available and if the NF Service Consumer requesting | |
| | | | | the SM Context pertains to the same PLMN (i.e. if | |
| | | | | the Retrieve SM Context Request does not contain | |
| | | | | the servingNetwork attribute set to a different | |
| | | | | PLMN ID). When present, it shall contain the | |
| | | | | addresses of the V-CHF used for the PDU session. | |
| roamingChargingProfile | RoamingChargingProfile | C | 0 . . . 1 | This IE shall be present for a HR PDU session, if | |
| | | | | available and if the NF Service Consumer requesting | |
| | | | | the SM Context pertains to the same PLMN (i.e. if | |
| | | | | the Retrieve SM Context Request does not contain | |
| | | | | the servingNetwork attribute set to a different | |
| | | | | PLMN ID). When present, it shall contain the | |
| | | | | Roaming Charging Profile selected by the HPLMN | |
| | | | | (see clauses 5.1.9.1, 5.2.1.7 and 5.2.2.12.2 of | |
| | | | | 3GPP TS 32.255 [25]). | |
| nefExtBufSupportInd | boolean | C | 0 . . . 1 | This IE shall be present with value “true”, if the | |
| | | | | anchor NEF has indicated support of Extended | |
| | | | | Buffering for mobile terminated data during SMF- | |
| | | | | NEF connection establishment. | |
| | | | | When present, this IE shall be set as following: | |
| | | | | true: Extended Buffering supported by NEF | |
| | | | | false (default): Extended Buffering not supported by | |
| | | | | NEF | |
| ipv6Index | IpIndex | C | 0 . . . 1 | This IE shall be present during I-SMF change | |
| | | | | scenarios, if IPv6 Index has previously been | |
| | | | | received by old I-SMF. | |
| dnAaaAddress | IpAddress | O | 0 . . . 1 | When present, this IE shall contain the address of | |
| | | | | DN-AAA server for UE IP Address allocation | |
| | | | | previously received by old I-SMF. | |
| redundantPduSessionInfo | RedundantPduSessionInformation | C | 0 . . . 1 | This IE shall be present for a PDU session with an I- | |
| | | | | SMF, if this information has been received | |
| | | | | previously from the UE, the anchor SMF or the old | |
| | | | | I-SMF. | |
| ranTunnelInfo | QosFlowTunnel | C | 0 . . . 1 | This IE shall be present if the ranUnchangedInd IE | |
| | | | | is set to “true” in the SM context retrieve | |
| | | | | request. When present, this IE shall contain the | |
| | | | | N2 tunnel information of NG-RAN with associated | |
| | | | | QoS flows (see “DL QoS Flow per TNL | |
| | | | | Information” in clause 9.3.4.2 of 3GPP | |
| | | | | 38.413 [9]). | |
| addRanTunnelInfo | array(QosFlowTunnel) | C | 1 . . . N | This IE shall be present if the ranUnchangedInd IE | |
| | | | | is set to “true” in the SM context retrieve | |
| | | | | request. When present, this IE shall contain the | |
| | | | | additional N2 tunnel information of NG-RAN | |
| | | | | together with associated QoS flows for split PDU | |
| | | | | session (see “Additional DL QoS Flow per TNL | |
| | | | | Information” in clause 9.3.4.2 of 3GPP | |
| | | | | 38.413 [9]). | |
| redRanTunnelInfo | QosFlowTunnel | C | 0 . . . 1 | This IE shall be present if the ranUnchangedInd IE | |
| | | | | is set to “true” in the SM context retrieve | |
| | | | | request.When present, this IE shall contain the | |
| | | | | additional N2 tunnel information of NG-RAN | |
| | | | | together with associated QoS flows for Redundant | |
| | | | | QoS Flow(s) (see “Redundant DL QoS Flow per | |
| | | | | TNL Information” in clause 9.3.4.2 of 3GPP | |
| | | | | 38.413 [9]). | |
| addRedRanTunnelInfo | array(QosFlowTunnel) | C | 1 . . . N | This IE shall be present if the ranUnchangedInd IE | |
| | | | | is set to “true” in the SM context retrieve | |
| | | | | request. When present, this IE shall contain the | |
| | | | | additional N2 tunnel information of NG-RAN | |
| | | | | together with associated QoS flows for Redundant | |
| | | | | QoS Flow(s) with split PDU session (see | |
| | | | | “Additional Redundant DL QoS Flow per TNL | |
| | | | | Information” in clause 9.3.4.2 of 3GPP | |
| | | | | 38.413 [9]). | |
| nspuSupportInd | boolean | C | 0 . . . 1 | This IE shall be present and set to “true” if | |
| | | | | the enablePauseCharging in the SmContext data | |
| | | | | type is set to “true” and if the (H-)SMF | |
| | | | | and PSA UPF support Notify Start Pause of | |
| | | | | Charging via user plane feature as specified | |
| | | | | in clause 5.30 of 3GPP TS 29.244 [29]. | |
| | | | | When present, it shall be set as follows: | |
| | | | | true: Notify Start Pause of Charging via user | |
| | | | | plane feature is supported. | |
| smfBindingInfo | string | C | 10 . . . 1 | This IE shall be present, if available. | |
| | | | | When present, this IE shall contain the Binding | |
| | | | | indications of the PDU session resource in the home | |
| | | | | SMF or the SMF and shall be set to the value of the | |
| | | | | 3gpp-Sbi-Binding header defined in clause 5.2.3.2.6 | |
| | | | | of 3GPP TS 29.500 [4], without the header name. | |
| satelliteBackhaulCat | SatelliteBackhaulCategory | O | 0 . . . 1 | When present, this IE shall indicate the satellite | |
| | | | | backhaul category information last signalled towards | |
| | | | | the anchor SMF, if any. | |
| sscMode | string | C | 0 . . . 1 | This IE shall be present, if available. | |
| | | | | When present, this IE shall indicate the SSC mode | |
| | | | | applicable to the PDU session. | |
| | | | | When present, it shall be encoded as one character | |
| | | | | in hexadecimal representation, taking a value of | |
| | | | | “0” to “7”, representing the 3 bits | |
| | | | | of the SSC mode value of the SSC mode IE | |
| | | | | specified in clause 9.11.4.16 of 3GPP TS | |
| | | | | 24.501 [7]. | |
| | | | | Pattern: “\hat{ }[0-7]$” | |
| | | | | Example: SSC mode 3 shall be encoded as “3”. | |
| fullDnaiList | array(Dnai) | C | 1 . . . N | This IE shall be present over N16a, if available and | DTSSA |
| | | | | an I-SMF has been inserted into a PDU session, | |
| | | | | during the following procedures: PDU session | |
| | | | | establishment, Registration, Service Request, Xn | |
| | | | | based handover, Inter NG-RAN node N2 based | |
| | | | | handover (see clause 4.23 of 3GPP TS 23.502 [3]). | |
| | | | | This IE shall be present over N38, if available and | |
| | | | | I-SMF has been changed for a PDU session during | |
| | | | | the following procedures: Registration, Service | |
| | | | | Request, Xn based handover, Inter NG-RAN node | |
| | | | | N2 based handover (see clause 4.23 of | |
| | | | | 3GPP TS 23.502 [3]). | |
| | | | | When present, it shall include the full list of DNAIs | |
| | | | | for the PDU session. | |

(NOTE 1):
If present, this attribute shall be used together with routingIndicator. This attribute is only used by the HPLMN in roaming scenarios.
(NOTE 2):
See NOTE 7 of Table 6.1.6.2.10-1.

TABLE 6.1.6.2.10
Definition of type PduSessionCreatedData
TS29.502 6.1.6.2.10 Type: PduSession CreatedData

| | | | | | |
|---|---|---|---|---|---|
| dnaiList | array(Dnai) | C | 1 . . . N | This IE shall be present over N16a, if available | DTSSA |
| | | | | and an I-SMF has been inserted into a PDU | |
| | | | | session, during the following procedures: PDU | |
| | | | | session establishment, Registration, Service | |
| | | | | Request, Xn based handover, Inter NG-RAN node | |
| | | | | N2 based handover (see clause 4.23 of | |
| | | | | 3GPP TS 23.502 [3]). | |
| | | | | When present, it shall include the list of DNAIs of | |
| | | | | interest for the PDU session for local traffic | |
| | | | | steering at the I-SMF. | |
| fullDnaiList | array(Dnai) | C | 1 . . . N | This IE shall be present over N16a, if available | DTSSA |
| | | | | and an I-SMF has been inserted into a PDU | |
| | | | | session, during the following procedures: PDU | |
| | | | | session establishment, Registration, Service | |
| | | | | Request, Xn based handover, Inter NG-RAN node | |
| | | | | N2 based handover (see clause 4.23 of | |
| | | | | 3GPP TS 23.502 [3]). | |
| | | | | This IE shall be present over N38, if available and | |
| | | | | I-SMF has been changed for a PDU session | |
| | | | | during the following procedures: Registration, | |
| | | | | Service Request, Xn based handover, Inter NG- | |
| | | | | RAN node N2 based handover (see clause 4.23 of | |
| | | | | 3GPP TS 23.502 [3]). | |
| | | | | When present, it shall include the full list of | |
| | | | | DNAIs for the PDU session. | |

TS29.502 6.1.6.2.12 Type: HsmfUpdateData

| | | | | | |
|---|---|---|---|---|---|
| dnaiList | array(Dnai) | C | 1 . . . N | This IE shall be present over N16a, if available | DTSSA |
| | | | | and an I-SMF has been inserted into a PDU | |
| | | | | session, during the following procedures: PDU | |
| | | | | session establishment, Registration, Service | |
| | | | | Request, Xn based handover, Inter NG-RAN node | |
| | | | | N2 based handover (see clause 4.23 of | |
| | | | | 3GPP TS 23.502 [3]). | |
| | | | | When present, it shall include the list of DNAIs of | |
| | | | | interest for the PDU session for local traffic | |
| | | | | steering at the I-SMF. | |
| fullDnaiList | array(Dnai) | C | 1 . . . N | This IE shall be present over N16a, if available | DTSSA |
| | | | | and an I-SMF has been inserted into a PDU | |
| | | | | session, during the following procedures: PDU | |
| | | | | session establishment, Registration, Service | |
| | | | | Request, Xn based handover, Inter NG-RAN node | |
| | | | | N2 based handover (see clause 4.23 of | |
| | | | | 3GPP TS 23.502 [3]). | |
| | | | | This IE shall be present over N38, if available and | |
| | | | | I-SMF has been changed for a PDU session | |
| | | | | during the following procedures: Registration. | |
| | | | | Service Request, Xn based handover, Inter NG- | |
| | | | | RAN node N2 based handover (see clause 4.23 of | |
| | | | | 3GPP TS 23.502 [3]). | |
| | | | | When present, it shall include the full list of | |
| | | | | DNAIs for the PDU session. | |

TABLE 6.1.6.2.15-1
Definition of type VsmfUpdateData

| | | | | | |
|---|---|---|---|---|---|
| dnaiList | array(Dnai) | C | 1 . . . N | This IE shall be present over N16a, if available | DTSSA |
| | | | | and an I-SMF has been inserted into a PDU | |
| | | | | session, during the following procedures: PDU | |
| | | | | session establishment, Registration, Service | |
| | | | | Request, Xn based handover, Inter NG-RAN node | |
| | | | | N2 based handover (see clause 4.23 of | |
| | | | | 3GPP TS 23.502 [3]). | |
| | | | | When present, it shall include the list of DNAIs of | |
| | | | | interest for the PDU session for local traffic | |
| | | | | steering at the I-SMF. | |
| fullDnaiList | array(Dnai) | C | 1 . . . N | This IE shall be present over N16a, if available | DTSSA |
| | | | | and an I-SMF has been inserted into a PDU | |
| | | | | session, during the following procedures: PDU | |
| | | | | session establishment, Registration, Service | |
| | | | | Request, Xn based handover, Inter NG-RAN node | |
| | | | | N2 based handover (see clause 4.23 of | |
| | | | | 3GPP TS 23.502 [3]). | |
| | | | | This IE shall be present over N38, if available and | |
| | | | | I-SMF has been changed for a PDU session | |
| | | | | during the following procedures: Registration, | |
| | | | | Service Request, Xn based handover, Inter NG- | |
| | | | | RAN node N2 based handover (see clause 4.23 of | |
| | | | | 3GPP TS 23.502 [3]). | |
| | | | | When present, it shall include the full list of | |
| | | | | DNAIs for the PDU session. | |

Embodiments of the present disclosure provide the following benefits.

The inserted/changed I-SMF generates the “common supported Dnai list for I-SMF and SMF” based on locally configured supported dnaiList of I-SMF and the received new fullDnaiList. That means I-SMF generates “dnailist of interest” by itself.

Particularly, for the simultaneous change of ULCL/BP and additional PSA controlled by different I-SMFs applied during the mobility procedure (TS23.502 4.23.9.5), the changed I-SMF is able to select Local PSA correctly and as early as possible.

For the simultaneous change of UL CL/BP and additional PSA controlled by different I-SMFs applied during the mobility procedure (TS23.502 4.23.9.5), the inserted I-SMF is able to select Local PSA correctly and as early as possible.

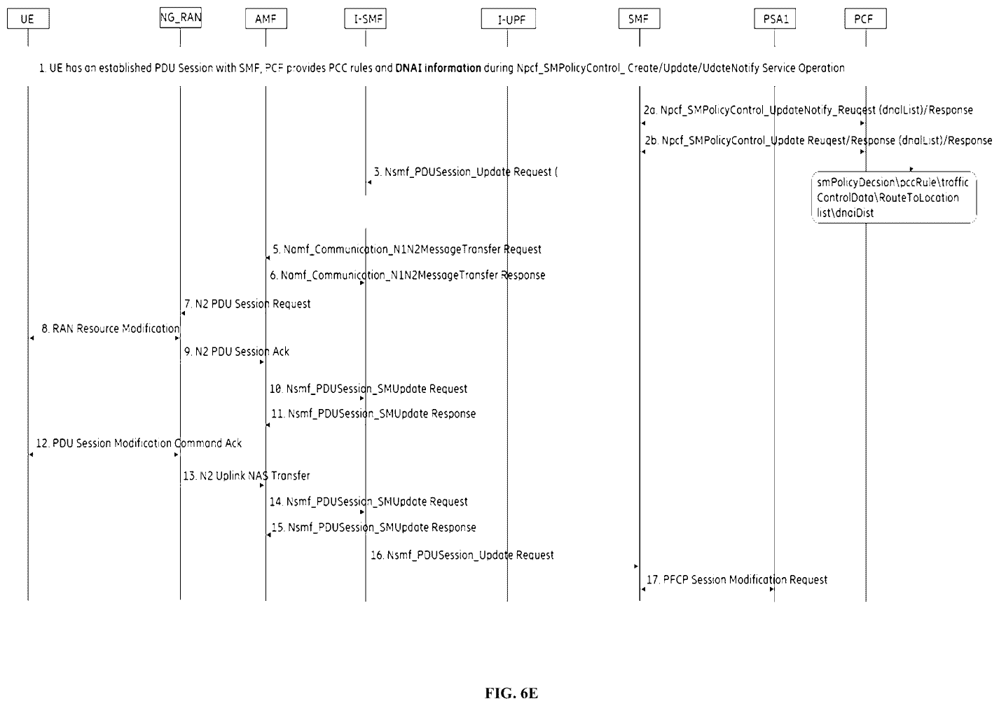

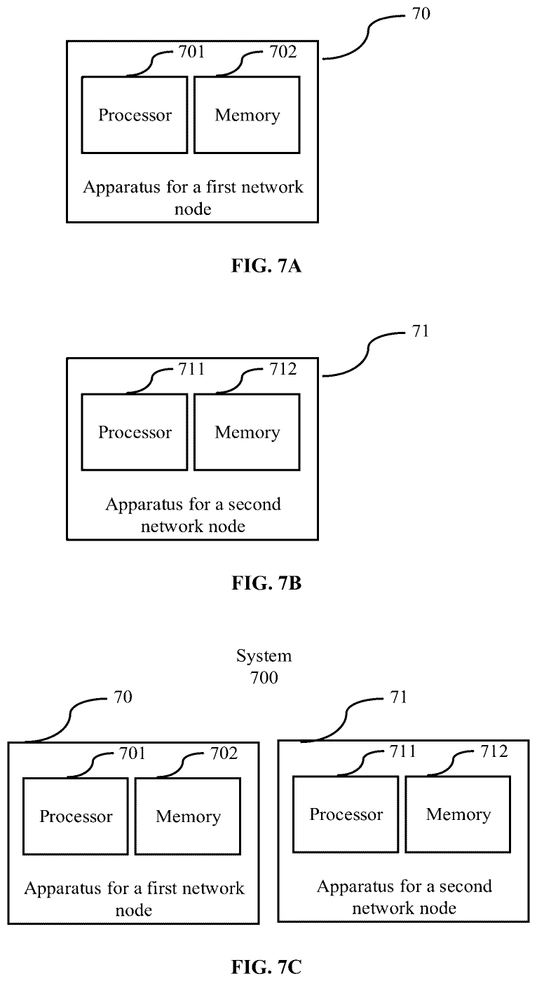

FIG. 7A is a block diagram showing an exemplary apparatus for a first network node, which is suitable for performing the method according to embodiments of the disclosure.

As shown in FIG. 7A, the apparatus 70 for the first network node comprises: a processor 701; and a memory 702. The memory 702 contains instructions executable by the processor 701. The apparatus 70 for the first network node is operative for: receiving from a second network node, a first list of data network access identifier (DNAI); and selecting a local user plane function (UPF), based at least on the first list of DNAI.

In embodiments of the present disclosure, the apparatus 70 is further operative to perform the method according to any of the above embodiments, such as these shown in FIG. 3A, 3B, 3C, 3D, 5A, 5B, 5C, 6A, 6B, 6C, 6D.

FIG. 7B is a block diagram showing an exemplary apparatus for a second network node, which is suitable for performing the method according to embodiments of the disclosure.

As shown in FIG. 7B, the apparatus 71 for the second network node comprises: a processor 711; and a memory 712. The memory 712 contains instructions executable by the processor 711. The apparatus 71 for the second network node is operative for: transmitting to a first network node, a first list of data network access identifier (DNAI). The first list of DNAI may be used for the first network node to select a local user plane function (UPF), based at least on the first list of DNAI.

In embodiments of the present disclosure, the apparatus 71 is further operative to perform the method according to any of the above embodiments, such as these shown in FIG. 4A, 4B, 5A, 5B, 5C, 6A, 6B, 6C, 6D.

The processors 701, 711 may be any kind of processing component, such as one or more microprocessor or microcontrollers, as well as other digital hardware, which may include digital signal processors (DSPs), special-purpose digital logic, and the like. The memories 702, 712 may be any kind of storage component, such as read-only memory (ROM), random-access memory, cache memory, flash memory devices, optical storage devices, etc.

FIG. 7C is a block diagram showing an exemplary system including the first network node, and the second network node.

The system 700 comprises: an apparatus 70 for a first network node, and an apparatus 71 for a second network node.

The apparatus 70 for the first network node comprises: a processor 701; and a memory 702. The memory 702 contains instructions executable by the processor 701. The apparatus 70 for the first network node is operative for: receiving from a second network node, a first list of data network access identifier (DNAI); and selecting a local user plane function (UPF), based at least on the first list of DNAI.

The apparatus 71 for the second network node comprises: a processor 711; and a memory 712. The memory 712 contains instructions executable by the processor 711. The apparatus 71 for the second network node is operative for: transmitting to a first network node, a first list of data network access identifier (DNAI). The first list of DNAI may be used for the first network node to select a local user plane function (UPF) for a terminal device, based at least on the first list of DNAI.

In embodiments of the present disclosure, the system may be further operative to perform the method according to any of above embodiments, such as these shown in FIG. 3A, 3B, 3C, 3D, 4A, 4B, 5A, 5B, 5C, 6A, 6B, 6C, 6D.

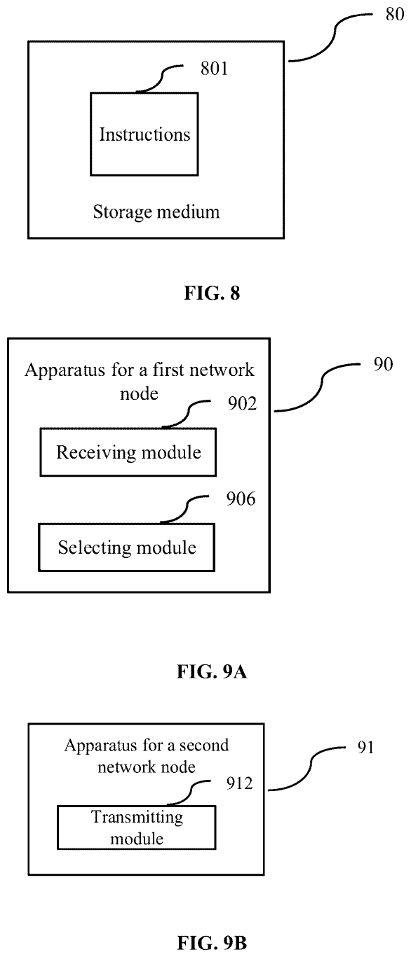

FIG. 8 is a block diagram showing an apparatus/computer readable storage medium, according to embodiments of the present disclosure.

As shown in FIG. 8, the computer-readable storage medium 80, or any other kind of product, storing instructions 801 which when executed by at least one processor, cause the at least one processor to perform the method according to any one of the above embodiments, such as these shown in FIG. 3A, 3B, 3C, 3D, 4A, 4B. 5A. 5B, 5C. 6A, 6B, 6C, 6D.

In addition, the present disclosure may also provide a carrier containing the computer program as mentioned above, the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

FIG. 9A is a block diagram showing modules for a first network node, which are suitable for performing the method according to embodiments of the disclosure.

As shown in FIG. 9A, the apparatus 90 for the first network node may comprise: a receiving module 902, configured to receive from a second network node, a first list of data network access identifier (DNAI); and a selecting module 904, selecting a user plane function (UPF), based at least on the first list of DNAI.

In embodiments of the present disclosure, the apparatus 90 is further operative to perform the method according to any of the above embodiments, such as these shown in FIG. 3A, 3B, 3C, 3D, 5A, 5B, 5C, 6A, 6B, 6C, 6D.

FIG. 9B is a block diagram showing modules for a second network node, which are suitable for performing the method according to embodiments of the disclosure.

As shown in FIG. 9B, the apparatus 91 for the second network node may comprise: a transmitting module 912, configured to transmit to a first network node, a first list of data network access identifier (DNAI). The first list of DNAI may be used for the first network node to select a user plane function (UPF), based at least on the first list of DNAI.

In embodiments of the present disclosure, the apparatus 91 is further operative to perform the method according to any of the above embodiments, such as these shown in FIG. 4A, 4B, 5A, 5B, 5C. 6A, 6B, 6C. 6D.

The term ‘module’ may have conventional meaning in the field of electronics, electrical devices and/or electronic devices and may include, for example, electrical and/or electronic circuitry, devices, units, processors, memories, logic solid state and/or discrete devices, computer programs or instructions for carrying out respective tasks, procedures, computations, outputs, and/or displaying functions, and so on, as such as those that are described herein.

With these modules, the apparatus may not need a fixed processor or memory, any kind of computing resource and storage resource may be arranged from at least one network node/device/entity/apparatus relating to the communication system. The virtualization technology and network computing technology (e.g., cloud computing) may be further introduced, so as to improve the usage efficiency of the network resources and the flexibility of the network.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules/units), or combinations thereof. For a firmware or software, implementation may be made through modules (e.g., procedures, functions, and so on) that perform the functions described herein.

Particularly, these function modules may be implemented either as a network element on a dedicated hardware, as a software instance running on a dedicated hardware, or as a virtualized function instantiated on an appropriate platform, e.g., on a cloud infrastructure.

The first network node, the second network node may be any communication device, and/or computing device in a network, such as any server, personal computer, user equipment, router, gateway device, etc. Examples for the first network node, and/or the second network node may be illustrated as follows.

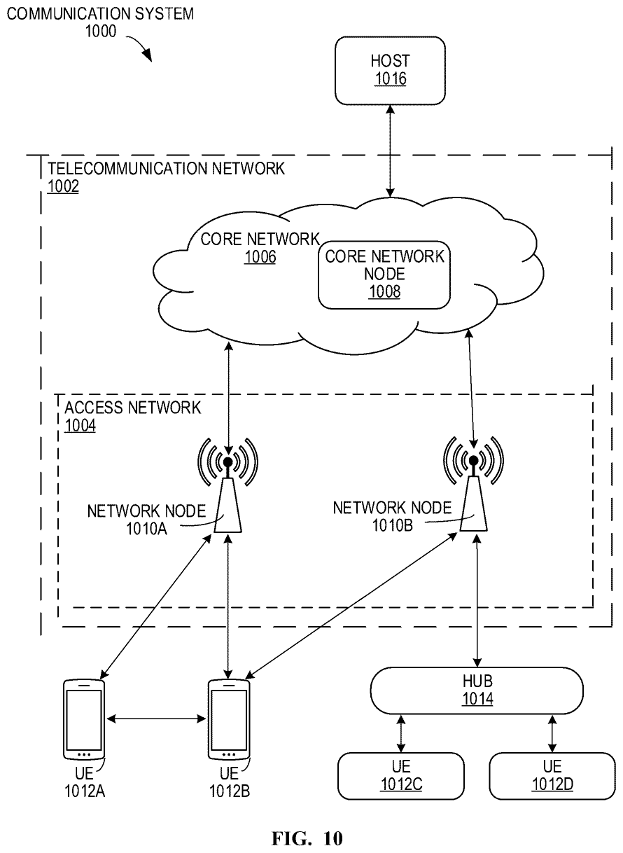

FIG. 10 shows an example of a communication system 1000 in accordance with some embodiments.

In the example, the communication system 1000 includes a telecommunication network 1002 that includes an access network 1004, such as a radio access network (RAN), and a core network 1006, which includes one or more core network nodes 1008. The access network 1004 includes one or more access network nodes, such as network nodes 1010a and 1010b (one or more of which may be generally referred to as network nodes 1010), or any other similar 3rd Generation Partnership Project (3GPP) access node or non-3GPP access point. The network nodes 1010 facilitate direct or indirect connection of user equipment (UE), such as by connecting UEs 1012a, 1012b, 1012c, and 1012d (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1014 communicates with the access network 1004 to facilitate indirect communication between one or more UEs (e.g., UE 1012c and/or 1012d) and network nodes (e.g., network node 1010b). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the network node 1010b. The hub 1014 may also allow for a different communication scheme and/or schedule between the hub 1014 and UEs (e.g., UE 1012c and/or 1012d), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub—that is, a hub whose primary function is to route communications to/from the UEs from/to the network node 1010b. In other embodiments, the hub 1014 may be a non-dedicated hub—that is, a device which is capable of operating to route communications between the UEs and network node 1010b, but which is additionally capable of operating as a communication start and/or end point for certain data channels.

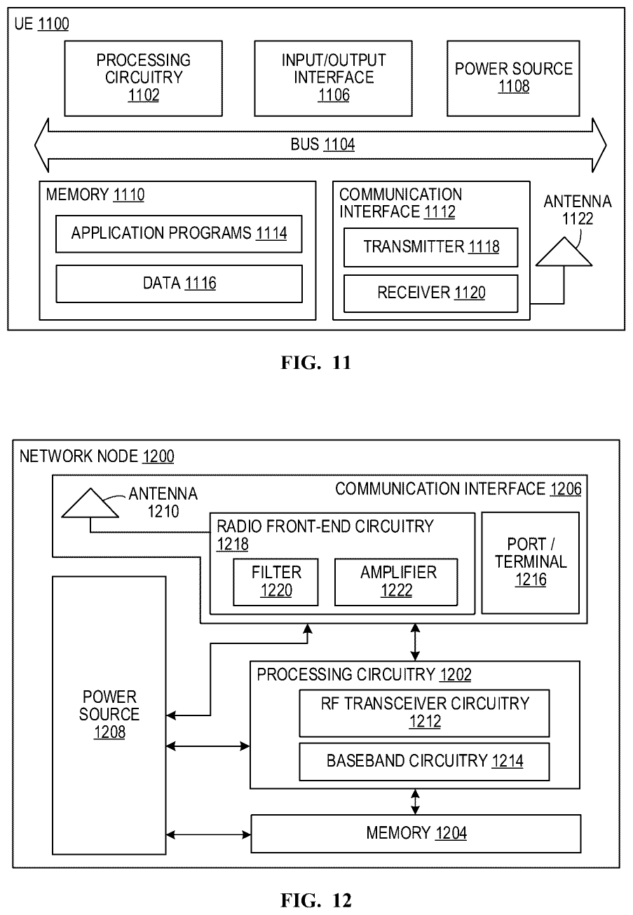

FIG. 11 shows a UE 1100 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, a memory 1110, a communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1102 may include multiple central processing units (CPUs).

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging of the power source 1108. Power circuitry may perform any formatting, converting, or other modification to the power from the power source 1108 to make the power suitable for the respective components of the UE 1100 to which power is supplied.

The memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1110 may allow the UE 1100 to access instructions, application programs and the like, stored on transitory or non-transitory memory media, to off-load data, or to upload data. An article of manufacture, such as one utilizing a communication system may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., antenna 1122) and may share circuit components, software or firmware, or alternatively be implemented separately.

In the illustrated embodiment, communication functions of the communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1100 shown in FIG. 11.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 12 shows a network node 1200 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1200 includes a processing circuitry 1202, a memory 1204, a communication interface 1206, and a power source 1208. The network node 1200 may be composed of multiple physically separate components (e.g., a NodeB component and a RNC component, or a BTS component and a BSC component, etc.), which may each have their own respective components. In certain scenarios in which the network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

The processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as the memory 1204, to provide network node 1200 functionality.

In some embodiments, the processing circuitry 1202 includes a system on a chip (SOC). In some embodiments, the processing circuitry 1202 includes one or more of radio frequency (RF) transceiver circuitry 1212 and baseband processing circuitry 1214. In some embodiments, the radio frequency (RF) transceiver circuitry 1212 and the baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

The memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and memory 1204 is integrated.

The communication interface 1206 is used in wired or wireless communication of signaling and/or data between a network node, access network, and/or UE. As illustrated, the communication interface 1206 comprises port(s)/terminal(s) 1216 to send and receive data, for example to and from a network over a wired connection. The communication interface 1206 also includes radio front-end circuitry 1218 that may be coupled to, or in certain embodiments a part of, the antenna 1210. Radio front-end circuitry 1218 comprises filters 1220 and amplifiers 1222. The radio front-end circuitry 1218 may be connected to an antenna 1210 and processing circuitry 1202. The radio front-end circuitry may be configured to condition signals communicated between antenna 1210 and processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of filters 1220 and/or amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface may comprise different components and/or different combinations of components.

In certain alternative embodiments, the network node 1200 does not include separate radio front-end circuitry 1218, instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes one or more ports or terminals 1216, the radio front-end circuitry 1218, and the RF transceiver circuitry 1212, as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, communication interface 1206, and/or the processing circuitry 1202 may be configured to perform any receiving operations and/or certain obtaining operations described herein as being performed by the network node. Any information, data and/or signals may be received from a UE, another network node and/or any other network equipment. Similarly, the antenna 1210, the communication interface 1206, and/or the processing circuitry 1202 may be configured to perform any transmitting operations described herein as being performed by the network node. Any information, data and/or signals may be transmitted to a UE, another network node and/or any other network equipment.

The power source 1208 provides power to the various components of network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid, an electricity outlet) via an input circuitry or interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 12 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

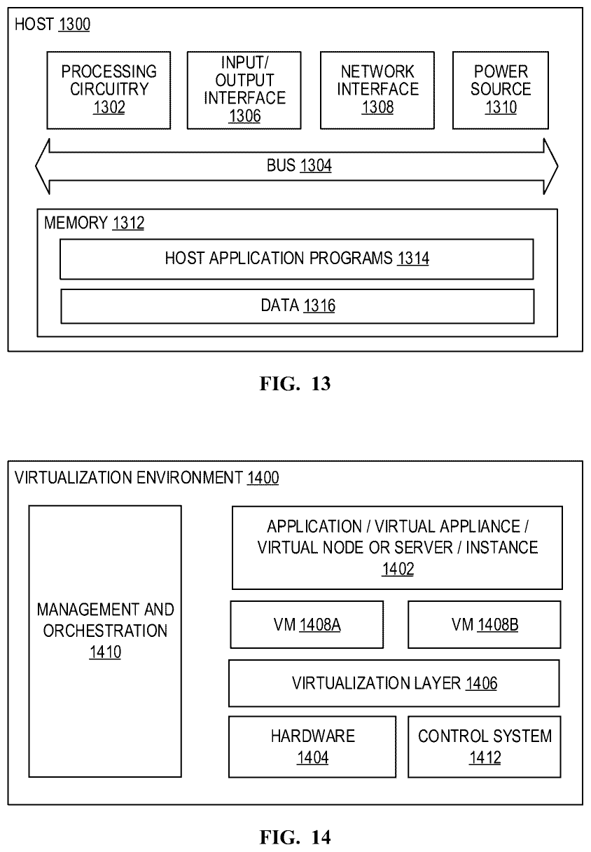

FIG. 13 is a block diagram of a host 1300, which may be an embodiment of the host 1016 of FIG. 10, in accordance with various aspects described herein. As used herein, the host 1300 may be or comprise various combinations hardware and/or software, including a standalone server, a blade server, a cloud-implemented server, a distributed server, a virtual machine, container, or processing resources in a server farm. The host 1300 may provide one or more services to one or more UEs.

The host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such as FIGS. 11 and 12, such that the descriptions thereof are generally applicable to the corresponding components of host 1300.

The memory 1312 may include one or more computer programs including one or more host application programs 1314 and data 1316, which may include user data, e.g., data generated by a UE for the host 1300 or data generated by the host 1300 for a UE. Embodiments of the host 1300 may utilize only a subset or all of the components shown. The host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1314 may also provide for user authentication and licensing checks and may periodically report health, routes, and content availability to a central node, such as a device in or on the edge of a core network. Accordingly, the host 1300 may select and/or indicate a different host for over-the-top services for a UE. The host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a and 1408b (one or more of which may be generally referred to as VMs 1408), and/or perform any of the functions, features and/or benefits described in relation with some embodiments described herein. The virtualization layer 1406 may present a virtual operating platform that appears like networking hardware to the VMs 1408.

The VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1408 may be a software implementation of a physical machine that runs programs as if they were executing on a physical, non-virtualized machine. Each of the VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to the application 1402.

Hardware 1404 may be implemented in a standalone network node with generic or specific components. Hardware 1404 may implement some functions via virtualization. Alternatively, hardware 1404 may be part of a larger cluster of hardware (e.g. such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

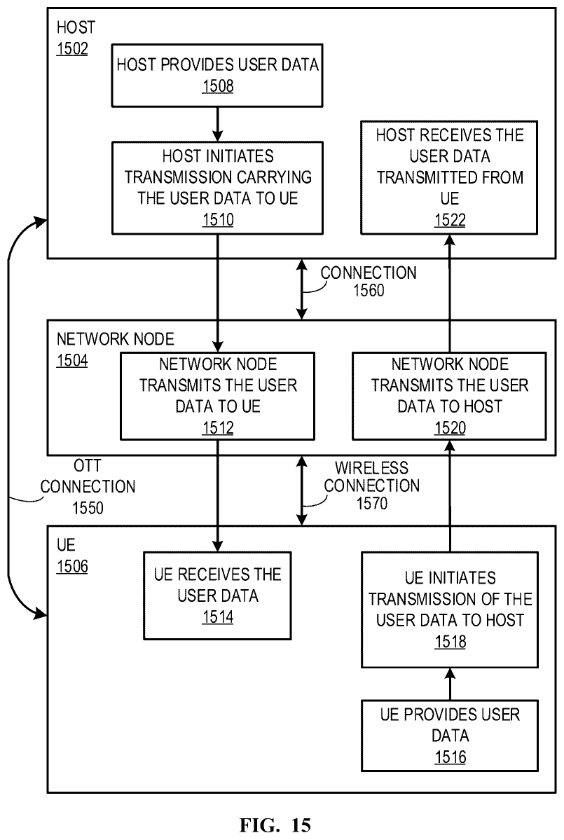

FIG. 15 shows a communication diagram of a host 1502 communicating via a network node 1504 with a UE 1506 over a partially wireless connection in accordance with some embodiments. Example implementations, in accordance with various embodiments, of the UE (such as a UE 1012a of FIG. 10 and/or UE 1100 of FIG. 11), network node (such as network node 1010a of FIG. 10 and/or network node 1200 of FIG. 12), and host (such as host 1016 of FIG. 10 and/or host 1300 of FIG. 13) discussed in the preceding paragraphs will now be described with reference to FIG. 15.

Like host 1300, embodiments of host 1502 include hardware, such as a communication interface, processing circuitry, and memory. The host 1502 also includes software, which is stored in or accessible by the host 1502 and executable by the processing circuitry. The software includes a host application that may be operable to provide a service to a remote user, such as the UE 1506 connecting via an over-the-top (OTT) connection 1550 extending between the UE 1506 and host 1502. In providing the service to the remote user, a host application may provide user data which is transmitted using the OTT connection 1550.

The network node 1504 includes hardware enabling it to communicate with the host 1502 and UE 1506. The connection 1560 may be direct or pass through a core network (like core network 1006 of FIG. 10) and/or one or more other intermediate networks, such as one or more public, private, or hosted networks. For example, an intermediate network may be a backbone network or the Internet.

The UE 1506 includes hardware and software, which is stored in or accessible by UE 1506 and executable by the UE's processing circuitry. The software includes a client application, such as a web browser or operator-specific “app” that may be operable to provide a service to a human or non-human user via UE 1506 with the support of the host 1502. In the host 1502, an executing host application may communicate with the executing client application via the OTT connection 1550 terminating at the UE 1506 and host 1502. In providing the service to the user, the UE's client application may receive request data from the host's host application and provide user data in response to the request data. The OTT connection 1550 may transfer both the request data and the user data. The UE's client application may interact with the user to generate the user data that it provides to the host application through the OTT connection 1550.

The OTT connection 1550 may extend via a connection 1560 between the host 1502 and the network node 1504 and via a wireless connection 1570 between the network node 1504 and the UE 1506 to provide the connection between the host 1502 and the UE 1506. The connection 1560 and wireless connection 1570, over which the OTT connection 1550 may be provided, have been drawn abstractly to illustrate the communication between the host 1502 and the UE 1506 via the network node 1504, without explicit reference to any intermediary devices and the precise routing of messages via these devices.

As an example of transmitting data via the OTT connection 1550, in step 1508, the host 1502 provides user data, which may be performed by executing a host application. In some embodiments, the user data is associated with a particular human user interacting with the UE 1506. In other embodiments, the user data is associated with a UE 1506 that shares data with the host 1502 without explicit human interaction. In step 1510, the host 1502 initiates a transmission carrying the user data towards the UE 1506. The host 1502 may initiate the transmission responsive to a request transmitted by the UE 1506. The request may be caused by human interaction with the UE 1506 or by operation of the client application executing on the UE 1506. The transmission may pass via the network node 1504, in accordance with the teachings of the embodiments described throughout this disclosure. Accordingly, in step 1512, the network node 1504 transmits to the UE 1506 the user data that was carried in the transmission that the host 1502 initiated, in accordance with the teachings of the embodiments described throughout this disclosure. In step 1514, the UE 1506 receives the user data carried in the transmission, which may be performed by a client application executed on the UE 1506 associated with the host application executed by the host 1502.

In some examples, the UE 1506 executes a client application which provides user data to the host 1502. The user data may be provided in reaction or response to the data received from the host 1502. Accordingly, in step 1516, the UE 1506 may provide user data, which may be performed by executing the client application. In providing the user data, the client application may further consider user input received from the user via an input/output interface of the UE 1506. Regardless of the specific manner in which the user data was provided, the UE 1506 initiates, in step 1518, transmission of the user data towards the host 1502 via the network node 1504. In step 1520, in accordance with the teachings of the embodiments described throughout this disclosure, the network node 1504 receives user data from the UE 1506 and initiates transmission of the received user data towards the host 1502. In step 1522, the host 1502 receives the user data carried in the transmission initiated by the UE 1506.

One or more of the various embodiments improve the performance of OTT services provided to the UE 1506 using the OTT connection 1550, in which the wireless connection 1570 forms the last segment. According to embodiments of the present disclosure, improved methods and improved apparatuses for UPF selection may be provided. Particularly, by receiving a first list of DNAI, a first network node may select UPF in time when needed. Therefore, the problem that the DNAI might not be available when the network node needs to select a UPF at some time point will be avoided. More precisely, the teachings of these embodiments may improve the performance, e.g., data rate, latency, power consumption, of the communication network, and thereby provide benefits such as reduced user waiting time, relaxed restriction on file size, improved content resolution, better responsiveness, extended battery lifetime.

In an example scenario, factory status information may be collected and analyzed by the host 1502. As another example, the host 1502 may process audio and video data which may have been retrieved from a UE for use in creating maps. As another example, the host 1502 may collect and analyze real-time data to assist in controlling vehicle congestion (e.g., controlling traffic lights). As another example, the host 1502 may store surveillance video uploaded by a UE. As another example, the host 1502 may store or control access to media content such as video, audio, VR or AR which it can broadcast, multicast or unicast to UEs. As other examples, the host 1502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1550 between the host 1502 and UE 1506, in response to variations in the measurement results. The measurement procedure and/or the network functionality for reconfiguring the OTT connection may be implemented in software and hardware of the host 1502 and/or UE 1506. In some embodiments, sensors (not shown) may be deployed in or in association with other devices through which the OTT connection 1550 passes; the sensors may participate in the measurement procedure by supplying values of the monitored quantities exemplified above, or supplying values of other physical quantities from which software may compute or estimate the monitored quantities. The reconfiguring of the OTT connection 1550 may include message format, retransmission settings, preferred routing etc.; the reconfiguring need not directly alter the operation of the network node 1504. Such procedures and functionalities may be known and practiced in the art. In certain embodiments, measurements may involve proprietary UE signaling that facilitates measurements of throughput, propagation times, latency and the like, by the host 1502. The measurements may be implemented in that software causes messages to be transmitted, in particular empty or ‘dummy’ messages, using the OTT connection 1550 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The followings are the references which are incorporated herein in their entirety:
3GPP TS23.502, V17.5.0 (2022 June)
3GPP TS29.502 V17.5.0 (2022 June)

| ABBREVIATION | EXPLANATION |
|---|---|
| SMF | session management function |
| UPF | user plane function |
| I-SMF | intermediate session management function |
| UL CL | uplink classifier |
| BP | branching point |
| PSA | protocol data unit session anchor |

### APPENDIX

According to embodiments of the present disclosure, a change request as following may be also provided to improve the current 3GPP standards.

TABLE 6.1.6.2.10-1
Definition of type PduSessionCreatedData

| | | | Cardi- | | Appli- |
|---|---|---|---|---|---|
| Attribute name | Data type | P | nality | Description | cability |
| pduSessionType | PduSessionType | M | 1 | This IE shall indicate the selected PDU type. | |
| sscMode | string | M | 1 | This IE shall indicate the SSC mode applicable to | |
| | | | | the PDU session. | |
| | | | | When present, it shall be encoded as one character | |
| | | | | in hexadecimal representation, taking a value of “0” | |
| | | | | to “7”, representing the 3 bits of the SSC mode | |
| | | | | value of the SSC mode IE specified in clause | |
| | | | | 9.11.4.16 of 3GPP TS 24.501 [7]. | |
| | | | | Pattern: “\hat{ }[0-7]$” | |
| | | | | Example: SSC mode 3 shall be encoded as “3”. | |
| | | | | (NOTE 1). | |
| hcnTunnelInfo | TunnelInfo | C | 0 . . . 1 | This IE shall be present for a HR PDU session, | |
| | | | | except when Control Plane CloT 5GS Optimisation | |
| | | | | is enabled and data delivery via NEF is selected | |
| | | | | for this PDU session. | |
| | | | | When present, this IE shall contain the N9 tunnel | |
| | | | | information of the home CN side, i.e. H-UPF. | |
| cnTunnelInfo | TunnelInfo | C | 0 . . . 1 | This IE shall be present for a PDU session | DTSSA |
| | | | | involving an I-SMF, except when Control Plane | |
| | | | | CloT 5GS Optimisation is enabled and data delivery | |
| | | | | via NEF is selected for this PDU session. | |
| | | | | When present, this IE shall contain the N9 tunnel | |
| | | | | information of the SMF. | |
| additionalCnTunnelInfo | TunnelInfo | C | 0 . . . 1 | This IE shall be present if a MA-PDU session is | MAPDU |
| | | | | established for a UE registered over both 3GPP | |
| | | | | access and Non-3GPP access. | |
| | | | | When present, it shall contain additional N9 tunnel | |
| | | | | information of the UPF controlled by the H-SMF or | |
| | | | | SMF. | |
| sessionAmbr | Ambr | C | 0 . . . 1 | This IE shall be present, except when Control Plane | |
| | | | | CloT 5GS Optimisation is enabled for the PDU | |
| | | | | session. | |
| | | | | When present, this IE shall contain the Session | |
| | | | | AMBR granted to the PDU session. | |
| qosFlowsSetupList | array(QosFlowSetupItem) | C | 1 . . . N | This IE shall be present, except when Control Plane | |
| | | | | CloT 5GS Optimisation is enabled for the PDU | |
| | | | | session. | |
| | | | | When present, this IE shall contain the full set of | |
| | | | | QoS flow(s) to establish for the PDU session. It | |
| | | | | shall contain at least the Qos flow associated to | |
| | | | | the default Qos rule. | |
| | | | | In V-SMF/I-SMF insertion scenarios where no QoS | |
| | | | | Rule(s) associated to a QoS flow can or need to be | |
| | | | | sent to the UE, the qosRules attribute of the | |
| | | | | QosFlowSetupItem may be set to an empty string or | |
| | | | | to the latest QoS Rule(s) associated to the QoS flow. | |
| | | | | (NOTE 3) | |
| hSmfInstanceId | NfInstanceId | C | 0 . . . 1 | This IE shall be present for a HR PDU session. | |
| | | | | When present, it shall contain the identifier of the | |
| | | | | home SMF. | |
| smfInstanceId | NfInstanceId | C | 0 . . . 1 | This IE shall be present for a PDU session with an I- | DTSSA |
| | | | | SMF. When present, it shall contain the identifier of | |
| | | | | the SMF. | |
| pduSessionId | PduSessionId | C | 0 . . . 1 | This IE shall be present during an EPS to 5GS Idle | |
| | | | | mode mobility or handover preparation using the | |
| | | | | N26 interface. | |
| | | | | When present, it shall be set to the PDU Session ID. | |
| sNssai | Snssai | C | 0 . . . 1 | This IE shall be present during an EPS to 5GS Idle | |
| | | | | mode mobility or handover using the N26 interface. | |
| | | | | When present, it shall contain: | |
| | | | | the S-NSSAI assigned to the PDU session in | |
| | | | | the Home PLMN, for a HR PDU session; | |
| | | | | the S-NSSAI assigned to the PDU session in | |
| | | | | the serving PLMN, for a PDU session with an | |
| | | | | I-SMF. The Snssai shall overwrite the S- | |
| | | | | NSSAI earlier stored in I-SMF, if they are | |
| | | | | different. | |
| enablePauseCharging | boolean | C | 0 . . . 1 | This IE shall be present, based on operator's policy, | |
| | | | | to enable the use of Pause of Charging for the PDU | |
| | | | | session (see clause 4.4.4 of 3GPP TS 23.502 [3]). | |
| | | | | When present, it shall be set as follows: | |
| | | | | true: enable Pause of Charging; | |
| | | | | false (default): disable Pause of Charging. | |
| uelpv4Address | Ipv4Addr | C | 0 . . . 1 | This IE shall be present if the SMF assigns a UE | |
| | | | | IPv4 address to the PDU session. | |
| uelpv6Prefix | Ipv6Prefix | C | 0 . . . 1 | This IE shall be present if the SMF assigns a UE | |
| | | | | IPv6 prefix to the PDU session. | |
| n1SmInfoToUe | RefToBinaryData | C | 0 . . . 1 | This IE shall be present if the SMF needs to send | |
| | | | | N1 SM information to the UE that does not need to | |
| | | | | be interpreted by the V-SMF or I-SMF. When | |
| | | | | present, this IE shall reference the n1SmInfoToUe | |
| | | | | binary data (see clause 6.1.6.4.4). | |
| epsPdnCnxInfo | EpsPdnCnxInfo | C | 0 . . . 1 | This IE shall be present if the PDU session may be | |
| | | | | moved to EPS during its lifetime. | |
| epsBearerInfo | array(EpsBearerInfo) | C | 1 . . . N | This IE shall be present if the PDU session may be | |
| | | | | moved to EPS during its lifetime. | |
| supportedFeatures | SupportedFeatures | C | 0 . . . 1 | This IE shall be present if at least one optional | |
| | | | | feature defined in clause 6.1.8 is supported. | |
| maxIntegrityProtectedDataRate | MaxIntegrityProtectedDataRate | C | 0 . . . 1 | This IE shall be present if the upSecurity IE is | |
| | | | | present and indicates that integrity protection is | |
| | | | | preferred or required. | |
| | | | | When present, it shall indicate the maximum | |
| | | | | integrity protected data rate for uplink. | |
| | | | | If the maxIntegrityProtectedDataRateDI IE is | |
| | | | | absent, this IE applies to both uplink and downlink. | |
| | | | | (NOTE 6) | |
| maxIntegrityProtectedDataRateDI | MaxIntegrityProtectedDataRate | C | 0 . . . 1 | This IE may be present if the upSecurity IE is | |
| | | | | present and indicates that integrity protection | |
| | | | | is preferred or required. | |
| | | | | When present, it shall indicate the maximum | |
| | | | | integrity protected data rate for downlink. | |
| | | | | (NOTE 6) | |
| alwaysOnGranted | boolean | C | 0 . . . 1 | This IE shall be present if the alwaysOnRequested | |
| | | | | IE was received in the request or if the SMF | |
| | | | | determines, based on local policy, that the PDU | |
| | | | | session needs to be established as an always-on | |
| | | | | PDU session. | |
| | | | | When present, it shall be set as follows: | |
| | | | | true: always-on PDU session granted. | |
| | | | | false (default): always-on PDU session not | |
| | | | | granted. | |
| gpsi | Gpsi | C | 0 . . . 1 | This IE shall be present if no GPSI IE is provided in | |
| | | | | the request, e.g. for a PDU session moved from | |
| | | | | another access or another system, and the SMF | |
| | | | | knows that a GPSI is already associated with the | |
| | | | | PDU session. | |
| | | | | When present, it shall contain the user's GPSI | |
| | | | | associated with the PDU session. | |
| upSecurity | UpSecurity | O | 0 . . . 1 | When present, this IE shall indicate the security | |
| | | | | policy for integrity protection and encryption for the | |
| | | | | user plane of the PDU session. | |
| | | | | If this IE is present, it shall not indicate that | |
| | | | | integrity protection is preferred or required, if the | |
| | | | | maxIntegrityProtectedDataRate IE is not present | |
| | | | | (e.g. if UE Integrity Protection Maximum Data | |
| | | | | Rate is not available in the SMF). | |
| | | | | (NOTE 6) | |
| roamingChargingProfile | RoamingChargingProfile | O | 0 . . . 1 | Roaming Charging Profile selected by the HPLMN | |
| | | | | (see clauses 5.1.9.1, 5.2.1.7 and 5.2.2.12.2 of | |
| | | | | 3GPP TS 32.255 [25]). | |
| hSmfServiceInstanceId | string | O | 0 . . . 1 | When present, this IE shall contain the | |
| | | | | serviceInstanceId of the H-SMF service instance | |
| | | | | serving the PDU session, for a HR PDU session. | |
| | | | | This IE may be used by the V-SMF to identify PDU | |
| | | | | sessions affected by a failure or restart of the | |
| | | | | H-SMF service (see clause 6.2 of 3GPP TS 23.527 | |
| | | | | [24]). | |
| smfServiceInstanceId | string | O | 0 . . . 1 | When present, this IE shall contain the | DTSSA |
| | | | | serviceInstanceId of the SMF service instance | |
| | | | | serving the PDU session, for a PDU session with an | |
| | | | | I-SMF. | |
| | | | | This IE may be used by the I-SMF to identify PDU | |
| | | | | sessions affected by a failure or restart of the SMF | |
| | | | | service (see clause 6.2 of 3GPP TS 23.527 [24]). | |
| recoveryTime | DateTime | O | 0 . . . 1 | Timestamp when the SMF service instance serving | |
| | | | | the PDU session was (re)started (see clause 6.3 of | |
| | | | | 3GPP TS 23.527 [24]). | |
| dnaiList | array(Dnai) | C | 1 . . . N | This IE shall be present over N16a, if available and | DTSSA |
| | | | | an I-SMF has been inserted into a PDU session, | |
| | | | | during the following procedures: PDU session | |
| | | | | establishment, Registration, Service Request, Xn | |
| | | | | based handover, Inter NG-RAN node N2 based | |
| | | | | handover (see clause 4.23 of 3GPP TS 23.502 [3]). | |
| | | | | When present, it shall include the list of DNAIs of | |
| | | | | interest for the PDU session for local traffic steering | |
| | | | | at the I-SMF | |
| fullDnaiList | array(Dnai) | C | 1 . . . N | This IE shall be present over N16a, if available | |
| | | | | and an I-SMF has been inserted into a PDU | |
| | | | | session, during the following procedures: PDU | |
| | | | | session establishment, Registration, Service | |
| | | | | Request, Xn based handover, Inter NG-RAN node | |
| | | | | N2 based handover (see clause 4.23 of | |
| | | | | 3GPP TS 23.502 [3]). | |
| | | | | When present, it shall include DNAIs in the list of | |
| | | | | DNAI(s) of interest for PDU session (provisioned | |
| | | | | by the PCF) excluding the ones supported by the | |
| | | | | Anchor SMF. | |
| ipv6MultiHomingInd | boolean | C | 0 . . . 1 | This IE shall be present over N16a, if available and | DTSSA |
| | | | | an I-SMF has been inserted into the PDU session | |
| | | | | during the following procedures: PDU session | |
| | | | | establishment, Registration, Service Request, Xn | |
| | | | | based handover, Inter NG-RAN node N2 based | |
| | | | | handover (see clause 4.23 of 3GPP TS 23.502 [3]). | |
| | | | | When present, it shall be set as follows: | |
| | | | | true: IPv6 multi-homing is permitted. | |
| | | | | false (default): IPv6 multi-homing is not allowed. | |
| maAcceptedInd | boolean | C | 0 . . . 1 | This IE shall be present if a request to establish a | MAPDU |
| | | | | MA PDU session was accepted or if a single access | |
| | | | | PDU session was upgraded into a MA PDU session | |
| | | | | (see clauses 4.22.2 and 4.22.3 of 3GPP TS 23.502 | |
| | | | | [3]). | |
| | | | | When present, it shall be set as follows: | |
| | | | | true: MA PDU session | |
| | | | | false (default): single access PDU session | |
| homeProvidedChargingId | string | O | 0 . . . 1 | When present, this IE shall contain the Home | |
| | | | | provided Charging ID (see 3GPP TS 32.255 [25]). | |
| | | | | This IE shall be present during an EPS to 5GS Idle | |
| | | | | mode mobility or Handover of a HR PDU session. | |
| | | | | (NOTE 5) | |
| nefExtBufSupportInd | boolean | C | 0 . . . 1 | This IE shall be present with value “true”, if | CIOT |
| | | | | NEF has indicated Extended Buffering Support for | |
| | | | | mobile terminated data in SMF-NEF connection | |
| | | | | establishment response. | |
| | | | | When present, this IE shall be set as following: | |
| | | | | true: Extended Buffering supported by NEF | |
| | | | | false (default): Extended Buffering not | |
| | | | | supported by NEF | |
| smallDataRateControlEnabled | boolean | C | 0 . . . 1 | This IE shall be present and set to “true” if small | CIOT |
| | | | | data rate control is applicable on the PDU session. | |
| | | | | When present, it shall be set as follows: | |
| | | | | true: small data rate control is applicable. | |
| | | | | false (default): small data rate control is not | |
| | | | | applicable. | |
| uelpv6InterfaceId | string | C | 0 . . . 1 | This IE shall be present if the H-SMF/SMF has | |
| | | | | assigned IPv6 interface identifier to the UE during | |
| | | | | the PDU session establishment for the Home-routed | |
| | | | | Roaming scenario or for a PDU session with an | |
| | | | | I-SMF. | |
| | | | | When present, it shall encode the UE IPv6 Interface | |
| | | | | Identifier to be used by the UE for its link-local | |
| | | | | address configuration with 16 hexadecimal digits. | |
| | | | | Pattern: “\hat{ }[A-Fa-f0-9]{16}$” | |
| ipv6Index | IpIndex | C | 0 . . . 1 | This IE shall be present if IPv6 Index has been | DTSSA |
| | | | | received from PCF during SM Policy Creation. | |
| | | | | (NOTE 4) | |
| dnAaaAddress | IpAddress | O | 0 . . . 1 | When present, this IE shall contain the address of | DTSSA |
| | | | | DN-AAA server for UE IP Address allocation that | |
| | | | | has been received from UDM. (NOTE 4). | |
| redundantPduSessionInfo | RedundantPduSessionInformation | C | 0 . . . 1 | This IE shall be present for a PDU session with an I- | DCE2ER |
| | | | | SMF, if Dual Connectivity based end to end | |
| | | | | Redundant User Plane Paths shall apply as specified | |
| | | | | in clause 5.33.2.1 of 3GPP TS 23.501 [2], | |
| | | | | regardless of whether the redundantPduSessionInfo | |
| | | | | IE was received or not in the request. If an RSN | |
| | | | | and/or PDU Session Pair ID was received from the | |
| | | | | UE, the same RSN and/or PDU Session Pair ID | |
| | | | | shall be returned in the response; additionally, | |
| | | | | if either the RSN or PDU Session Pair ID was not | |
| | | | | received from the UE, the anchor SMF shall | |
| | | | | determine and also return an RSN or PDU Session | |
| | | | | Pair ID respectively in the response. | |
| nspuSupportInd | boolean | C | 0 . . . 1 | This IE shall be present and set to “true” if | |
| | | | | enablePauseCharging is set to “true” and if the | |
| | | | | (H-)SMF and PSA UPF support Notify Start Pause | |
| | | | | of Charging via user plane feature as specified | |
| | | | | in clause 5.30 of 3GPP TS 29.244 [29]. | |
| | | | | When present, it shall be set as follows: | |
| | | | | true: Notify Start Pause of Charging via user | |
| | | | | plane feature is supported. | |
| interPlmnApiRoot | Uri | C | 0 . . . 1 | This IE should be present if the PDU session may be | |
| | | | | subject to inter-PLMN mobility and different PDU | |
| | | | | session context URIs shall be used for intra-PLMN | |
| | | | | and inter-PLMN signaling requests targeting the | |
| | | | | PDU session context. | |
| | | | | When present, it shall contain the apiRoot of the | |
| | | | | PDU session context to be used in inter-PLMN | |
| | | | | signalling request targeting the PDU session context. | |
| | | | | (NOTE 7) | |
| intraPlmnApiRoot | Uri | C | 0 . . . 1 | This IE should be present if the PDU session may be | |
| | | | | subject to inter-PLMN mobility and different PDU | |
| | | | | session context URIs shall be used for intra-PLMN | |
| | | | | and inter-PLMN signaling requests targeting the | |
| | | | | PDU session context. | |
| | | | | When present, it shall contain the apiRoot of the | |
| | | | | PDU session context to be used in intra-PLMN | |
| | | | | signalling request targeting the PDU session context. | |
| | | | | (NOTE 7) | |

(NOTE 1):
This IE contains information that the V-SMF or I-SMF only needs to transfer to the UE (without interpretation). It is sent as a separate IE rather than within the n1SmInfoToUE binary data because the Selected SSC mode IE is defined as a “V” IE (i.e. without a Type field) in the NAS PDU Session Establishment Accept message.
(NOTE 2):
In scenarios with a V-SMF/I-SMF insertion, the V-SMF/I-SMF may receive in the Create Response some IEs it has already received during the earlier SM context retrieval from the SMF (e.g. due to the condition of presence of IEs in the Create Response). In such a case, the V-SMF/I-SMF shall overwrite the IEs earlier received with the new IEs received in the Create Response.
(NOTE 3):
The V-SMF/I-SMF shall ignore any QoS Rule(s) associated to a QoS flow received in PduSessionCreatedData during V-SMF/I-SMF insertion scenarios where no QoS Rule(s) can be sent to the UE, i.e. during Registration, Inter NG-RAN node N2 based handover, and EPS to 5GS Idle mode mobility/handover using N26 interface procedures with V-SMF/I-SMF insertion, or during Service Request and Xn based handover procedures with I-SMF insertion. In such scenarios, the (H-)SMF shall initiate a subsequent PDU session modification procedure if it needs to change the QoS Rules associated to the QoS flows.
(NOTE 4):
The I-SMF may use IPv6 index to assist in selecting how the IPv6 prefix is to be allocated for local PSA when IPv6 multi-homing is applied for the PDU session. If the IPv6 index indicates UE IP address allocation should be performed towards DN-AAA server, the DN-AAA server address may be included from the SMF to the I-SMF.
(NOTE 5):
The chargingId IE in SmContext (see clause 6.1.6.2.39) shall be set to the value received in the homeProvidedChargingId IE during an EPS to 5GS Idle mode mobility or Handover of a HR PDU session.
(NOTE 6):
During inter-system mobility from EPS to 5GS, the UE Integrity Protection Maximum Data Rate is not available at the SMF during PDU Session Creation. The UE will provide UE Integrity Protection Maximum Data Rate to the network within a subsequent UE triggered PDU session modification procedure, as specified in clause 4.3.3.2 of 3GPP TS 23.502 [3].
(NOTE 7):
During an inter-PLMN mobility, after retrieving the SM context from the old V-SMF, I-SMF or anchor SMF, the target V-SMF or I-SMF shall replace the apiRoot of the pduSessionRef with the interPlmnApiRoot (if available) if the anchor SMF is not in the target PLMN, or with the intraPlmnApiRoot (if available) otherwise. The Operator Identifier in the DNN indicates the PLMN ID of the anchor SMF.

TABLE 6.1.6.2.12-1
Definition of type HsmfUpdatedData

| | | | Cardi- | | Appli- |
|---|---|---|---|---|---|
| Attribute name | Data type | P | nality | Description | cability |
| n1SmInfoToUe | RefToBinaryData | C | 0 . . . 1 | This IE shall be present if the H-SMF/SMF needs to | |
| | | | | send N1 SM information to the UE that does not | |
| | | | | need to be interpreted by the V-SMF/I-SMF. When | |
| | | | | present, this IE shall reference the n1SmInfoToUe | |
| | | | | binary data (see clause 6.1.6.4.4). | |
| n4Info | N4Information | O | 0 . . . 1 | This IE may be present if the SMF needs to send N4 | DTSSA |
| | | | | response information to the I-SMF (e.g. related with | |
| | | | | traffic usage reporting). | |
| n4InfoExt1 | N4Information | O | 0 . . . 1 | This IE may be present if the SMF needs to send | DTSSA |
| | | | | additional N4 response information to the I-SMF(e.g. | |
| | | | | related with traffic usage reporting). | |
| n4InfoExt2 | N4Information | O | 0 . . . 1 | This IE may be present if the SMF needs to send | DTSSA |
| | | | | additional N4 response information to the I-SMF | |
| | | | | (e.g. related with traffic usage reporting). | |
| dnaiList | array(Dnai) | C | 1 . . . N | This IE shall be present over N16a during UE | DTSSA |
| | | | | Triggered Service Request procedure with I-SMF | |
| | | | | change, Xn based handover and Inter NG-RAN node | |
| | | | | N2 based handover with I-SMF change (see clauses | |
| | | | | 4.23.4.3, 4.23.11.3 and 4.23.7.3.3 in | |
| | | | | 3GPP TS 23.502 [3]). | |
| | | | | When present, it shall include the DNAI(s) of interest | |
| | | | | for this PDU Session. | |
| fullDnaiList | array(Dnai) | C | 1 . . . N | This IE shall be present over N16a during UE | |
| | | | | Triggered Service Request procedure with I-SMF | |
| | | | | change, Xn based handover and Inter NG-RAN | |
| | | | | node N2 based handover with I-SMF change (see | |
| | | | | clauses 4.23.4.3, 4.23.11.3 and 4.23.7.3.3 in | |
| | | | | 3GPP TS 23.502 [3]). | |
| | | | | When present, it shall include DNAIs in the list of | |
| | | | | DNAI(s) of interest for PDU session (provisioned | |
| | | | | by the PCF) excluding the ones supported by the | |
| | | | | Anchor SMF. | |
| supportedFeatures | SupportedFeatures | C | 0 . . . 1 | This IE shall be present if the supportedFeatures IE | |
| | | | | was received in the request and at least one optional | |
| | | | | feature defined in clause 6.1.8 is supported by the | |
| | | | | updated PDU session resource. | |
| roamingChargingProfile | RoamingChargingProfile | O | 0 . . . 1 | This IE may be present during an inter-PLMN V-SMF | |
| | | | | change (including the inter-PLMN mobility from | |
| | | | | HPLMN with I-SMF to VPLMN). When present, it | |
| | | | | shall contain the Roaming Charging Profile selected | |
| | | | | by the HPLMN (see clauses 5.1.9.1, 5.2.1.7 and | |
| | | | | 5.2.2.12.2 of 3GPP TS 32.255 [25]). | |
| homeProvidedChargingId | string | C | 0 . . . 1 | When present, this IE shall contain the Home | DTSSA |
| | | | | provided Charging ID (see 3GPP TS 32.255 [25]). | |
| | | | | This IE shall be present during a HPLMN to VPLMN | |
| | | | | mobility of a PDU session with I-SMF in HPLMN. | |
| | | | | (NOTE 3) | |
| ipv6MultiHomingInd | boolean | C | 0 . . . 1 | This IE shall be present over N16a, if available and | DTSSA |
| | | | | an I-SMF has been changed during the following | |
| | | | | procedures: Registration, Service Request, Xn | |
| | | | | based handover, Inter NG-RAN node N2 based | |
| | | | | handover (see clause 4.23 of 3GPP TS 23.502 [3]). | |
| | | | | When present, it shall be set as follows: | |
| | | | | true: IPv6 multi-homing is permitted. | |
| | | | | false (default): IPv6 multi-homing is not allowed. | |
| upSecurity | UpSecurity | C | 0 . . . 1 | This IE shall be present if the “upSecurityInfo” IE | |
| | | | | was received in the request (i.e. during an Xn | |
| | | | | handover), and there is a mismatch between security | |
| | | | | policy received and stored (see clause 5.2.2.8.2.16). | |
| | | | | When present, this IE shall indicate the security | |
| | | | | policy for integrity protection and encryption for the | |
| | | | | user plane of the PDU session. | |
| | | | | This IE may be present during a handover from non- | |
| | | | | 3GPP access to 3GPP access, to indicate the | |
| | | | | security policy for integrity protection and encryption | |
| | | | | for the user plane of the PDU session in the target | |
| | | | | access type. | |
| | | | | This IE may be present when UE Integrity Protection | |
| | | | | Maximum Data Rate was received in the request, | |
| | | | | during a UE triggered PDU session modification | |
| | | | | procedure. | |
| | | | | (NOTE 1, NOTE 2) | |
| maxIntegrityProtectedDataRateUl | MaxIntegrityProtectedDataRate | C | 0 . . . 1 | This IE shall be present if the upSecurity IE is | |
| | | | | present and indicates that integrity protection is | |
| | | | | preferred or required. | |
| | | | | When present, it shall indicate the maximum integrity | |
| | | | | protected data rate supported by the UE for uplink. | |
| | | | | (NOTE 1) | |
| maxIntegrityProtectedDataRateDl | MaxIntegrityProtectedDataRate | C | 0 . . . 1 | This IE shall be present if the upSecurity IE is | |
| | | | | present and indicates that integrity protection is | |
| | | | | preferred or required. | |
| | | | | When present, it shall indicate the maximum integrity | |
| | | | | protected data rate supported by the UE for | |
| | | | | downlink. | |
| | | | | (NOTE 1) | |
| qosFlowsSetupList | array(QosFlowSetupItem | C | 1 . . . N | This IE shall be present during a handover between | |
| | | | | 3GPP and non-3GPP accesses. | |
| | | | | When present, it shall contain the set of QoS flow(s) | |
| | | | | to establish for the PDU session for the target | |
| | | | | access type. | |
| | | | | (NOTE 1) | |
| sessionAmbr | Ambr | C | 0 . . . 1 | This IE shall be present during a handover between | |
| | | | | 3GPP and non-3GPP accesses. | |
| | | | | When present, this IE shall contain the Session | |
| | | | | AMBR authorized for the PDU session for the target | |
| | | | | access type. | |
| | | | | (NOTE 1) | |
| epsPdnCnxInfo | EpsPdnCnxInfo | C | 0 . . . 1 | This IE shall be present during a handover from non- | |
| | | | | 3GPP access to 3GPP access, if the PDU session | |
| | | | | may be moved to EPS during its lifetime. | |
| | | | | (NOTE 1) | |
| | | | | The IE shall also be included when the EPS PDN | |
| | | | | Connection Context Information of the PDU session | |
| | | | | is changed, e.g. due to reselection of anchor SMF. | |
| epsBearerInfo | array(EpsBearerInfo) | C | 1 . . . N | This IE shall be present during a handover from non- | |
| | | | | 3GPP access to 3GPP access, if the PDU session | |
| | | | | may be moved to EPS during its lifetime. | |
| | | | | When present, it shall include the complete | |
| | | | | epsBearerInfo IE(s) for all EBIs. | |
| | | | | (NOTE 1) | |
| pti | ProcedureTransactionId | C | 0 . . . 1 | This IE shall be present during a handover between | |
| | | | | 3GPP and non-3GPP accesses. | |
| | | | | When present, it shall contain the PTI value received | |
| | | | | in the corresponding request. | |
| interPlmnApiRoot | Uri | C | 0 . . . 1 | This IE should be present if the information has | |
| | | | | changed. When present, it shall contain the apiRoot | |
| | | | | of the PDU session context to be used in inter-PLMN | |
| | | | | signalling request targeting the PDU session context. | |
| intraPlmnApiRoot | Uri | C | 0 . . . 1 | This IE should be present if the information has | |
| | | | | changed. When present, it shall contain the apiRoot | |
| | | | | of the PDU session context to be used in intra-PLMN | |
| | | | | signalling request targeting the PDU session context. | |

(NOTE 1):
During a handover between 3GPP and non-3GPP accesses, the V-SMF or I-SMF shall delete any corresponding information received earlier for the source access type and use the new information received for the target access type.
(NOTE 2):
During inter-system mobility from EPS to 5GS, the UE Integrity Protection Maximum Data Rate is not available at the SMF during PDU Session Creation. The UE will provide UE Integrity Protection Maximum Data Rate to the network within a subsequent UE triggered PDU session modification procedure, as specified in clause 4.3.3.2 of 3GPP TS 23.502 [3].
(NOTE 3):
The chargingId IE in SmContext (see clause 6.1.6.2.39) shall be set to the value received in the homeProvidedChargingId IE during a HPLMN to VPLMN mobility of a PDU session with I-SMF in HPLMN.

TABLE 6.1.6.2.15-1
Definition of type VsmfUpdateData

| | | | Cardi- | | Appli- |
|---|---|---|---|---|---|
| Attribute name | Data type | P | nality | Description | cability |
| requestIndication | RequestIndication | M | 1 | This IE shall indicate the request type. | |
| sessionAmbr | Ambr | C | 1 | This IE shall be present if the Session AMBR | |
| | | | | authorized for the PDU session is modified. When | |
| | | | | present, it shall contain the new Session AMBR | |
| | | | | authorized for the PDU session. | |
| qosFlowsAddModRequestList | array(QosFlowAddModifyRequestItem) | C | 1 . . . N | This IE shall be present if QoS flows are requested | |
| | | | | to be established or modified. | |
| qosFlowsRelRequestList | array(QosFlowReleaseRequestItem) | C | 1 . . . N | This IE shall be present if QoS flows are requested | |
| | | | | to be released. | |
| epsBearerInfo | array(EpsBearerInfo) | C | 1 . . . N | This IE shall be present if the PDU session may be | |
| | | | | moved to EPS during its lifetime and the | |
| | | | | ePSBearerInfo has changed. | |
| | | | | When present, it shall only include epsBearerInfo | |
| | | | | IE(s) for new EBI or for EBIs for which the | |
| | | | | epsBearerInfo has changed. The complete | |
| | | | | epsBearerInfo shall be provided for an EBI that is | |
| | | | | included (i.e. the epsBearerInfo newly received for a | |
| | | | | given EBI replaces any epsBearerInfo previously | |
| | | | | received for this EBI). | |
| assignEbiList | array(Arp) | C | 1 . . . N | This IE shall be present if the H-SMF requests EBIs | |
| | | | | to be assigned. | |
| revokeEbiList | array(EpsBearerId) | C | 1 . . . N | This IE shall be present if the H-SMF/SMF requests | |
| | | | | the V-SMF/I-SMF to revoke some EBI(s). When | |
| | | | | present, it shall contain the EBIs to revoke. | |
| modifiedEbiList | array(EbiArpMapping) | C | 1 . . . N | This IE shall be present if a PDU session | |
| | | | | modification procedure resulted in the change of | |
| | | | | ARP for a QoS flow that was already allocated an | |
| | | | | EBI. | |
| pti | ProcedureTransactionId | C | 0 . . . 1 | This IE shall be present if the request is sent in | |
| | | | | response to a UE requested PDU session | |
| | | | | modification or release. When present, it shall | |
| | | | | contain the PTI value received in the corresponding | |
| | | | | request. | |
| n1SmInfoToUe | RefToBinaryData | C | 0 . . . 1 | This IE shall be present if the H-SMF/SMF needs to | |
| | | | | send N1 SM information to the UE that does not | |
| | | | | need to be interpreted by the V-SMF/I-SMF. When | |
| | | | | present, this IE shall reference the n1SmInfoToUe | |
| | | | | binary data (see clause 6.1.6.4.4). | |
| alwaysOnGranted | boolean | C | 0 . . . 1 | This IE shall be present if: | |
| | | | | an alwaysOnRequested IE was received in | |
| | | | | an earlier V-SMF/I-SMF initiated Update | |
| | | | | request to change the PDU session to an | |
| | | | | always-on PDU session; or | |
| | | | | the H-SMF/SMF determines, based on local | |
| | | | | policy, that the PDU session needs to be | |
| | | | | established as an always-on PDU session. | |
| | | | | When present, it shall be set as follows: | |
| | | | | true: always-on PDU session granted. | |
| | | | | false (default): always-on PDU session not | |
| | | | | granted. | |
| hsmfPduSessionUri | Uri | C | 0 . . . 1 | This IE shall be included if: | |
| | | | | an Update Request is sent to the V-SMF/I- | |
| | | | | SMF before the Create Response (e.g. for | |
| | | | | EPS bearer ID allocation as specified in | |
| | | | | clause 4.11.1.4.1 of 3GPP TS 23.502 [3], or | |
| | | | | for Secondary authorization/authentication as | |
| | | | | specified in clause 4.3.2.3 of | |
| | | | | 3GPP TS 23.502 [3]), and | |
| | | | | the H-SMF PDU Session Resource URI has | |
| | | | | not been previously provided to the V-SMF/I- | |
| | | | | SMF. | |
| | | | | This IE shall not be included otherwise. | |
| | | | | When present, this IE shall include the URI | |
| | | | | representing the PDU session resource in the H- | |
| | | | | SMF. | |
| newSmfId | NfInstanceId | C | 0 . . . 1 | This IE may be present if the anchor SMF has | |
| | | | | changed and the SMF Instance ID of the new anchor | |
| | | | | SMF has not been already signalled to the I-SMF or | |
| | | | | V-SMF. | |
| | | | | When present, it shall carry the NF instance | |
| | | | | identifier of the new anchor SMF handling the PDU | |
| | | | | session. | |
| newSmfPduSessionUri | Uri | C | 0 . . . 1 | This IE shall be present if the newSmfId is present. | |
| | | | | When present, it shall carry the URI representing the | |
| | | | | updated PDU session resource in the new anchor | |
| | | | | SMF. | |
| supportedFeatures | SupportedFeatures | C | 0 . . . 1 | This IE shall be present if “hsmfPduSessionUri” | |
| | | | | IE is present and at least one optional feature | |
| | | | | defined in clause 6.1.8 is supported. | |
| cause | Cause | O | 0 . . . 1 | When present, this IE shall indicate the cause for | |
| | | | | the requested modification. | |
| n1smCause | string | O | 0 . . . 1 | When present, this IE shall contain the 5GSM cause | |
| | | | | the H-SMF proposes the V-SMF/I-SMF to send to | |
| | | | | the UE. It shall be encoded as two characters in | |
| | | | | hexadecimal representation with each character | |
| | | | | taking a value of “0” to “9” or “A” to “F”, and | |
| | | | | represent the cause value of the 5GSM cause IE | |
| | | | | specified in clause 9.11.4.2 of 3GPP TS 24.501 [7]. | |
| | | | | Example: the cause “Invalid mandatory information” | |
| | | | | shall be encoded as “60”. | |
| | | | | See NOTE. | |
| backOffTimer | DurationSec | O | 0 . . . 1 | When present, this IE shall indicate a Back-off timer | |
| | | | | value, in seconds, that the V-SMF/I-SMF may use | |
| | | | | when sending the NAS message (PDU Session | |
| | | | | Release Command) towards the UE. | |
| maReleaseInd | MaReleaseIndication | C | 0.1 | This IE shall be present if one access of a MA PDU | MAPDU |
| | | | | session is to be released, when H-SMF or SMF | |
| | | | | initiates MA PDU session release over one access. | |
| | | | | When present, it shall indicate the access requested | |
| | | | | to be released. | |
| maAcceptedInd | boolean | C | 0 . . . 1 | This IE shall be present if a request to modify a | MAPDU |
| | | | | single access PDU session into a MA PDU session | |
| | | | | was accepted (see clause 4.22.6.3 of | |
| | | | | 3GPP TS 23.502 [3]). | |
| | | | | When present, it shall be set as follows: | |
| | | | | true: MA PDU session | |
| | | | | false (default): single access PDU session | |
| additionalCnTunnelInfo | TunnelInfo | C | 0 . . . 1 | This IE shall be present for a MA-PDU session if | MAPDU |
| | | | | the UE requested to establish resources for a | |
| | | | | MA PDU session over the other access. | |
| | | | | When present, it shall contain additional N9 tunnel | |
| | | | | information of the UPF controlled by the H-SMF or | |
| | | | | SMF. | |
| dnaiList | array(Dnai) | C | 0 . . . N | This IE shall be present if received from PCF during | DTSSA |
| | | | | I-SMF Related Procedures with PCF (see | |
| | | | | clause 4.23.6.2 in 3GPP TS 23.502 [3]). | |
| | | | | When present, the IE shall include a list of DNAI(s) | |
| | | | | the SMF deems relevant for the PDU Session. | |
| | | | | If this IE is not present, the I-SMF shall consider | |
| | | | | that the dnaiList has not changed. If there is no | |
| | | | | more DNAI of interest for the PDU session, the | |
| | | | | dnaiList attribute shall be present and be | |
| | | | | encoded as an empty array. | |
| fullDnaiList | array(Dnai) | C | 1 . . . N | This IE shall be present if received from PCF | |
| | | | | during I-SMF Related Procedures with PCF (see | |
| | | | | clause 4.23.6.2 in 3GPP TS 23.502 [3]). | |
| | | | | When present, it shall include DNAIs in the list of | |
| | | | | DNAI(s) of interest for PDU session (provisioned | |
| | | | | by the PCF) excluding the ones supported by the | |
| | | | | Anchor SMF. | |
| | | | | If this IE is not present, the I-SMF shall consider | |
| | | | | that the dnaiList has not changed. If there is no | |
| | | | | more DNAI of interest for the PDU session, the | |
| | | | | dnaiList attribute shall be present and be | |
| | | | | encoded as an empty array. | |
| n4Info | N4Information | O | 0 . . . 1 | This IE may be present if the SMF needs to send N4 | DTSSA |
| | | | | information to the I-SMF for the control of traffic | |
| | | | | offloaded at a PSA/BP/ULCL controlled by an | |
| | | | | I-SMF. | |
| n4InfoExt1 | N4Information | O | 0 . . . 1 | This IE may be present if the SMF needs to send | DTSSA |
| | | | | additional N4 information to the I-SMF for the | |
| | | | | control of traffic offloaded at a PSA/BP/ULCL | |
| | | | | controlled by an I-SMF. | |
| n4InfoExt2 | N4Information | O | 0 . . . 1 | This IE may be present if the SMF needs to send | DTSSA |
| | | | | additional N4 information to the I-SMF for the | |
| | | | | control of traffic offloaded at a PSA/BP/ULCL | |
| | | | | controlled by an I-SMF (e.g. during a change of | |
| | | | | PSA). | |
| n4InfoExt3 | N4Information | O | 0 . . . 1 | This IE may be present if the SMF needs to send | SCPBU |
| | | | | additional N4 information to the I-SMF for the | |
| | | | | control of traffic offloaded at a PSA/BP/ULCL | |
| | | | | controlled by an I-SMF (e.g. during simultaneous | |
| | | | | change of BP/ULCL and PSA). | |
| smallDataRateControlEnabled | boolean | C | 0 . . . 1 | This IE shall be present if the applicability of | CIOT |
| | | | | small data rate control on the PDU session changes. | |
| | | | | When present, it shall be set as follows: | |
| | | | | true: small data rate control is applicable. | |
| | | | | false: small data rate control is not | |
| | | | | applicable. | |
| qosMonitoringInfo | QosMonitoringInfo | C | 0 . . . 1 | This IE may be present if QoS monitoring has been | DTSSA |
| | | | | activated for at least one QoS flow of the PDU | |
| | | | | session (see the qosMonitoringReq attribute in | |
| | | | | clause 6.1.6.2.22). | |
| epsPdnCnxInfo | EpsPdnCnxInfo | C | 0 . . . 1 | This IE shall be present if the PDU session may be | |
| | | | | moved to EPS during its lifetime and the | |
| | | | | EpsInterworkingIndication is changed to | |
| | | | | “WITH_N26”. | |
| | | | | The IE shall also be present when the EPS PDN | |
| | | | | Connection Context Information of the PDU session | |
| | | | | is changed, e.g. due to change of anchor SMF. | |
| n9DataForwardingInd | boolean | C | 0 . . . 1 | This IE shall be present and set as specified in | N9FSC |
| | | | | clauses 4.23.9.4 and 4.23.9.5 of 3GPP TS | |
| | | | | 23.502 [3] during simultaneous change of | |
| | | | | Branching Points or UL CLs controlled by I-SMF | |
| | | | | or controlled by different I-SMFs. | |
| | | | | When present, it shall be set as follows: | |
| | | | | true: setup N9 forwarding tunnels between | |
| | | | | Branching Points or UL CLS; | |
| | | | | false (default): N9 forwarding tunnels between | |
| | | | | Branching Points or UL CLs are not required | |
| | | | | to be setup (see clauses 5.2.2.8.3.6 and | |
| | | | | 5.2.2.8.3.10). | |
| n9InactivityTimer | DurationSec | O | 0 . . . 1 | When present, this IE shall indicate an inactivity | N9FSC |
| | | | | detection timer, in seconds, that the I-SMF may use | |
| | | | | to set the N9 forwarding tunnel inactive traffic | |
| | | | | detection timer in Branching Point or UL CL as | |
| | | | | specified in clauses 4.23.9.4 and 4.23.9.5 of | |
| | | | | 3GPP TS 23.502 [3]. | |

NOTE:
This IE contains information that the V-SMF shall transfer to the UE without interpretation. It is sent as a separate IE rather than within the n1SmInfoToUE binary data because the 5GSM cause IE is defined as a “V” IE (i.e. without a Type field) in the NAS PDU Session Release Command message.

TABLE 6.1.6.2.39-1
Definition of type SmContext

| Attribute name | Data type | P | Cardinality | Description |
|---|---|---|---|---|
| pduSessionId | PduSessionId | M | 1 | This IE shall contain the PDU Session ID. |
| dnn | Dnn | M | 1 | This IE shall contain the UE requested DNN of the |
| | | | | PDU session. |
| | | | | The DNN shall be the full DNN (i.e. with both the |
| | | | | Network Identifier and Operator Identifier) for a HR |
| | | | | PDU session, and it should be the full DNN in LBO |
| | | | | and non-roaming scenarios. If the Operator Identifier |
| | | | | is absent, the serving core network operator shall be |
| | | | | assumed. |
| selectedDnn | Dnn | C | 0 . . . 1 | This IE shall be present, if another DNN other than |
| | | | | the UE requested DNN is selected for this PDU |
| | | | | session. |
| | | | | When present, it shall contain the selected DNN. |
| | | | | The DNN shall be the full DNN (i.e. with both the |
| | | | | Network Identifier and Operator Identifier) for a HR |
| | | | | PDU session, and it should be the full DNN in LBO |
| | | | | and non-roaming scenarios. If the Operator Identifier |
| | | | | is absent, the serving core network operator shall be |
| | | | | assumed. |
| sNssai | Snssai | M | 1 | This IE shall contain the S-NSSAI for the serving |
| | | | | PLMN. |
| hplmnSnssai | Snssai | C | 0 . . . 1 | This IE shall be present for a HR PDU session. |
| | | | | When present, it shall contain the S-NSSAI for the |
| | | | | HPLMN. |
| pduSessionType | PduSessionType | M | 1 | This IE shall indicate the PDU session type. |
| gpsi | Gpsi | C | 0 . . . 1 | This IE shall be present if it is available. When |
| | | | | present, it shall contain the user's GPSI. |
| hSmfUri | Uri | C | 0 . . . 1 | This IE shall be present in HR roaming scenarios. |
| | | | | When present, it shall contain the API URI of the |
| | | | | Nsmf_PDUSession service of the H-SMF. The API |
| | | | | URI shall be formatted as specified in clause 6.1.1. |
| smfUri | Uri | C | 0 . . . 1 | This IE shall be present for a PDU session with an I- |
| | | | | SMF. When present, it shall contain the API URI of |
| | | | | the Nsmf_PDUSession service of the SMF. The API |
| | | | | URI shall be formatted as specified in clause 6.1.1. |
| pduSessionRef | Uri | C | 0 . . . 1 | This IE shall be present for a HR PDU session or a |
| | | | | PDU session with an I-SMF. |
| | | | | When present, this IE shall include the absolute URI |
| | | | | of the PDU Session in H-SMF or SMF, including |
| | | | | apiRoot (see clause 6.1.3.6.2) |
| interPlmnApiRoot | Uri | C | 0 . . . 1 | This IE shall be present, if available. |
| | | | | When present, it shall contain the apiRoot of the |
| | | | | PDU session context to be used in inter-PLMN |
| | | | | signalling request targeting the PDU session context. |
| | | | | (NOTE 2) |
| intraPlmnApiRoot | Uri | C | 0 . . . 1 | This IE shall be present, if available. |
| | | | | When present, it shall contain the apiRoot of the |
| | | | | PDU session context to be used in intra-PLMN |
| | | | | signalling request targeting the PDU session context. |
| | | | | (NOTE 2) |
| pcfId | NfInstanceId | O | 0 . . . 1 | When present, this IE shall contain the identifier of: |
| | | | | the H-PCF selected by the AMF (for UE |
| | | | | Policy), for a HR PDU session; or |
| | | | | the V-PCF selected by the AMF (for Access |
| | | | | and Mobility Policy), for a PDU session in |
| | | | | LBO roaming scenarios; or |
| | | | | the PCF selected by the AMF (for Access and |
| | | | | Mobility Policy and/or UE Policy), for a PDU |
| | | | | session in non-roaming scenarios. |
| pcfGroupId | NfGroupId | O | 0 . . . 1 | This IE may be present in non-roaming and HR |
| | | | | roaming scenarios. |
| | | | | When present, this IE shall contain the identity of the |
| | | | | (home) PCF group serving the UE for Access and |
| | | | | Mobility Policy and/or UE Policy. |
| pcfSetId | NfSetId | O | 0 . . . 1 | This IE may be present if the pcfId IE is present. |
| | | | | When present, it shall contain the NF Set ID of the |
| | | | | PCF indicated by the pcfId IE. |
| selMode | DnnSelectionMode | C | 0 . . . 1 | This IE shall be present if it is available. When |
| | | | | present, it shall be set to: |
| | | | | “VERIFIED”, if the requested DNN provided |
| | | | | by UE or the selected DNN provided by the |
| | | | | network corresponds to an explicitly |
| | | | | subscribed DNN; or |
| | | | | “UE_DNN_NOT_VERIFIED”, if the requested |
| | | | | DNN provided by UE corresponds to the |
| | | | | usage of a wildcard subscription; or |
| | | | | “NW_DNN_NOT_VERIFIED”, if the selected |
| | | | | DNN provided by network corresponds to the |
| | | | | usage of a wildcard subscription. |
| | | | | If both the requested DNN (i.e. dnn IE) and selected |
| | | | | DNN (i.e. selected Dnn IE) are present, the selMode |
| | | | | shall be related to the selected DNN. |
| udmGroupId | NfGroupId | O | 0 . . . 1 | When present, it shall indicate the identity of the |
| | | | | UDM group serving the UE. |
| routingIndicator | string | O | 0 . . . 1 | When present, it shall indicate the Routing Indicator |
| | | | | of the UE. |
| hNwPubKeyId | integer | O | 0 . . . 1 | When present, it shall indicate the Home Network |
| | | | | Public Key Identifier of the UE. (NOTE 1) |
| sessionAmbr | Ambr | M | 1 | This IE shall contain the Session AMBR granted to |
| | | | | the PDU session. |
| qosFlowsList | array(QosFlowSetupItem) | M | 1 . . . N | This IE shall contain the set of QoS flow(s) |
| | | | | established for the PDU session. It shall contain at |
| | | | | least the Qos flow associated to the default Qos rule. |
| | | | | The qosRules attribute of each QosFlowSetupItem |
| | | | | shall be set to an empty string. |
| hSmfInstanceId | NfInstanceId | C | 0 . . . 1 | This IE shall be present for a HR PDU session. |
| | | | | When present, it shall contain the identifier of the |
| | | | | home SMF. |
| smfInstanceId | NfInstanceId | C | 0 . . . 1 | This IE shall be present for a PDU session with an I- |
| | | | | SMF. |
| | | | | When present, it shall contain the identifier of the |
| | | | | SMF. |
| pduSessionSmfSetId | NfSetId | C | 0 . . . 1 | This IE shall be present, if available. |
| | | | | When present, this IE shall contain the NF Set ID of |
| | | | | the home SMF as identified by hSmfInstanceId, or |
| | | | | the SMF as identified by the smfInstanceId. |
| pduSessionSmfServiceSetId | NfServiceSetId | C | 0 . . . 1 | This IE shall be present, if available. |
| | | | | When present, this IE shall contain the NF Service |
| | | | | Set ID of the PDUSession service instance (for this |
| | | | | PDU session) in the home SMF or the SMF. |
| pduSessionSmfBinding | SbiBindingLevel | C | 0 . . . 1 | This IE shall be present, if available. |
| | | | | When present, this IE shall contain the SBI binding |
| | | | | level of the PDU session resource in the home SMF |
| | | | | or the SMF. |
| enablePauseCharging | boolean | C | 0 . . . 1 | This IE shall be present for a HR PDU session, if |
| | | | | available. |
| | | | | When present, it shall indicate whether the use of |
| | | | | Pause of Charging is enabled for the PDU session |
| | | | | (see clause 4.4.4 of 3GPP TS 23.502 [3]). |
| | | | | When present, it shall be set as follows: |
| | | | | true: enable Pause of Charging; |
| | | | | false (default): disable Pause of Charging. |
| uelpv4Address | Ipv4Addr | C | 0 . . . 1 | This IE shall be present if a UE IPv4 address to the |
| | | | | PDU session. |
| uelpv6Prefix | Ipv6Prefix | C | 0 . . . 1 | This IE shall be present if a UE IPv6 prefix to the |
| | | | | PDU session. |
| epsPdnCnxInfo | EpsPdnCnxInfo | C | 0 . . . 1 | This IE shall be present if the PDU session may be |
| | | | | moved to EPS during its lifetime. |
| epsBearerInfo | array(EpsBearerInfo) | C | 1 . . . N | This IE shall be present if the PDU session may be |
| | | | | moved to EPS during its lifetime. |
| maxIntegrityProtectedDataRate | MaxIntegrityProtectedDataRate | C | 0 . . . 1 | This IE shall be present if the upSecurity IE is |
| | | | | present and indicates that integrity protection is |
| | | | | preferred or required. |
| | | | | When present, it shall indicate the maximum integrity |
| | | | | protected data rate for uplink. |
| | | | | If the maxIntegrityProtectedDataRateDI IE is absent, |
| | | | | this IE applies to both uplink and downlink. |
| maxIntegrityProtectedDataRateDI | MaxIntegrityProtectedDataRate | C | 0 . . . 1 | This IE may be present if the upSecurity IE is |
| | | | | present and indicates that integrity protection is |
| | | | | preferred or required. |
| | | | | When present, it shall indicate the maximum integrity |
| | | | | protected data rate for downlink. |
| alwaysOnGranted | boolean | C | 0 . . . 1 | This IE shall be present if available. When present, it |
| | | | | shall indicate whether this is an always On PDU |
| | | | | session and it shall be set as follows: |
| | | | | true: always-on PDU session granted. |
| | | | | false (default): always-on PDU session not granted. |
| upSecurity | UpSecurity | O | 0 . . . 1 | When present, this IE shall indicate the security |
| | | | | policy for integrity protection and encryption for the |
| | | | | user plane of the PDU session. |
| hSmfServiceInstanceId | string | O | 0 . . . 1 | This IE may be present for a HR PDU session. |
| | | | | When present, this IE shall contain the |
| | | | | serviceInstanceId of the H-SMF service instance |
| | | | | serving the PDU session. |
| | | | | This IE may be used by the V-SMF to identify PDU |
| | | | | sessions affected by a failure or restart of the H-SMF |
| | | | | service (see clause 6.2 of 3GPP TS 23.527 [24]). |
| smfServiceInstanceId | string | O | 0 . . . 1 | This IE may be present for a PDU session with an I- |
| | | | | SMF. |
| | | | | When present, this IE shall contain the |
| | | | | serviceInstanceId of the SMF service instance |
| | | | | serving the PDU session. |
| | | | | This IE may be used by the I-SMF to identify PDU |
| | | | | sessions affected by a failure or restart of the SMF |
| | | | | service (see clause 6.2 of 3GPP TS 23.527 [24]). |
| recoveryTime | DateTime | O | 0 . . . 1 | This IE may be present if available. |
| | | | | When present, this IE shall indicate the timestamp |
| | | | | when the H-SMF or SMF service instance serving |
| | | | | the PDU session was (re)started (see clause 6.3 of |
| | | | | 3GPP TS 23.527 [24]). |
| forwardingInd | boolean | C | 0 . . . 1 | This IE shall be present, when downlink data |
| | | | | packets are buffered at I-UPF. The SMF or I-SMF |
| | | | | shall use this IE to inform the NF service consumer |
| | | | | that a forwarding tunnel is needed for receiving the |
| | | | | buffered downlink data packets, as specified in |
| | | | | clause 4.23.4 of 3GPP TS 23.502 [3]. |
| | | | | When present, this IE shall be set as follows: |
| | | | | true: a forwarding tunnel is needed for sending |
| | | | | buffered downlink data packets; |
| | | | | false (default): forwarding tunnel is not needed |
| psaTunnelInfo | TunnelInfo | C | 0 . . . 1 | This IE shall be present if available. |
| | | | | When present, this IE shall contain the N9 tunnel |
| | | | | information of PDU Session Anchor UPF controlled |
| | | | | by SMF or H-SMF. |
| chargingId | string | C | 0 . . . 1 | This IE shall be present for a HR PDU session, in |
| | | | | scenarios with a V-SMF insertion/change/removal. |
| | | | | When present, it shall contain the Charging ID of the |
| | | | | PDU session (see 3GPP TS 32.255 [25]). |
| chargingInfo | ChargingInformation | C | 0 . . . 1 | This IE shall be present for a HR PDU session, if |
| | | | | available and if the NF Service Consumer requesting |
| | | | | the SM Context pertains to the same PLMN (i.e. if |
| | | | | the Retrieve SM Context Request does not contain |
| | | | | the servingNetwork attribute set to a different PLMN |
| | | | | ID). |
| | | | | When present, it shall contain the addresses of the |
| | | | | V-CHF used for the PDU session. |
| roamingChargingProfile | RoamingChargingProfile | C | 0 . . . 1 | This IE shall be present for a HR PDU session, if |
| | | | | available and if the NF Service Consumer requesting |
| | | | | the SM Context pertains to the same PLMN (i.e. if |
| | | | | the Retrieve SM Context Request does not contain |
| | | | | the servingNetwork attribute set to a different PLMN |
| | | | | ID). |
| | | | | When present, it shall contain the Roaming Charging |
| | | | | Profile selected by the HPLMN (see clauses 5.1.9.1, |
| | | | | 5.2.1.7 and 5.2.2.12.2 of 3GPP TS 32.255 [25]). |
| nefExtBufSupportInd | boolean | C | 0 . . . 1 | This IE shall be present with value “true”, if the |
| | | | | anchor NEF has indicated support of Extended |
| | | | | Buffering for mobile terminated data during SMF- |
| | | | | NEF connection establishment. |
| | | | | When present, this IE shall be set as following: |
| | | | | true: Extended Buffering supported by NEF |
| | | | | false (default): Extended Buffering not supported by |
| | | | | NEF |
| ipv6Index | IpIndex | C | 0 . . . 1 | This IE shall be present during I-SMF change |
| | | | | scenarios, if IPv6 Index has previously been |
| | | | | received by old I-SMF. |
| dnAaaAddress | IpAddress | O | 0 . . . 1 | When present, this IE shall contain the address of |
| | | | | DN-AAA server for UE IP Address allocation |
| | | | | previously received by old I-SMF. |
| redundantPduSessionInfo | RedundantPduSessionInformation | C | 0 . . . 1 | This IE shall be present for a PDU session with an I- |
| | | | | SMF, if this information has been received previously |
| | | | | from the UE, the anchor SMF or the old I-SMF. |
| ranTunnelInfo | QosFlowTunnel | C | 0 . . . 1 | This IE shall be present if the ranUnchangedInd IE is |
| | | | | set to “true” in the SM context retrieve request. |
| | | | | When present, this IE shall contain the N2 tunnel |
| | | | | information of NG-RAN with associated QoS flows |
| | | | | (see “DL QoS Flow per TNL Information” in |
| | | | | clause 9.3.4.2 of 3GPP 38.413 [9]). |
| addRanTunnelInfo | array(QosFlowTunnel) | C | 1 . . . N | This IE shall be present if the ranUnchangedInd IE is |
| | | | | set to “true” in the SM context retrieve request. |
| | | | | When present, this IE shall contain the additional N2 |
| | | | | tunnel information of NG-RAN together with |
| | | | | associated QoS flows for split PDU session (see |
| | | | | “Additional DL QoS Flow per TNL Information” in |
| | | | | clause 9.3.4.2 of 3GPP 38.413 [9]). |
| redRanTunnelInfo | QosFlowTunnel | C | 0 . . . 1 | This IE shall be present if the ranUnchangedInd IE is |
| | | | | set to “true” in the SM context retrieve request. |
| | | | | When present, this IE shall contain the additional N2 |
| | | | | tunnel information of NG-RAN together with |
| | | | | associated QoS flows for Redundant QoS Flow(s) |
| | | | | (see “Redundant DL QoS Flow per TNL Information” |
| | | | | in clause 9.3.4.2 of 3GPP 38.413 [9]). |
| addRedRanTunnelInfo | array(QosFlowTunnel) | C | 1 . . . N | This IE shall be present if the ranUnchangedInd IE is |
| | | | | set to “true” in the SM context retrieve request. |
| | | | | When present, this IE shall contain the additional N2 |
| | | | | tunnel information of NG-RAN together with |
| | | | | associated QoS flows for Redundant QoS Flow(s) |
| | | | | with split PDU session (see “Additional Redundant |
| | | | | DL QoS Flow per TNL Information” in clause 9.3.4.2 |
| | | | | of 3GPP 38.413 [9]). |
| nspuSupportInd | boolean | C | 0 . . . 1 | This IE shall be present and set to “true” if the |
| | | | | enablePauseCharging in the SmContext data type is |
| | | | | set to “true” and if the (H-)SMF and PSA UPF |
| | | | | support Notify Start Pause of Charging via user |
| | | | | plane feature as specified in clause 5.30 of |
| | | | | 3GPP TS 29.244 [29]. |
| | | | | When present, it shall be set as follows: |
| | | | | true: Notify Start Pause of Charging via user |
| | | | | plane feature is supported. |
| smfBindingInfo | string | C | 0 . . . 1 | This IE shall be present, if available. |
| | | | | When present, this IE shall contain the Binding |
| | | | | indications of the PDU session resource in the home |
| | | | | SMF or the SMF and shall be set to the value of the |
| | | | | 3gpp-Sbi-Binding header defined in clause 5.2.3.2.6 |
| | | | | of 3GPP TS 29.500 [4], without the header name. |
| satelliteBackhaulCat | SatelliteBackhaulCategory | O | 0 . . . 1 | When present, this IE shall indicate the satellite |
| | | | | backhaul category information last signalled towards |
| | | | | the anchor SMF, if any. |
| sscMode | string | C | 0 . . . 1 | This IE shall be present, if available. |
| | | | | When present, this IE shall indicate the SSC mode |
| | | | | applicable to the PDU session. |
| | | | | When present, it shall be encoded as one character |
| | | | | in hexadecimal representation, taking a value of “0” |
| | | | | to “7”, representing the 3 bits of the SSC mode value |
| | | | | of the SSC mode IE specified in clause 9.11.4.16 of |
| | | | | 3GPP TS 24.501 [7]. |
| | | | | Pattern: “\hat{ }[0-7]$” |
| | | | | Example: SSC mode 3 shall be encoded as “3”. |
| dlsetSupportInd | boolean | C | 0 . . . 1 | This IE shall be present and set to “true” if the |
| | | | | (H-)SMF supports the “DLSET” feature as specified |
| | | | | in clause 6.1.8. |
| | | | | When present, it shall be set as follows: |
| | | | | true: the (H-)SMF supports the “DLSET” |
| | | | | feature. |
| | | | | false: the (H-)SMF does not support the |
| | | | | “DLSET” feature |
| n9fscSupportInd | boolean | C | 0 . . . 1 | This IE shall be present and set to “true” if the SMF |
| | | | | supports the “N9FSC” feature as specified in |
| | | | | clause 6.1.8. |
| | | | | When present, it shall be set as follows: |
| | | | | true: “N9FSC” feature is supported. |
| fullDnaiList | array(Dnai) | O | 1 . . . N | This IE may be present to contain DNAIs in the |
| | | | | list of DNAI(s) of interest for PDU session |
| | | | | (provisioned by the PCF) excluding the ones |
| | | | | supported by the Anchor SMF. |

NOTE 1:
If present, this attribute shall be used together with routingIndicator. This attribute is only used by the HPLMN in roaming scenarios.
NOTE 2:
See NOTE 7 of Table 6.1.6.2.10-1.

1. A method performed by a first network node, comprising:
receiving, from a second network node, a first list of data network access identifier, DNAI; and
selecting a user plane function, UPF, based at least on the first list of DNAI.

2. The method according to claim 1,
wherein the UPF comprises at least one of:
an Intermediate UPF, I-UPF,
a visited UPF, V-UPF, and
a local protocol data unit session anchor, PSA,
for a protocol data unit, PDU, session.

3. (canceled)

4. The method according to claim 1, further comprising:
receiving an updated first list of DNAI, from the second network node; and
storing the updated first list of DNAI.

5. The method according to claim 1,
wherein selecting the UPF comprises:
obtaining a second list of DNAI, based at least on one of the first list of DNAI and a configuration; and
selecting one or more UPF, based at least on the second list of DNAI.

6. The method according to claim 5,
wherein the second list of DNAI is a list of DNAIs that are both included in the first list of DNAI and supported by the first network node.

7. The method according to claim 5, further comprising:
prior to selecting the UPF, selecting an Uplink Classifier or Branching Point to be inserted into user plane data path.

8. The method according to claim 1,
wherein the first list of DNAI is a full DNAI list.

9. The method according to claim 8,
wherein the full DNAI list is a DNAI list of interest for a protocol data unit, PDU, session, that either excludes or does not exclude one or more DNAIs supported by the second network node.

10. The method according to claim 1,
wherein the first network node comprises at least one of:
a first intermediate session management function, I-SMF, and
a first visited session management function, V-SMF.

11. (canceled)

12. The method according to claim 10,
wherein the second network node comprises at least one of:
a second intermediate session management function, I-SMF, and
a second V-SMF, or an anchor SMF.

13. The method according to claim 10,
wherein the first list of DNAI is received via at least one of:
a Nsmf_PDUSession_Context Response message;
a Nsmf_PDUSession_Update Request message;
a Nsmf_PDUSession_Update Response message; and
a Nsmf_PDUSession_Create Response message.

14. The method according to claim 10,
wherein the first I-SMF is one of:
a newly inserted I-SMF or a target I-SMF at an inter I-SMF mobility procedure; and
an inserted I-SMF, or a target I-SMF when changing I-SMF.

15. The method (300) according to claim 1,
wherein the first network node receives the first list of DNAI, during at least one of flowing procedures: protocol data unit session establishment, registration, service request, inter next generation-radio access network node N2 based handover, Xn based handover, handover from evolved packet core/evolved packet data gateway to 5th generation system, and handover from non-3rd generation partnership project access to 5th generation system.

16. A method performed by a second network node, comprising:
transmitting, to a first network node, a first list of data network access identifier, DNAI;
wherein the first list of DNAI is used for the first network node to select a user plane function, UPF, based at least on the first list of DNAI.

17. (canceled)

18. The method according to claim 16, further comprising:
receiving an updated first list of DNAI, from the PCF; and
transmitting the updated first list of DNAI, to the first network node.

19. The method according to claim 16,
wherein the first list of DNAI is used for the first network node to:
obtain a second list of DNAI based on at least one of the first list of DNAI and a configuration; and
select one or more UPF based at least on the second list of DNAI.

20. The method according to claim 19,
wherein the second list of DNAI is a list of DNAIs that is both included in the first list of DNAI and supported by the first network node.

21. The method according to claim 19,
wherein the first network node selects an Uplink Classifier or Branching Point to be inserted into user plane data path, prior to selecting the UPF.

22-26. (canceled)

27. The method according to claim 19,
wherein the first list of DNAI is transmitted via at least one of:
a Nsmf_PDUSession_Context Response message;
a Nsmf_PDUSession_Update Request message;
a Nsmf_PDUSession_Update Response message; and
a Nsmf_PDUSession_Create Response.

28-44. (canceled)

45. An apparatus for a first network node, comprising:
a processor; and
a memory containing instructions executable by the processor, whereby the apparatus for the first network node is operative for:
receiving, from a second network node, a first list of data network access identifier, DNAI, and
selecting a user plane function, UPF, based at least on the first list of DNAI.

46-51. (canceled)
